(19) United States
(12) Patent Application Publication
(10) Pub. No.: US 2010/0245744 A1
(43) Pub. Date: Sep. 30, 2010

(54) CELLULOSE COMPOSITION, OPTICAL FILM, RETARDATION SHEET, POLARIZING PLATE AND LIQUID CRYSTAL DISPLAY DEVICE

(75) Inventors: Aiko YOSHIDA, Minami-ashigara-shi (JP); Satoshi TANAKA, Minami-ashigara-shi (JP); Yoshiaki HISAKADO, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/750,294

(22) Filed: Mar. 30, 2010

(30) Foreign Application Priority Data
Mar. 31, 2009 (JP) 2009-087822
Sep. 30, 2009 (JP) 2009-228643

(51) Int. Cl. G02F 1/13363; C09K 19/34; B05D 3/12; G02B 1/08

(52) U.S. Cl. 349/118; 252/299.61; 427/171; 359/500

(57) ABSTRACT

A cellulose composition, containing:
a cellulose compound;
a compound represented by formula (I); and
a low molecular weight compound (A);
   wherein molecular absorption wavelength of the compound (A) derived from an electric dipole transition moment My in a direction approximately orthogonal to a molecular long axis direction, is longer than that derived from an electric dipole transition moment Mx in a direction approximately parallel to the molecular long axis direction; and
   wherein |My| is larger than |Mx|:

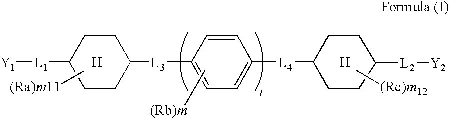

wherein L₁ to L₄ represent a single bond or a specific divalent linking group; Y₁ and Y₂ represent an alkyl group; Ra, Rb and Rc represent a substituent; m represents an integer of 0 to 4; t represents an integer of 1 or 2; and m11 and m12 represent an integer of 0 to 10.

### FIELD OF THE INVENTION

The present invention relates to a composition containing a compound and a rod-shaped compound which are capable of imparting inverse wavelength dispersibility to a film when added to the film, together with a cellulose compound. The present invention also relates to a cellulose film containing the compounds. The present invention also relates to an optical film, and a polarizing plate and a liquid crystal display device using the optical film. In particular, the present invention relates to an optical film, a polarizing plate and a liquid crystal display device which realize high definition visibility with less viewing-angle dependency.

### BACKGROUND OF THE INVENTION

A liquid crystal display device is increasingly used year by year as a space-saving, less power-consuming image display device. It has been conventionally a great drawback of the liquid crystal display device that the viewing-angle dependency of the image is large, but in recent years, various high viewing-angle modes differing in the arrayed state of liquid crystal molecules in the liquid crystal cell are put into practical use and this allows rapid spreading of the demand for a liquid crystal display device also in the market where a high viewing angle is required, such as television.

In general, the liquid crystal display device comprises a liquid crystal cell, an optically compensatory sheet and a polarizer. The optically compensatory sheet is used for eliminating image coloration or enlarging the viewing angle, and a stretched birefringent film or a film obtained by coating a liquid crystal on a transparent film is used therefor. For example, Japanese Patent No. 2587398 discloses a technique of applying an optically compensatory sheet where a discotic liquid crystal is coated on a triacetyl cellulose, aligned and fixed, to a TN-mode liquid crystal cell, thereby enlarging the viewing angle. However, a liquid crystal display device for a large-screen television expected to be seen from various angles imposes severe requirements on the viewing angle dependency, and even the technique above cannot satisfy these requirements. Therefore, studies are being made on a liquid crystal display device different from TN mode, such as IPS (In-Plane Switching) mode, OCB (Optically Compensatory Bend) mode and VA (Vertically Aligned) mode.

In particular, the VA mode ensures high contrast and a relatively high production yield, and the liquid crystal display device of this mode is attracting attention as a liquid crystal display device for TV. However, the VA mode has a problem that although the panel may be displayed in almost complete black in the normal direction, light leakage occurs when viewed from an oblique direction and the viewing angle is narrowed. In order to solve such a problem, there has been proposed a method where a first retardation sheet having a positive refractive index anisotropy of nx>ny=nz and a second retardation sheet having a negative refractive index anisotropy of nx=ny>nz are used together so as to reduce the leakage of light (e.g., Japanese Patent No. 3027805).

Specifically, there is disclosed a method for obtaining a colorless VA-mode liquid crystal display device which gives a clear black display even when viewed from an oblique direction, by using two types of phase difference layers having different optical properties (see, for example, WO 2003/032060). However, in the method described above, a process of producing a polarizing plate and then pasting a phase difference film thereto is required. For this reason, the production process becomes complicated, and there are problems of low productivity and high production cost. Thus, there has been a demand for an improvement.

JP-A-2007-256494 (“JP-A” means unexamined published Japanese patent application) discloses a method of obtaining a VA-mode liquid crystal display device in which the wavelength dispersion of a film is converted into inverse dispersion only by adding a specific material to cellulose acylate and stretching the film formed therefrom, so that the black display turns colorless even when observed from an oblique direction. In this method, the complicatedness of the production process no longer poses a problem, but the optical expression properties of the material being added are still insufficient, and the amount to be added of the material is large. Furthermore, it was found that there is a problem that sufficient optical anisotropy cannot be expressed. Therefore, it is requested to produce a VA-mode liquid crystal display device by producing a similar inverse dispersion film, using a material having higher optical expression properties in a smaller amount to be added.

In JP-A-2007-256494, a rod-shaped compound in which a cyclohexyl ring and a benzene ring are linked via an ester bond is used as a retardation increasing agent. However, in regard to known liquid crystalline rod-shaped compounds other than the compound used therein, there is no finding in connection with the retardation expression properties obtained when the compounds are added to cellulose films together with an inverse dispersing agent. JP-A-2007-249224 discloses that a compound in which a cyclohexyl ring and a benzene ring are linked via an ester bond can be used as an additive for the moisture permeability improvement of certain types of cellulose ester films, but nothing is known concerning the retardation expression properties of the films.

### SUMMARY OF THE INVENTION

The present invention resides in a cellulose composition, comprising:

at least one kind of cellulose compound;

at least one kind of compound represented by formula (I); and

at least one kind of low molecular weight compound (A)

wherein molecular absorption wavelength of the low molecular weight compound (A) derived from an electric dipole transition moment My in a direction approximately orthogonal to a molecular long axis direction, is longer than that derived from an electric dipole transition moment Mx in a direction approximately parallel to the molecular long axis direction; and
wherein magnitude of the electric dipole transition moment |My| of the low molecular weight compound (A) in the direction approximately orthogonal to the molecular long axis is larger than that of the electric dipole transition moment |Mx| in the direction approximately parallel to the molecular long axis direction;

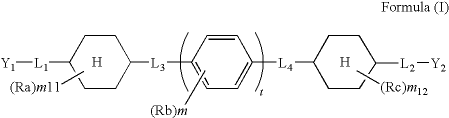

wherein L₁, L₂, L₃, and L₄ each independently represent a single bond, or a divalent linking group selected from the group consisting of —O—, —CO—, —NR^{A}— (R^{A} represents an alkyl group having 1 to 7 carbon atoms or a hydrogen atom), —CH₂— and a combination of these; Y₁ and Y₂ each independently represent an alkyl group; Ra, Rb and Rc each independently represent a substituent; m represents an integer of 0 to 4; t represents an integer of 1 or 2; and m11 and m12 each independently represent an integer of 0 to 10.

Further, the present invention resides in a cellulose film, comprising the composition as described above.

Further, the present invention resides in an optical film, comprising the cellulose film as described above.

Further, the present invention resides in a method of producing the cellulose film or the optical film as described above, comprising the steps of:

stretching a film; and

contracting the film.

Further, the present invention resides in a retardation sheet, comprising the cellulose film or the optical film as described above.

Further, the present invention resides in a polarizing plate, comprising the retardation sheet as described above.

Further, the present invention resides in a liquid crystal display device, comprising the retardation sheet as described above or the polarizing plate as described above.

Other and further features and advantages of the invention will appear more fully from the following description.

### DETAILED DESCRIPTION OF THE INVENTION

As results of inventive studies, the inventors of the present invention found that when a film is produced using a composition containing a specific compound together with a cellulose compound, and stretched, the wavelength dispersion in the film can be converted to inverse dispersion, and thus the inventors completed the present invention based on this finding.

According to the present invention, there is provided the following means:

[1] A cellulose composition, comprising:

at least one kind of cellulose compound;

at least one kind of compound represented by formula (I); and

at least one kind of low molecular weight compound (A);

wherein molecular absorption wavelength of the low molecular weight compound (A) derived from an electric dipole transition moment My in a direction approximately orthogonal to a molecular long axis direction, is longer than that derived from an electric dipole transition moment Mx in a direction approximately parallel to the molecular long axis direction; and
wherein magnitude of the electric dipole transition moment |My| of the low molecular weight compound (A) in the direction approximately orthogonal to the molecular long axis is larger than that of the electric dipole transition moment |Mx| in the direction approximately parallel to the molecular long axis direction:

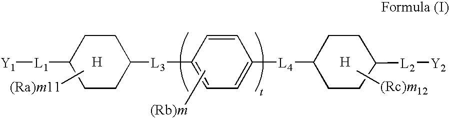

wherein L₁, L₂, L₃, and L₄ each independently represent a single bond, or a divalent linking group selected from the group consisting of —O—, —CO—, —NR^{A}— (R^{A} represents an alkyl group having 1 to 7 carbon atoms or a hydrogen atom), —CH₂— and a combination of these; Y₁ and Y₂ each independently represent an alkyl group; Ra, Rb and Rc each independently represent a substituent; m represents an integer of 0 to 4; t represents an integer of 1 or 2; and m11 and m12 each independently represent an integer of 0 to 10.

[2] The cellulose composition as described in the above item [1], wherein the low molecular weight compound (A) is a compound having a structure represented by formula (a) in its skeleton.

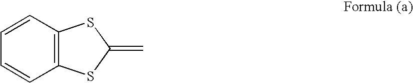

[3] The cellulose composition as described in the above item [2], wherein the low molecular weight compound (A) having a structure represented by formula (a) is a compound represented by formula (A-1):

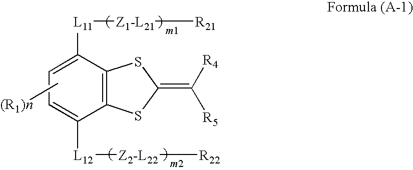

wherein R₁, R₄ and R₅ each independently represent a substituent; n represents an integer of 0 to 2; L₁₁, L₁₂, L₂₁ and L₂₂ each independently represent a single bond, or a divalent linking group selected from the group consisting of —O—, —S—, —S(═O)₂—, —CO—, —NR^{A}— (R^{A} represents an alkyl group having 1 to 7 carbon atoms or a hydrogen atom), —CH₂— and a combination of these; Z₁ and Z₂ each independently represent a divalent 5- or 6-membered cyclic linking group; R₂₁ and R₂₂ each independently represent a hydrogen atom or an alkyl group; and m1 and m2 each independently represent an integer of 0 to 2.

[4] The cellulose composition as described in the above item [3], wherein R₄ and R₅ in formula (A-1) is an electron-withdrawing substituent having a Hammett substituent constant σₚ value of 0 or more.
[5] The cellulose composition as described in the above item [3] or [4], wherein Z₁ and Z₂ in formula (A-1) each independently represent a 1,4-cyclohexylene group or a 1,4-phenylene group.
[6] The cellulose composition as described in any one of the above items [3] to [5],
wherein m1 and m2 in formula (A-1) each are 0 or 1.
[7] The cellulose composition as described in any one of the above items [1] to [6],
wherein L₃ and L₄ in formula (I) each independently represent —OC(═O)— or —C(═O)O—.
[8] The cellulose composition as described in any one of the above items [1] to [7],
wherein L₁ and L₂ in formula (I) each independently represent a single bond; and
wherein Y₁ and Y₂ in formula (I) each independently represent an unsubstituted alkyl group.
[9] The cellulose composition as described in any one of the above items [1] to [8],
wherein at least one of the compound represented by formula (I) and the low molecular weight compound (A) is in a liquid crystal phase at any temperature of from 100° C. to 300° C.
[10] The cellulose composition as described in any one of the above items [1] to [9],
wherein the cellulose compound is a cellulose ester.
[11] The cellulose composition as described in the above item [10],
wherein the cellulose ester is a cellulose acylate;
wherein the acyl substituent of the cellulose acylate is substantially an acetyl group; and
wherein a total substitution degree of the cellulose acylate is from 2.00 to 3.00.
[12] A cellulose film, comprising the composition as described in any one of the above items [1] to [11].
[13] The cellulose film as described in the above item [12], wherein the low molecular weight compound (A) is contained in an amount of 0.1 to 50 mass parts, with respect to 100 mass parts of the cellulose compound.
[14] The cellulose film as described in the above item [12], wherein the compound (I) is contained in an amount of 0.1 to 50 mass parts, with respect to 100 mass parts of the cellulose compound.
[15] An optical film, comprising the cellulose film as described in any one of the above items [12] to [14].
[16] The optical film as described in the above item [15],
wherein the birefringence Δn (550 nm) in the orientation direction is larger than 0; and
wherein the optical film satisfies expressions (1) and (2).

1>|Δn(450 nm)/Δn(550 nm)| Expression (1)

1<|Δn(630 nm)/Δn(550 nm)| Expression (2)

[17] A method of producing the cellulose film as described in any one of the above items [12] to [14] or the optical film as described in the above item [15] or [16], comprising the steps of:

stretching a film; and

contracting the film.

[18] A retardation sheet, comprising the cellulose film as described in any one of the above items [12] to [14] or the optical film as described in the above item [15] or [16].
[19] A polarizing plate, comprising the retardation sheet as described in the above item [18].
[20] A liquid crystal display device, comprising the retardation sheet as described in the above item [18] or the polarizing plate as described in the above item [19].
[21] The liquid crystal display device as described in the above item [20], which is a VA mode.

Hereinafter, the present invention will be described in detail. The descriptions below may be given based on some representative embodiments or examples of elements of the present invention, but the invention is not meant to be limited to such embodiments or examples. In the present specification, “to” denotes a range including numerical values described before and after it as a minimum value and a maximum value.

The cellulose composition (also referred to as “cellulose compound solution” in this specification) of the present invention contains a cellulose compound as a main component; and at least one kind of compound represented by formula (I) and at least one kind of low molecular weight compound (A). Herein, molecular absorption wavelength of the low molecular weight compound (A) derived from an electric dipole transition moment My in a direction approximately orthogonal to a molecular long axis direction, is longer than that derived from an electric dipole transition moment Mx in a direction approximately parallel to the molecular long axis direction. Further, magnitude of the electric dipole transition moment |My| of the low molecular weight compound (A) in the direction approximately orthogonal to the molecular long axis is larger than that of the electric dipole transition moment |Mx| in the direction approximately parallel to the molecular long axis direction.

### [Compound Represented by Formula (I)]

The compound represented by formula (I) is described below in detail.

The compound represented by formula (I) is known as a liquid crystalline compound, and the method for synthesis, the liquid crystal phase transition temperature, dielectric anisotropy and the like of the compound are described in, for example, U.S. Pat. No. 4,519,936, U.S. Pat. No. 4,659,499, JP-A-61-26898 and JP-A-56-158739.

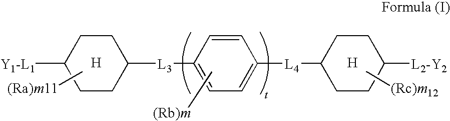

In formula (I), L₁, L₂, L₃, and L₄ each independently represent a single bond, or a divalent linking group selected from the group consisting of —O—, —CO—, —NR^{A}— (R^{A} represents an alkyl group having 1 to 7 carbon atoms or a hydrogen atom), —CH₂— and a combination of these; Y₁ and Y₂ each independently represent an alkyl group; Ra, Rb and Rc each independently represent a substituent; m represents an integer of 0 to 4; t represents an integer of 1 or 2; and m11 and m12 each independently represent an integer of 0 to 10.

Examples of the divalent linking group represented by L₁, L₂, L₃ and L₄ include —C(═O)O—, —OC(═O)—, —OC(═O)O—, —C(═O)NH—, —NHC(═O)—, —C(═O)N(CH₃)—, —N(CH₃)C(═O)—, —OC(═O)NH—, —NHC(═O)O—, —NHC(═O)NH—, —C(═O)O(CH₂)ₚO— (in which p represents an integer of 1 or more) and —OCH₂—.

L₃ and L₄ each are preferably a single bond, *—C(═O)O—, *—OC(═O)—, *—C(═O)NH—, *—NHC(═O)—, *—C(═O)N(CH₃)—, *—N(CH₃)C(═O)—, *—CH₂O—, or *—OCH₂—; and more preferably *—C(═O)O— or *—OC(═O)—. Herein, the symbol “*” means the site to be bonded with the benzene ring.

L₁ and L₂ each are preferably a single bond, *—O—, *—CH₂O—, *—C(═O)O—, *—OC(═O)—, *—NH—, *—NHC(═O)—, *—CH₂—NH—, or *—CH₂NHC(═O)—; more preferably a single bond, *—O—, or *—C(═O)O—. Herein, the symbol “*” means the site to be bonded with the cyclohexyl ring.

Y₁ and Y₂ each represent a substituted or unsubstituted alkyl group. The alkyl group is preferably an alkyl group having 1 to 30 carbon atoms, e.g., a methyl group, an ethyl group, a n-propyl group, an iso-propyl group, a n-butyl group, a tert-butyl group, a n-pentyl group, a n-hexyl group, a n-octyl group and a 2-ethylhexyl group.

Y₁ and Y₂ each are preferably a substituted or unsubstituted alkyl group having 12 or less carbon atoms, more preferably an unsubstituted alkyl group having 8 or less carbon atoms, and further preferably a linear unsubstituted alkyl group having 8 or less carbon atoms.

Ra, Rb and Rc are each independently a substituent. Examples of the substituent include those shown below.

Halogen atom (such as fluorine atom, chlorine atom, bromine atom and iodine atom), an alkyl group (preferably an alkyl group having 1 to 30 carbon atoms such as a methyl group, an ethyl group, a n-propyl group, an isopropyl group, a tert-butyl group, a n-octyl group and a 2-ethylhexyl group), a cycloalkyl group (preferably a substituted or unsubstituted alkyl group having 3 to 30 carbon atoms such as a cyclohexyl group, a cyclopentyl group and a 4-n-dodecylcylohexyl group), a bicycloalkyl group (preferably a substituted or unsubstituted bicycloalkyl group having 5 to 30 carbon atoms, in other words, a monovalent group obtained by removing one hydrogen atom from a bicycloalkane having 5 to 30 carbon atoms such as a bicyclo[1,2,2]heptan-2-yl group and a bicyclo[2,2,2]octan-3-yl group), an alkenyl group (preferably a substituted or unsubstituted alkenyl group having 2 to 30 carbon atoms such as a vinyl group and an allyl group), a cycloalkenyl group (preferably a substituted or unsubstituted alkenyl group having 3 to 30 carbon atoms, in other words, a monovalent group obtained by removing one hydrogen atom from a cycloalkene having 3 to 30 carbon atoms such as a 2-cyclopenten-1-yl group and a 2-cyclohexen-1-yl group), a bicycloalkenyl group (a substituted or unsubstituted bicycloalkenyl group, preferably a substituted or unsubstituted bicycloalkenyl group having 5 to 30 carbon atoms, in other words, a monovalent group obtained by removing one hydrogen atom from a bicycloalkene having one double bond such as a bicyclo[2,2,1]hept-2-en-1-yl group and a cyclo[2,2,2]oct-2-en-4-yl group), an alkynyl group (preferably a substituted or unsubstituted alkynyl group having 2 to 30 carbon atoms such as an ethynyl group and a propargyl group), an aryl group (preferably a substituted or unsubstituted aryl group having 6 to 30 carbon atoms such as a phenyl group, a p-tolyl group and a naphthyl group), a heterocyclic group (preferably a monovalent group obtained by removing one hydrogen from a five- or six-membered substituted or unsubstituted aromatic or non-aromatic heterocyclic compound, more preferably an five- or six-membered aromatic heterocyclic group having 3 to 30 carbon atoms such as a 2-furyl group, a 2-thienyl group, a 2-pyrimidinyl group and a 2-benzothiazolyl group), cyano group, hydroxyl group, nitro group, carboxyl group, an alkoxy group (preferably a substituted or unsubstituted alkoxy group having 1 to 30 carbon atoms such as a methoxy group, an ethoxy group, an isopropoxy group, a tert-butoxy group, a n-octyloxy group and a 2-methoxyethoxy group), an aryloxy group (preferably a substituted or unsubstituted aryloxy group having 6 to 30 carbon atoms such as a phenoxy group, a 2-methylphenoxy group, a 4-tert-butylphenoxy group, a 3-nitrophenoxy group and a 2-tetradecanoylaminophenoxy group), a silyloxy group (preferably a silyloxy group having 3 to 20 carbon atoms such as a trimethylsilyloxy group and a tert-butyldimethylsilyloxy group), a heterocyclic oxy group (preferably a substituted or unsubstituted heterocyclic oxy group having 2 to 30 carbon atoms such as a 1-phenyltetrazol-5-oxy group and a 2-tetrahydropyranyloxy group), an acyloxy group (preferably a formyloxy group, a substituted or unsubstituted alkylcarbonyloxy group having 2 to 30 carbon atoms and a substituted or unsubstituted arylcarbonyloxy group having 6 to 30 carbon atoms such as a formyloxy group, an acetyloxy group, a pivaloyloxy group, a stearoyloxy group, a benzoyloxy group and a p-methoxyphenylcarbonyloxy group), a carbamoyloxy group (preferably a substituted or unsubstituted carbamoyloxy group having 1 to 30 carbon atoms such as a N,N-dimethylcarbamoyloxy group, a N,N-diethylcarbamoyloxy group, a morpholinocarbonyloxy group, a N,N-di-n-octylaminocarbonyloxy group and a N-n-octylcarbamoyloxy group), an alkoxycarbonyloxy group (preferably a substituted or unsubstituted alkoxycarbonyloxy group having 2 to 30 carbon atoms such as a methoxycarbonyloxy group, an ethoxycarbonyloxy group, a tert-butoxycarbonyloxy group and a n-octylcarbonyloxy group), an aryloxycarbonyloxy group (preferably a substituted or unsubstituted aryloxycarbonyloxy group having 7 to 30 carbon atoms such as a phenoxycarbonyloxy group, a p-methoxyphenoxycarbonyloxy group and a p-n-hexadecyloxyphenoxycarbonyloxy group), an amino group (preferably an amino group, a substituted or unsubstituted alkylamino group having 1 to 30 carbon atoms and a substituted or unsubstituted anilino group having 6 to 30 carbon atoms such as an amino group, a methylamino group, a dimethylamino group, an anilino group, a N-methyl-anilino group and a diphenylamino group), an acylamino group (preferably a formylamino group, a substituted or unsubstituted alkylcarbonylamino group having 2 to 30 carbon atoms and a substituted or unsubstituted arylcarbonylamino group having 7 to 30 carbon atoms such as a formylamino group, an acetylamino group, a pivaloylamino group, a lauroylamino group and a benzoylamino group), an aminocarbonylamino group (preferably a substituted or unsubstituted aminocarbonylamino group having 1 to 30 carbon atoms such as a carbamoylamino group, a N,N-dimethylaminocarbonylamino group, a N,N-diethylaminocarbonylamino group and a morpholinocarbonylamino group), an alkoxycarbonylamino group (preferably a substituted or unsubstituted alkoxycarbonylamino group having 2 to 30 carbon atoms such as a methoxycarbonylamino group, an ethoxycarbonylamino group, a tert-butoxycarbonylamino group, a n-octadecyloxycarbonylamino group and a N-methyl-methoxycarbonylamino group), an aryloxycarbonylamino group (preferably a substituted or unsubstituted aryloxycarbonylamino group having 7 to 30 carbon atoms such as a phenoxycarbonylamino group, a p-chlorophenoxycarbonylamino group and a m-n-octyloxyphenoxycarbonylamino group), a sulfamoylamino group (preferably a substituted or unsubstituted sulfamoylamino group having 0 to 30 carbon atoms such as a sulfamoylamino group, a N,N-dimethylaminosulfonylamino group and a N-n-octylaminosulfonylamino group), an alkyl- or aryl-sulfonylamino group (preferably a substituted or unsubstituted alkylsulfonylamino group having 1 to 30 carbon atoms and a substituted or unsubstituted arylsulfonylamino group having 6 to 30 carbon atoms such as a methylsulfonylamino group, a butylsulfonylamino group, a phenylsulfonylamino group, a 2,3,5-trichlorophenylsulfonylamino group and a p-methylphenylsulfonylamino group), mercapto group, an alkylthio group (preferably a substituted or unsubstituted alkylthio group having 1 to 30 carbon atoms such as a methylthio group, an ethylthio group and a n-hexadecylthio group), an arylthio group (preferably a substituted or unsubstituted arylthio group having 6 to 30 carbon atoms such as a phenylthio group, a p-chlorophenylthio group and a m-methoxyphenylthio group), a heterocyclic thio group (preferably a substituted or unsubstituted heterocyclic thio group having 2 to 30 carbon atoms such as a 2-benzothiazolylthio group and a 1-phenyltetrazol-5-ylthio group), a sulfamoyl group (preferably a substituted or unsubstituted sulfamoyl group having 0 to 30 carbon atoms such as a N-ethylsulfamoyl group, a N-(3-dodecyloxypropyl)sulfamoyl group, a N,N-dimethylsulfamoyl group, a N-acetylsulfamoyl group, a N-benzoylsulfamoyl group and a N—(N′-phenylcarbamoyl)sulfamoyl group), sulfo group, an alkyl- or aryl-sulfonyl group (preferably a substituted or unsubstituted alkylsulfinyl group having 1 to 30 carbon atoms and a substituted or unsubstituted arylsulfinyl group having 6 to 30 carbon atoms such as a methylsulfinyl group, an ethylsulfinyl group, a phenylsulfinyl group and a p-methylphenylsulfinyl group), an alkyl- or aryl-sulfonyl group (preferably a substituted or unsubstituted alkylsulfonyl group having 1 to 30 carbon atoms and a substituted or unsubstituted arylsulfonyl group having 6 to 30 carbon atoms such as a methylsulfonyl group, an ethylsulfonyl group, a phenylsulfonyl group and a p-methylphenylsulfonyl group), an aryl- or heterocyclic-azo group (preferably a substituted or unsubstituted arylazo group having 6 to 30 carbon atoms and a substituted or unsubstituted heterocyclic azo group having 3 to 30 carbon atoms such as a phenylazo group, a p-chlorophenylazo group and a 5-ethylthio-1,3,4-thiadiazol-2-ylazo group), an imide group (preferably a N-succinimide group and a N-phthalimide group), a phosphino group (preferably a substituted or unsubstituted phosphino group having 2 to 30 carbon atoms such as a dimethylphosphino group, a diphenylphosphino group and a methylphenoxyphosphino group), a phosphinyl group (preferably a substituted or unsubstituted phosphinyl group having 2 to 30 carbon atoms such as a phosphinyl group, a dioctylphosphinyl group and a diethoxyphosphinyl group), a phosphinyloxy group (preferably a substituted or unsubstituted phosphinyloxy group having 2 to 30 carbon atoms such as a diphenxoyphosphinyloxy group and a dioctyloxyphosphinyl group), a phosphinylamino group (preferably a substituted or unsubstituted phosphinylamino group having 2 to 30 carbon atoms such as a dimethoxyphosphinylamino group and a dimethylaminophosphinyl group) and a silyl group (preferably a substituted or unsubstituted silyl group having 3 to 30 carbon atoms such as a trimethylsilyl group, a tert-butyldimethylsilyl group and a phenyldimethylsilyl group).

Among the substituents, with respect to one having a hydrogen atom, the hydrogen atom may be removed and be substituted by any of the above-mentioned substituents. Examples thereof include: an alkylcarbonylaminosulfonyl group, an arylcarbonylaminosulfonyl group, an alkylsulfonylaminocarbonyl group, and an arylsulfonylaminocarbonyl group. Specific examples thereof include a methylsulfonylaminocarbonyl group, a p-methylphenylsulfonylaminocarbonyl group, an acetylaminosulfonyl group, and a benzoylaminosulfonyl group.

Ra, Rb and Rc each are preferably an alkyl group, a halogen atom, a cyano group, an alkoxy group, an acyloxy group, an alkoxycarbonyl group, a nitro group or an acyl group; more preferably an alkyl group having 4 or less carbon atoms, a halogen atom, a cyano group, or an alkoxy group; and most preferably a methyl group, a methoxy group, a chlorine atom, or a cyano group.

In formula (I), t represents an integer of 1 or 2, preferably 1.

In formula (I), m11 and m12 each independently represent an integer of 0 to 10. m11 and m12 each are preferably an integer of 0 to 2; more preferably 0.

In formula (I), m represents an integer of 0 to 4, preferably an integer of 0 to 2.

In regard to the two cyclohexane rings in formula (I), a cyclohexane ring has stereoisomers, namely, a cis-form and a trans-form. However, there is no limitation to its isomeric form in the present invention, and a mixture of the two isomeric forms may be used. However, preferred one from the viewpoint of liquid crystallinity is a trans-cyclohexane ring.

The compound represented by formula (I) is preferably a compound represented by formula (I-1) or (1-2).

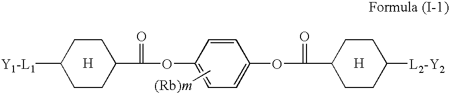

In formula (I-1), L₁, L₂, Y₁, Y₂, Rb and m have the same meaning as those in formula (I), respectively, and preferable ranges are also the same.

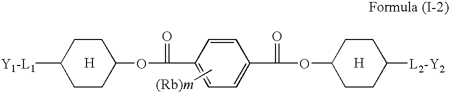

In formula (I-2), L₁, L₂, Y₁, Y₂, Rb and m have the same meaning as those in formula (I), respectively, and preferable ranges are also the same.

### <Specific Examples of the Compound Represented by Formula (I)>

Hereinafter, specific examples of the compound represented by formula (I) will be shown, but the present invention is not limited thereto.

In the following compounds, n represents an integer of 1 to 8, preferably an integer of 2, 3, 4, 5 or 6; and k represents an integer of 1 to 8, preferably an integer of 2, 3, 4, 5 or 6.

| | | | |
|---|---|---|---|
| —L₁—Y₁ | —L₂—Y₂ | R | Compound No. |

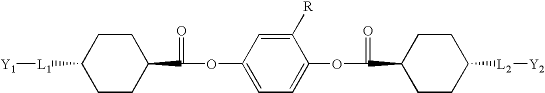

| | | | |
|---|---|---|---|
| CₙH₂ₙ₊₁ | CₙH₂ₙ₊₁ | H | (101-n) |
| CₙH₂ₙ₊₁ | CₙH₂ₙ₊₁ | H | (102) |
| (Mixture in which | (Mixture in which H | | |
| n = 3, 4 or 5) | n = 3,4 or 5) | | |
| CₙH₂ₙ₊₁ | CₙH₂ₙ₊₁ | CH₃ | (103-n) |
| CₙH₂ₙ₊₁ | CₙH₂ₙ₊₁ | C₂H₅ | (104-n) |
| COOCₙH₂ₙ₊₁ | COOCₙH₂ₙ₊₁ | C₄H₉ | (105-n) |
| CₙH₂ₙ₊₁ | CₙH₂ₙ₊₁ | Cl | (106-n) |
| CₙH₂ₙ₊₁ | CₙH₂ₙ₊₁ | Br | (107-n) |
| CₙH₂ₙ₊₁ | CₙH₂ₙ₊₁ | F | (108-n) |
| CₙH₂ₙ₊₁ | CₙH₂ₙ₊₁ | NO₂ | (109-n) |
| CₙH₂ₙ₊₁ | CₙH₂ₙ₊₁ | CN | (110-n) |
| CₙH₂ₙ₊₁ | CₙH₂ₙ₊₁ | COCH₃ | (111-n) |
| CₙH₂ₙ₊₁ | CₙH₂ₙ₊₁ | COOCH₃ | (112-n) |
| OCH₃ | OCH₃ | H | (113) |
| OCₙH₂ₙ₊₁ | OCₙH₂ₙ₊₁ | H | (114) |
| OC₈H₁₇ | OC₈H₁₇ | H | (115) |

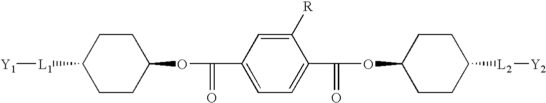

| | | | |
|---|---|---|---|
| CₙH₂ₙ₊₁ | CₙH₂ₙ₊₁ | H | (116-n) |
| CₙH₂ₙ₊₁ | CₙH₂ₙ₊₁ | H | (117) |
| (Mixture in | (Mixture in | | |
| which n = 3,4 or | which n = 3,4 or | | |
| 5) | 5) | | |
| CₙH₂ₙ₊₁ | CₙH₂ₙ₊₁ | CH₃ | (118-n) |
| CₙH₂ₙ₊₁ | CₙH₂ₙ₊₁ | Cl | (119-n) |
| CₙH₂ₙ₊₁ | CₙH₂ₙ₊₁ | Br | (120-n) |
| CₙH₂ₙ₊₁ | CₙH₂ₙ₊₁ | COOCH₃ | (121-n) |
| OCₙH₂ₙ₊₁ | OCₙH₂ₙ₊₁ | H | (122-n) |
| COOCₙH₂ₙ₊₁ | COOCₙH₂ₙ₊₁ | H | (123-n) |

| | |
|---|---|
| | (124-n) |
| 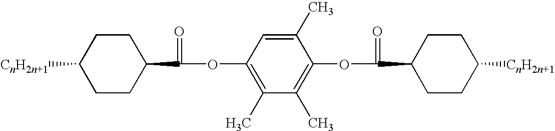 | |
| | (125-n) |
| 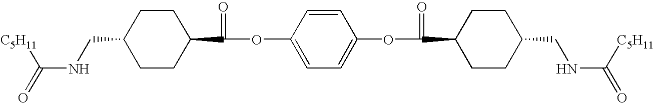 | |
| | (126-n) |
| 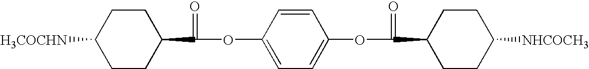 | |
| | (127-n) |
| 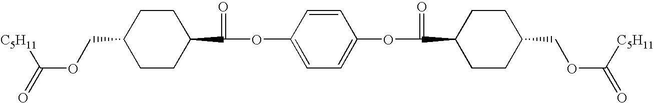 | |
| | (128-n) |
| 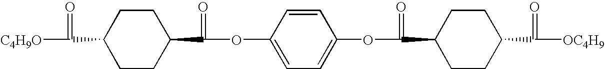 | |
| | (129-n) |
| 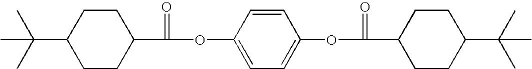 | |
| | (130-n) |
| 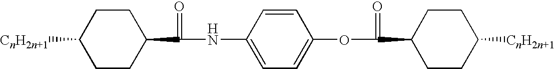 | |
| | (131-n) |
| 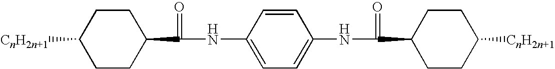 | |
| | (132-n) |
| 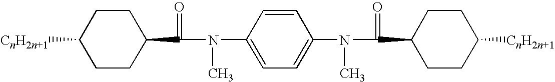 | |
| | (133-n) |
| 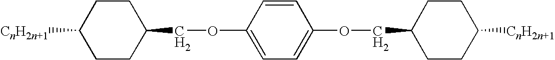 | |
| | (134-n) |
| 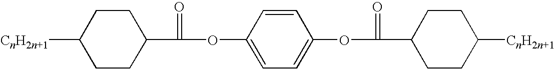 | |
| | (135-n) |
| 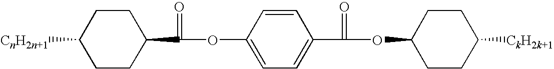 | |
| | (136-n) |
| 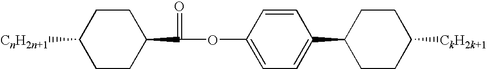 | |
| | (137-n) |
| 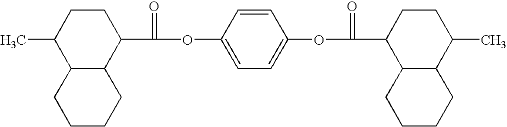 | |
| | (138-n) |
| 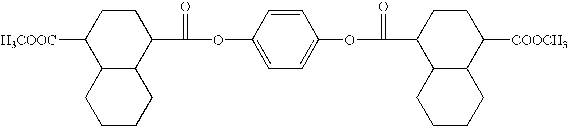 | |
| | (139-n) |
| 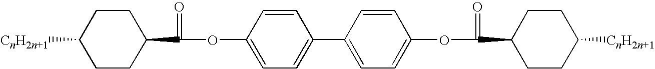 | |
| | (140-n) |
| 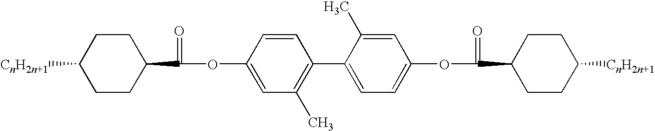 | |
| | (141-n) |
| 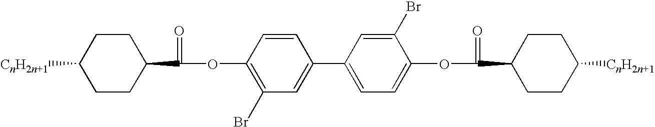 | |

### <Synthesis of the Compound Represented by Formula (I)>

The compound represented by formula (I) for use in the present invention can be synthesized by an ordinary method. For example, the compound represented by formula (I) can be synthesized referring to the methods described in, for example, JP-A-61-26898 and JP-A-56-158739.

For example, the compound represented by formula (I) can be easily synthesized by the following scheme.

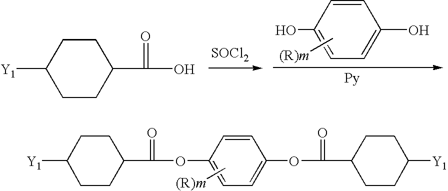

For example, when Y₁ is an n-butyl group and m=0, the desired compound can be synthesized by forming an acid chloride from 4-butylcyclohexanecarboxylic acid using thionyl chloride, subsequently adding the acid chloride dropwise to a THF solution of hydroquinone and pyridine, and stirring the mixture at room temperature. Syntheses of other compounds having different substituents or linking groups for formula (I) can be carried out based on the method described above, by changing the compound to be used or the reaction to be carried out, but the present invention is not intended to be limited to this synthesis method.

### <Content of Compound Represented by Formula (I)>

In the present invention, content of the compound represented by formula (I) is preferably 0.1 to 50 mass parts, more preferably 0.25 to 20 mass parts, further preferably 0.25 to 10 mass parts, and most preferably 0.25 to 5 mass parts, with respect to 100 mass parts of the cellulose compound.

In the present invention, it is preferable that the compound represented by formula (I) has an absorption maximum of 200 nm or more and 270 nm or less, more preferably of 200 nm or more and 250 nm or less, and most preferably of 200 nm or more and 230 nm or less.

The compound represented by formula (I) shows a liquid crystalline property. It is more preferred that the liquid crystalline property is achieved (having a thermotropic liquid crystalline property) upon heating. It is preferred that liquid crystalline property of at least one of the compound represented by formula (I) and the low molecular weight compound (A) is achieved within a temperature range of 100° C. to 300° C. The liquid crystal phase of the compound represented by formula (I) is preferably a columnar phase, a nematic phase or a smectic phase; more preferably a nematic phase.

### [Low Molecular Weight Compound (A)]

Next, the low molecular weight compound (A) contained in the cellulose composition of the present invention is described below.

### (Determination of Molecular Long Axis)

The molecular long axis in the low molecular weight compound (A) used in the present invention can be determined by density functional calculation using a computer. That is, the optimal structure of the molecule is obtained by the density functional calculation, and among the distances between any two atoms in the obtained molecular structure, an axis binding the two atoms with the longest distance therebetween is designated as the molecular long axis.

In the establishment of the molecular structure as described above, GausView 3.0 (trade name, manufactured by Gaussian, Inc.) is used. As a program used for the optimization of the molecular structure, Gaussian03 Rev. D.02 (trade name, manufactured by Gaussian, Inc.) is used, and as a basis function, B3LYP/6-31+G(d) is used. For the convergence conditions, default values are used.

(Computation of Electric Dipole Transition Moments, their Magnitudes, and Absorption Wavelengths Derived from Electric Dipole Transition Moments)

The electric dipole transition moments Mx and My, their magnitudes |Mx| and |My|, and the absorption wavelengths derived from Mx and My can be determined by time-dependent density functional calculation. Gaussian03 Rev. D.02 (trade name, manufactured by Gaussian, Inc.) is used as a program used in the time-dependent density functional calculation, and B3LYP/6-31+G(d) is used as a basis function. Solvent effects are further introduced by a PCM method.

More specifically, the angle formed by the electric dipole transition moment and the molecular long axis is determined from an inner product of a vector that constitutes the electric dipole transition moment determined by the calculation as described above and a vector represented by the Cartesian coordinates of the atoms at the two ends constituting the molecular long axis. Based on these values, Mx, My, |Mx|, |My|, and the molecular absorption wavelengths derived from Mx and My are determined.

In the present specification, the term “electric dipole transition moment in a direction approximately orthogonal to the molecular long axis direction” is not meant to refer to the electric dipole transition moment forming an angle of exactly 90° with the molecular long axis direction, but is meant to refer to the largest electric dipole transition moment among all the electric dipole transition moments forming an angle of 70° to 110° with a direction approximately parallel to the molecular long axis direction.

As previously described, one of the features of the low molecular weight compound (A) used in the cellulose composition of the present invention is that the molecular absorption wavelength derived from the electric dipole transition moment, My, in a direction approximately orthogonal to the molecular long axis direction, is longer than the molecular absorption wavelength derived from the electric dipole transition moment, Mx, in a direction approximately parallel to the molecular long axis direction.

Here, the absorption wavelength derived from the electric dipole transition moment, My, in a direction approximately orthogonal to the molecular long axis direction, is preferably a wavelength longer by 10 nm or more and 200 nm or less, more preferably by 10 nm or more and 150 nm or less, and further preferably by 20 nm or more and 120 nm or less, compared with the absorption wavelength derived from the electric dipole transition moment, Mx, in a direction approximately parallel to the molecular long axis direction.

The absorption wavelength derived from the electric dipole transition moment My in a direction approximately orthogonal to the long axis direction is in the range of preferably 250 nm or more and 400 nm or less, more preferably 300 nm or more and 390 nm or less, and further preferably 320 nm or more and 380 nm or less.

Another feature of the low molecular weight compound (A) used in the cellulose composition of the present invention is that the magnitude of the electric dipole transition moment, |My|, in a direction approximately orthogonal to the molecular long axis direction, is larger than the magnitude of the electric dipole transition moment, |Mx|, in a direction approximately parallel to the molecular long axis direction. That is, the ratio of the two values (|My|/|Mx|) is preferably 1 or more, more preferably 1 or more and 50 or less, and even more preferably 1.1 or more and 30 or less.

The low molecular weight compound (A) used in the cellulose composition of the present invention is a low molecular weight compound. Here, the term “low molecular weight compound” means a compound having a molecular weight of 2,000 or less, more preferably 1,500 or less, and further preferably 1,200 or less.

A compound having too larger molecular weight is likely to undergo bleed-out, and is not preferable.

### <Content of Low Molecular Weight Compound (A)>

In the present invention, content of the low molecular weight compound (A) is preferably 0.1 to 50 mass parts, more preferably 0.2 to 20 mass parts, further preferably 0.2 to 10 mass parts, and most preferably 0.25 to 5 mass parts, with respect to 100 mass parts of the cellulose compound.

The low molecular weight compound (A) and/or the compound represented by formula (I) is preferred to express a liquid crystal phase within a temperature range of 100° C. to 300° C., more preferably 120° C. to 200° C. With regard to the liquid crystal phase of the low molecular weight compound (A), it is preferred to be a columnar phase, a nematic phase or a smectic phase; more preferred a nematic phase or a smectic phase.

### [Low Molecular Weight Compound (Compound Represented by Formula (A-1))]

In the present invention, the low molecular weight compound (A) is a compound having a structure represented by formula (a) in its skeleton.

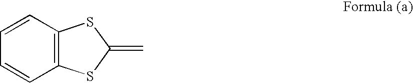

Further, the compound having a structure represented by formula (a) is preferably a compound represented by formula (A-1).

The compound represented by formula (A-1) is described below.

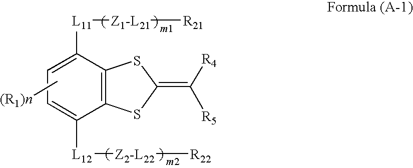

### <R₁>

In formula (A-I), R₁ represents a substituent. When there are two or more R₁, they may be same or different from each other, or form a ring. Examples thereof are the above-mentioned examples for Ra, Rb and Rc in formula (I).

R₁ is preferably a halogen atom, an alkyl group, an alkenyl group, an aryl group, a heterocyclic group, hydroxyl group, a carboxyl group, an alkoxy group, an aryloxy group, an acyloxy group, cyano group or an amino group; more preferably a halogen atom, an alkyl group having 1 to 8 carbon atoms, cyano group or an alkoxy group having 1 to 8 carbon atoms; further preferably chlorine atom, a methyl group, a t-butyl group, cyano group or a methoxy group; and most preferably a methyl group or a t-butyl group.

n is an integer from 0 to 2, and preferably 0 or 1.

### <R₄ and R₅>

R₄ and R₅ each independently is a substituent. Examples thereof are the above-mentioned examples for Ra, Rb and Rc in formula (I).

R₄ and R₅ each are preferably an electron-attractive substituent having Hammett's substituent constant σₚ value of preferably more than 0, more preferably 0.2 or more, further preferably 0.35 or more, and most preferably 0.35 to 1.5.

Herein, the Hammett's substituent constant σ values are described. The Hammett rule is an empirical rule proposed by L. P. Hammett in 1935 to discuss quantitatively the influence of substituents on the reaction or equilibrium of benzene derivatives, and its validity is approved widely nowadays. The substituent constant determined with the Hammett rule includes σₚ value and σₘ value, and these values can be found in many general literatures. For example, such values are described in detail in e.g. “Lange's Handbook of Chemistry”, 12th edition, (1979), edited by J. A. Dean (McGraw-Hill), “Kagaku No Ryoiki” (Region of Chemistry), extra edition, No. 122, pp. 96-103, (1979) (Nankodo), “Chemical Reviews”, Vol. 91, pp. 165-195, (1991), “Hammett Rule—Structure and Reactivity—” by Naoki Inamoto (Maruzen), “New Chemical Experiments, Vol. 14, Synthesis and Reaction of Organic Compounds, V”, page 2605, edited by the Chemical Society of Japan (Maruzen), and “Theoretical Organic Chemistry”, page 217, by Tadao Nakatani (Tokyo Kagaku Dojin).

Examples of the substituent having a Hammett's substituent constant σₚ value of more than 0 include a trifluoromethyl group, a cyano group, a nitro group, a carbonyl group and a carbamoyl group. Among these, preferred examples thereof include a cyano group (0.66), a carboxyl group (—COOH: 0.45), an alkoxycarbonyl group (e.g., —COOMe: 0.45), an aryloxycarbonyl group (e.g., —COOPh: 0.44), a carbamoyl group (—CONH₂: 0.36), an alkylcarbonyl group (e.g., —COMe: 0.50), an arylcarbonyl group (e.g., —COPh: 0.43), an alkylsulfonyl group (e.g., —SO₂Me: 0.72) and an arylsulfonyl group (e.g., —SO₂Ph: 0.68). Herein, “Me” represents a methyl group, and “Ph” represents a phenyl group. The values in the parentheses are σₚ values of typical substituents which are excerpted from Chem. Rev., 91, pp. 165 to 195, (1991).

At least one of R₄ and R₅ is preferably a substituent having a Hammett's substituent constant σₚ value of 0 or more; and both R₄ and R₅ each are particularly preferably a substituent having a Hammett's substituent constant σₚ value of 0 or more.

At least one of R₄ and R₅ is preferably a cyano group, an alkylcarbonyl group, an arylcarbonyl group, an alkyloxycarbonyl group, an aryloxycarbonyl group, a carbamoyl group or a sulfonyl; more preferably a cyano group, an alkylcarbonyl group, an alkyloxycarbonyl group or a carbamoyl group; further preferably a cyano group, an alkylcarbonyl group, an alkyloxycarbonyl group or a carbamoyl group, each having 10 or less carbon atoms; and most preferably a cyano group.

Both R₄ and R₅ each are preferably any one of a cyano group, an alkylcarbonyl group, an arylcarbonyl group, an alkyloxycarbonyl group, an aryloxycarbonyl group, a carbamoyl group and a sulfonyl; and more preferably a cyano group, an alkylcarbonyl group, an alkyloxycarbonyl group and a carbamoyl group.

R₄ and R₅ may be bonded with each other to form a ring. The formed ring may be a saturated or unsaturated, hydrocarbon ring or heterocyclic ring. Examples of the ring formed by R₄ and R₅ include a cyclopropane ring, a cyclobutane ring, a cyclopentane ring, a cyclohexane ring, a cycloheptane ring, a pyrrolidine ring, a tetrahydrofuran ring, a tetrahydrothiophene ring, an oxazoline ring, a thiazoline ring, a pyrroline ring, a pyrazolidine ring, a pyrazoline ring, an imidazolidine ring, an imidazoline ring, a piperidine ring, a piperadine ring, and a pyran ring. These rings may have a substituent at any position on the ring.

The groups represented by -L₁₁-(Z₁-L₂₁)ₘ₁-R₂₁ or -L₁₂-(Z₂-L₂₂)ₘ₂-R₂₂ are described below.

### <L₁₁, L₁₂, L₂₁ and L₂₂>

L₁₁, L₁₂, L₂₁ and L₂₂ each independently represents a single bond, or a divalent linking group selected from the group consisting of —O—, —S—, —S(═O)₂—, —CO—, —NR^{A}— (R^{A} represents an alkyl group having 1 to 7 carbon atoms, or a hydrogen atom), —CH₂— and combination of these (divalent linking group formed by bonding of two or more of the above linking groups).

Example of the divalent linking group formed by bonding of two or more of the above linking groups include —C(═O)O—, —OC(═O)—, —OC(═O)O—, —C(═O)NH—, —NHC(═O)—, —OC(═O)NH—, —NHC(═O)O—, —NHC(═O)NH—, and —O—CH₂—.

L₁₁ and L₁₂ each are preferably a single bond, —O—*, —C(═O)—O—*, —O—C(═O)—*, —O—CO—O—*, or —OCH₂—*; more preferably —O—*, —O—C(═O)—*, —O—CO—O—*, or —OCH₂—* (in which the symbol “*” means the site to be bonded with Z₁).

L₂₁ and L₂₂ each are preferably a single bond, *—O—, *—C(═O)—, *—C(═O)—O—, *—O—C(═O)—, *—O—CO—O—, *OCH₂— or *—CH₂O—; more preferably a single bond, *—O—, *—C(═O)—, *—C(═O)—O— or *—O—C(═O) (in which the symbol “*” means the site to be bonded with Z₁).

### <Z₁ and Z₂>

Z₁ and Z₂ each independently represent a divalent 5- or 6-membered cyclic linking group. As the ring contained in the divalent cyclic linking group, aromatic rings, aliphatic rings and heterocycles can be used. The ring may be a single ring or a fused ring, and also may be substituted.

Examples of the aromatic ring include a benzene ring, a naphthalene ring, an anthracene ring and a phenanthrene ring, each having 6 to 30 carbon atoms. The cyclic group having the benzene ring is preferably a 1,4-phenylene group or a 1,3-phenylene group. The cyclic group having the naphthalene ring is preferably a naphthalene-1,4-diyl group, a naphthalene-1,5-diyl group, a naphthalene-1,6-diyl group, a naphthalene-2,5-diyl group, a naphthalene-2,6-diyl group or a naphthalene-2,7-diyl group.

Among these, particularly preferred ones as the divalent cyclic linking group formed from an aromatic ring are a 1,4-phenylene group, a 1,3-phenylene group and a naphthalene-2,6-diyl group, which may be unsubstituted or substituted, and an unsubstituted or substituted 1,4-phenylene group is most preferred.

Examples of the aliphatic ring include a cyclopentyl ring and a cyclohexane ring, each having 3 to 20 carbon atoms. The cyclic group having the cyclohexane ring is preferably a 1,4-cyclohexylene group. The cyclohexane ring has stereoisomers, namely, a cis-form and a trans-form, but there is no limitation to its isomeric form in the present invention, and a mixture of the two isomeric forms may be used. However, preferred is a trans-cyclohexane ring, and therefore, preferred one as a divalent cyclic linking group formed from an aliphatic ring is a trans-1,4-cyclohexylene group.

Examples of the heterocyclic linking group includes five- or six-membered substituted or unsubstituted aromatic or non-aromatic heterocyclic linking group. Examples of hetero atoms contained in the heterocyclic linking group include N (nitrogen atom), O (oxygen atom), S (sulfur atom) and B (boron atom), but the present invention is not limited thereto. The heterocyclic linking group may preferably contain two or more hetero atoms. The heterocyclic linking group may be monocyclic or may be condensed with other rings, and may have a substituent. Examples of the heterocyclic linking group includes a pyridine ring linking group, a piperidine ring linking group, a piperazine ring linking group, a pyrazine ring linking group, a furan ring linking group, a dioxane ring linking group, a benzimidazole ring linking group, an imidazole ring linking group, a thiophene ring linking group, and a pyrrole ring linking group.

### <R₂₁ and R₂₂>

R₂₁ and R₂₂ each independently represent a hydrogen atom or a substituted or unsubstituted alkyl group. Examples of the alkyl group include those mentioned previously for Ra, Rb and Rc in formula (I).

R₂₁ and R₂₂ each are preferably a substituted or unsubstituted alkyl group having 20 or less carbon atoms; more preferably an unsubstituted alkyl group having 14 or less carbon atoms.

m1 and m2 each represent an integer of 0 to 2, preferably 0 or 1.

When m1 is 2, L₂₁ and Z₁ which are present in pluralities, may be identical or different. Similarly, when m2 is 2, L₂₂ and Z₂ which are present in pluralities, may be identical or different. Furthermore, the group represented by -L₁₁-(Z₁-L₂₁)ₘ₁-R₂₁ and the group represented by -L₁₂-(Z₂-L₂₂)ₘ₂-R₂₂ may be identical or different. From the viewpoint of synthesis, it is preferable that the two groups are identical, but the present invention is not intended to be limited thereto.

Structures that are preferred as the groups represented by -L₁₁-(Z₁-L₂₁)ₘ₁-R₂₁ and -L₁₂-(Z₂-L₂₂)ₘ₂-R₂₂ as discussed above in detail are presented in the following formula (L1), and particularly preferred structures are presented by the following formula (L2). The group of -L₁₂-(Z₂-L₂₂)ₘ₂-R₂₂ is presented as a group obtained by converting L₂₂ to L₂₁, R₂₂ to R₂₁, Z₂ to Z₁, and L₁₂ to L₁₁. These groups respectively have the same meanings.

<Preferred Examples of the Structure Represented by -L₁₁-(Z₁-L₂₁)ₘ₁-R₂₁>

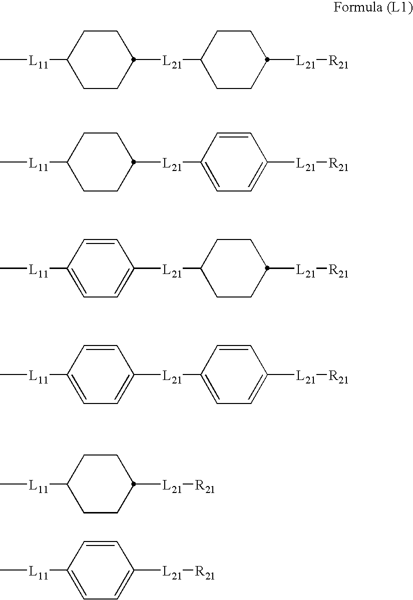

<Particularly Preferred Examples of the Structure Represented by -L₁₁-(Z₁-L₂₁)ₘ₁-R₂₁>

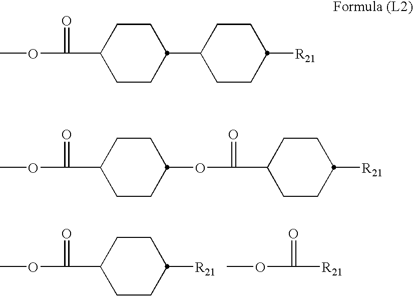

### <Most Preferred Examples of the Compound Represented by Formula (A-1)>

A most preferred example of the compound represented by formula (A-1) of the present invention is such that:

n is 0 or 1; when n is 1, R₁ is a chlorine atom, a methyl group, a t-butyl group or a methoxy group;
R₄ and R₅ are each independently a cyano group, an alkylcarbonyl group, an alkyloxycarbonyl group or a carbamoyl group, each having 10 or less carbon atoms;
L₁₁ and L₁₂ are each a single bond, —O—, —C(═O)—, —C(═O)—O—, —O—C(═O)—, —O—CO—O— or —OCH₂—, and more preferably —O—, —O—C(═O)—, —O—CO—O— or —OCH₂—;
L₂₁ and L₂₂ are each a single bond, —O—, —C(═O)—, —O—CO—O—, —OCH₂— or —CH₂O—, and more preferably a single bond, —O—, —C(═O)—, —C(═O)—O— or —O—C(═O)—;
Z₁ and Z₂ are each an unsubstituted or substituted 1,4-phenylene group or 1,4-cyclohexylene group;
R₂₁ and R₂₂ are each independently an unsubstituted alkyl group; and
m1 and m2 are each independently an integer of 0 to 2.

In the present invention, molecular weight of the compound represented by formula (A-1) is preferably 100 to 2,000, more preferably 200 to 1,500, and most preferably 300 to 1,200.

### <Specific Examples of the Low Molecular Weight Compound (A)>

Hereinafter, specific examples of the low molecular weight compound (A) will be shown, but the present invention is not limited thereto. The following compounds are, unless stated otherwise, presented as exemplified compounds (X) with the number in the parentheses. In the following formulae, n represents an integer of 1 to 8; preferably an integer of 2, 3, 4, 5 or 6. (That is, “1-n” represents eight kinds of compounds such as 1-1, 1-2, 1-3, 1-4, 1-5, 1-6, 1-7 and 1-8, depending on “n” representing the number of carbon atoms.) In the following formulae, m represents an integer of 1 to 14; preferably an integer of 4 to 14.

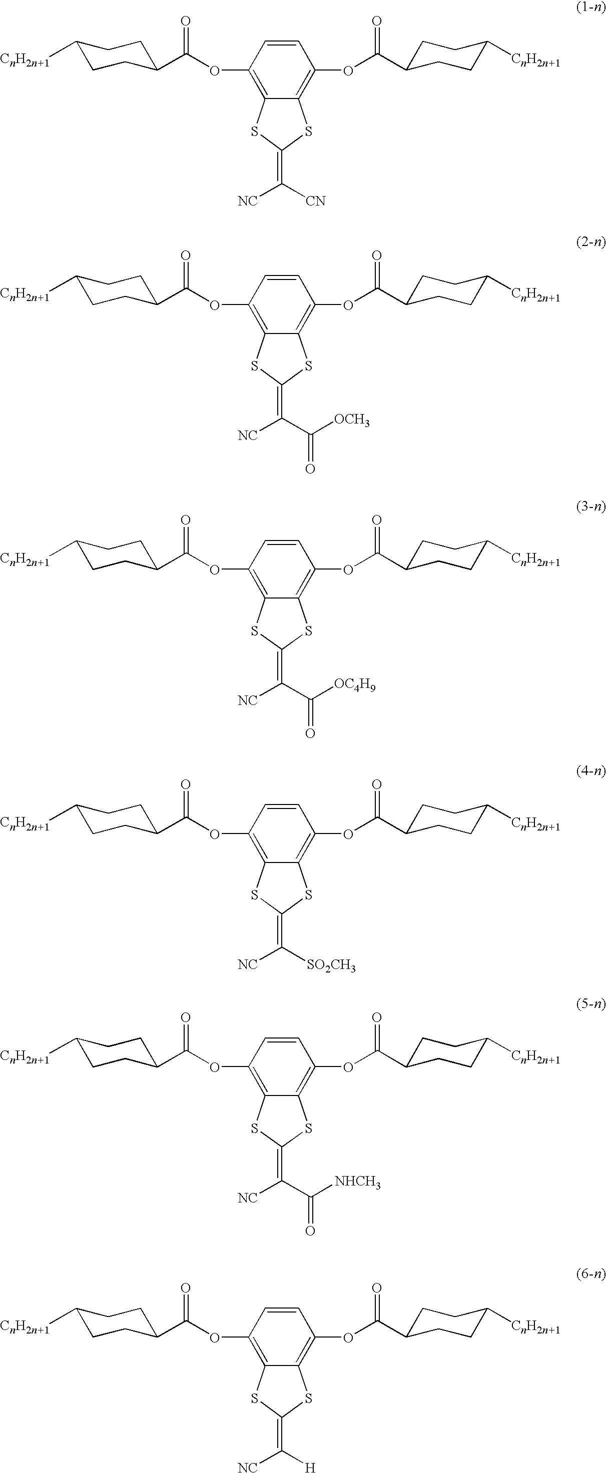

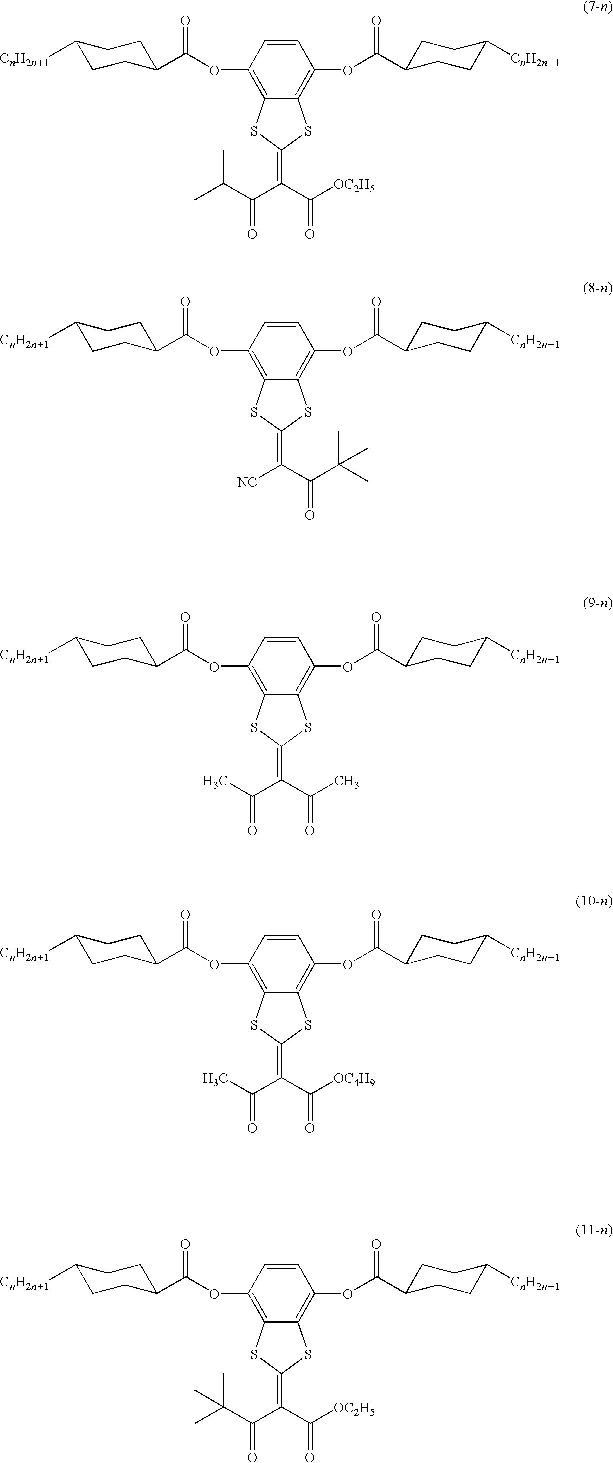

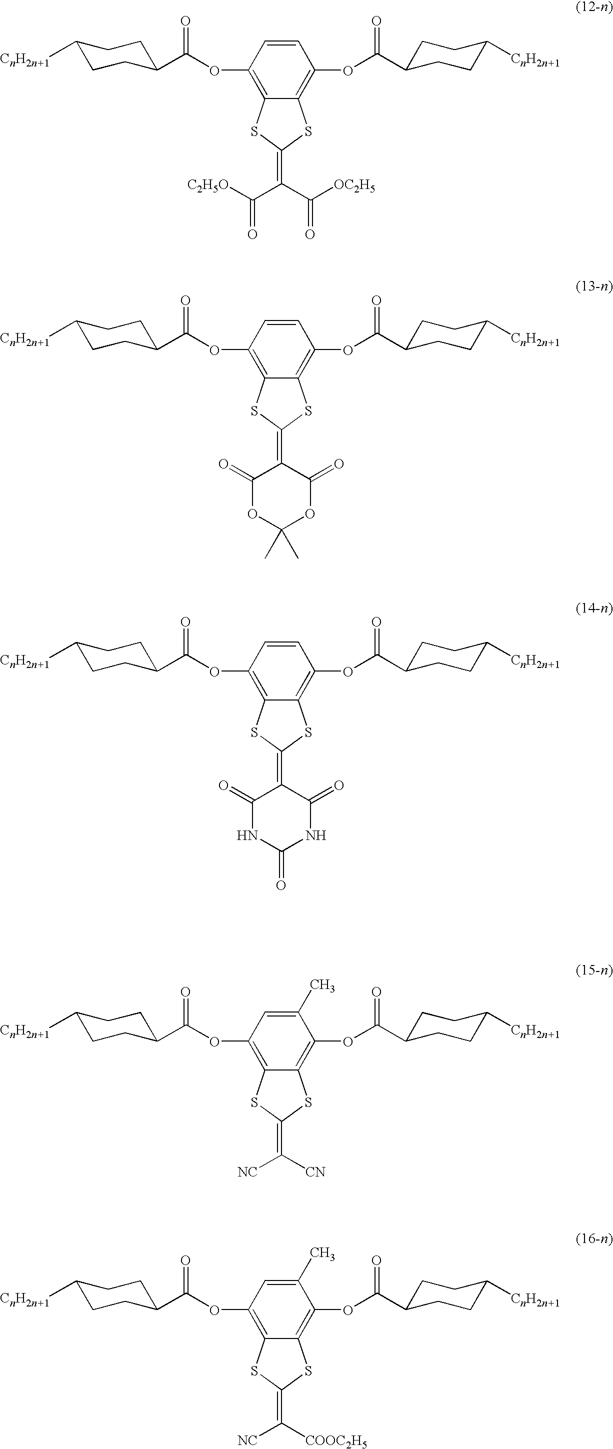

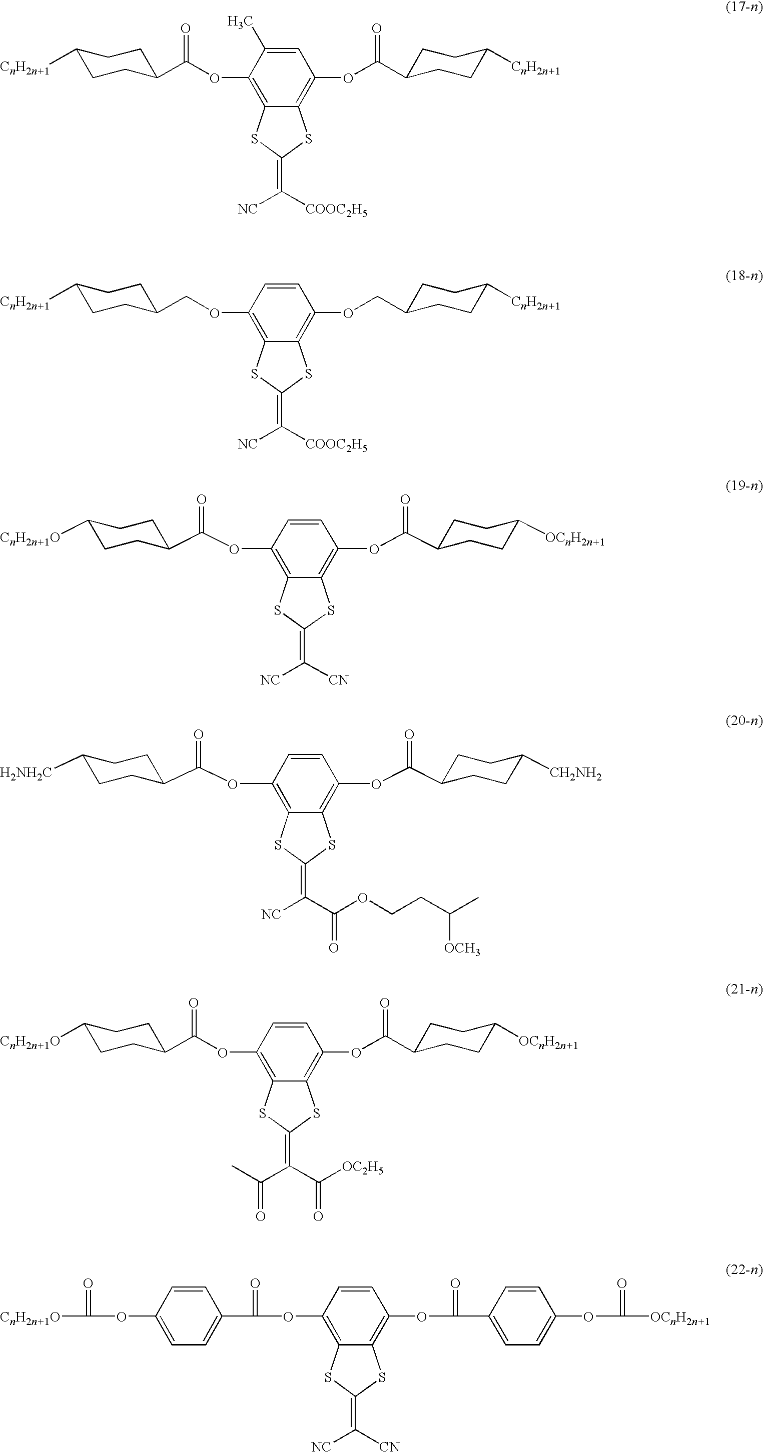

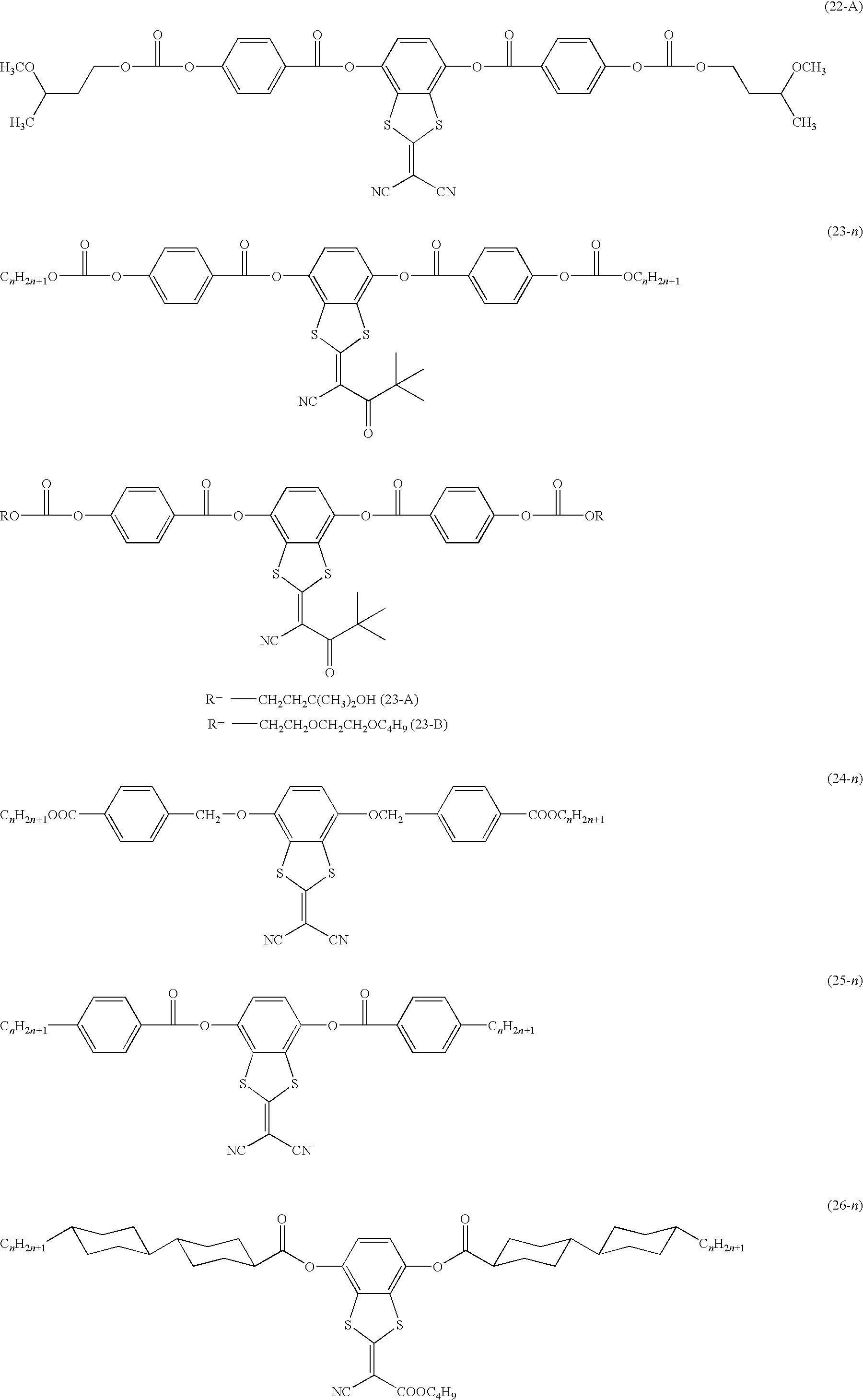

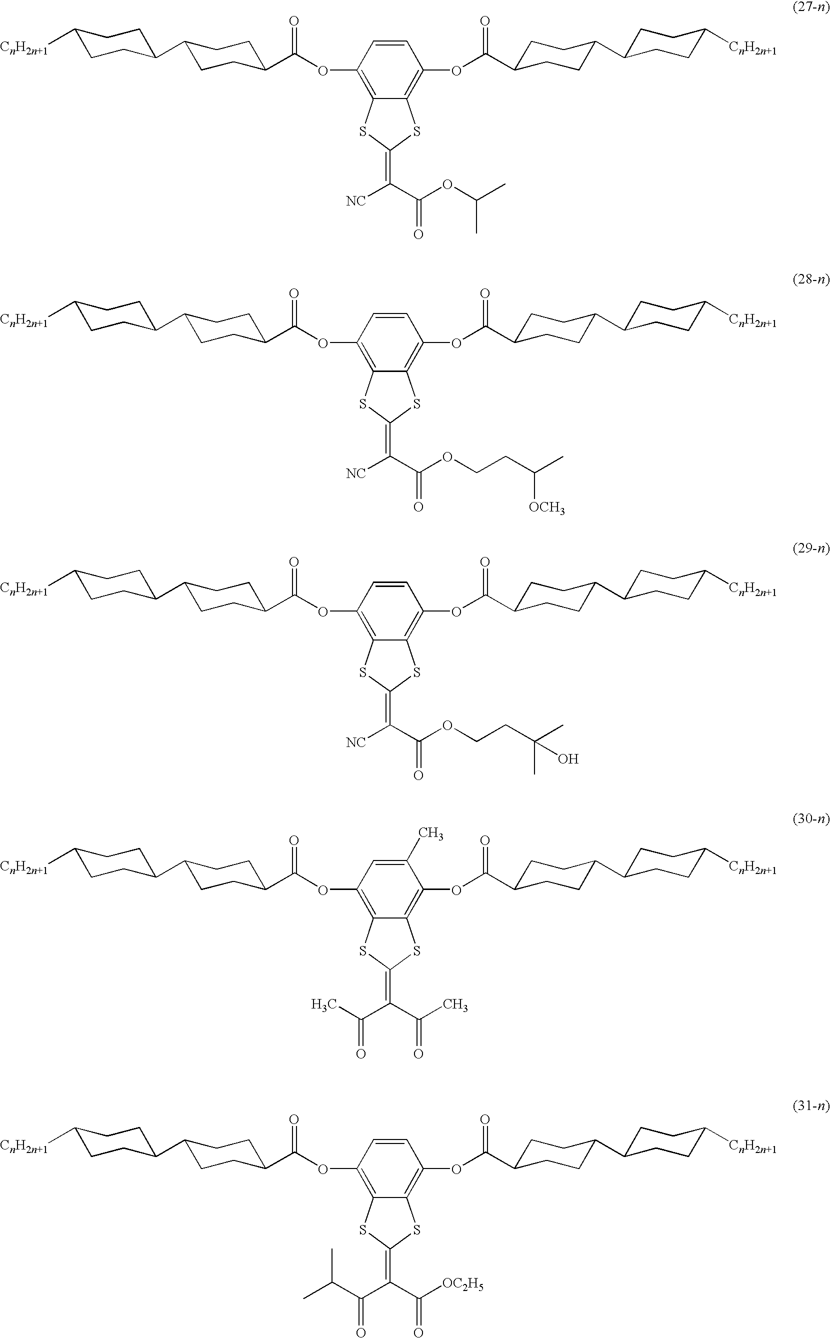

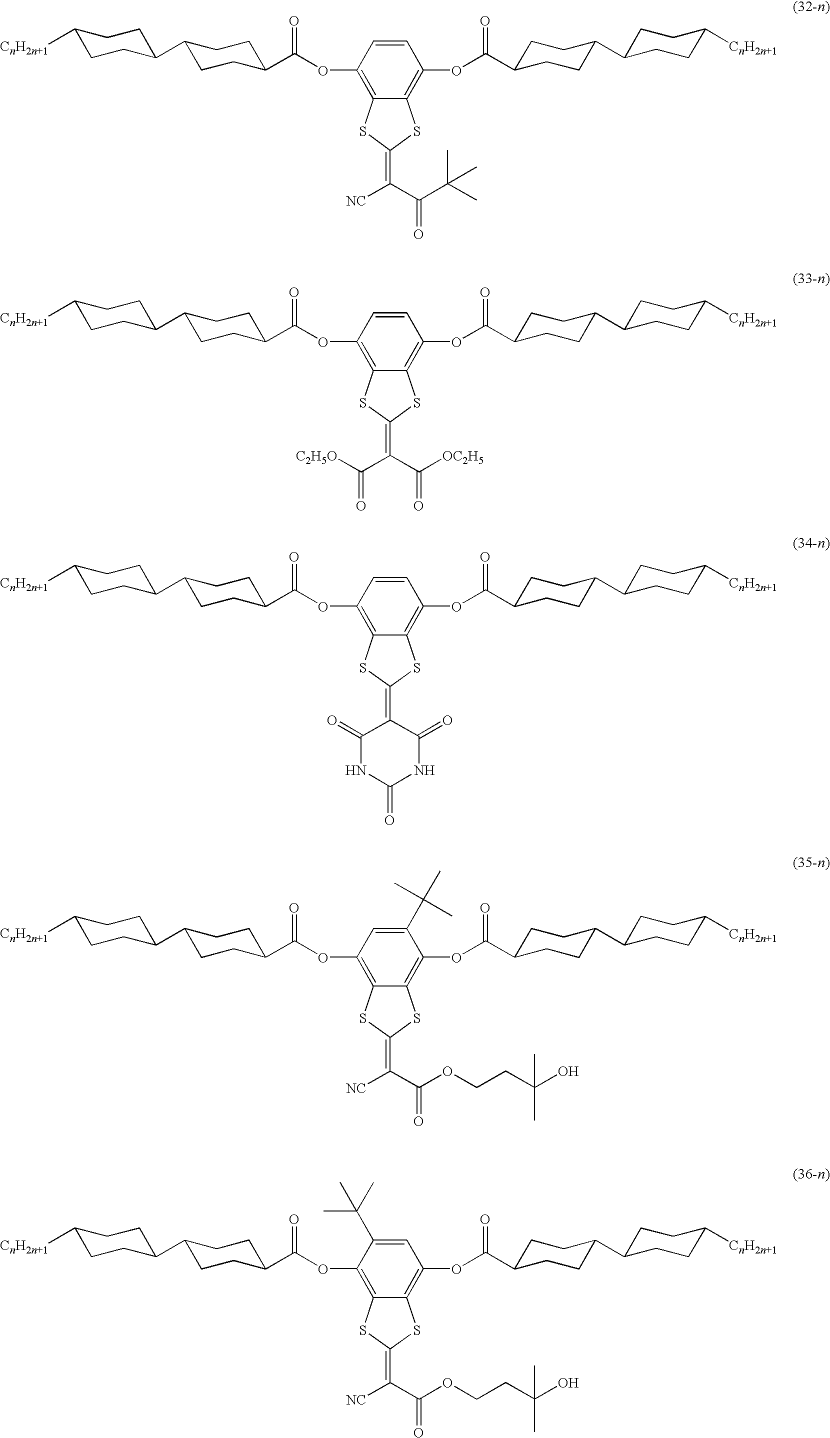

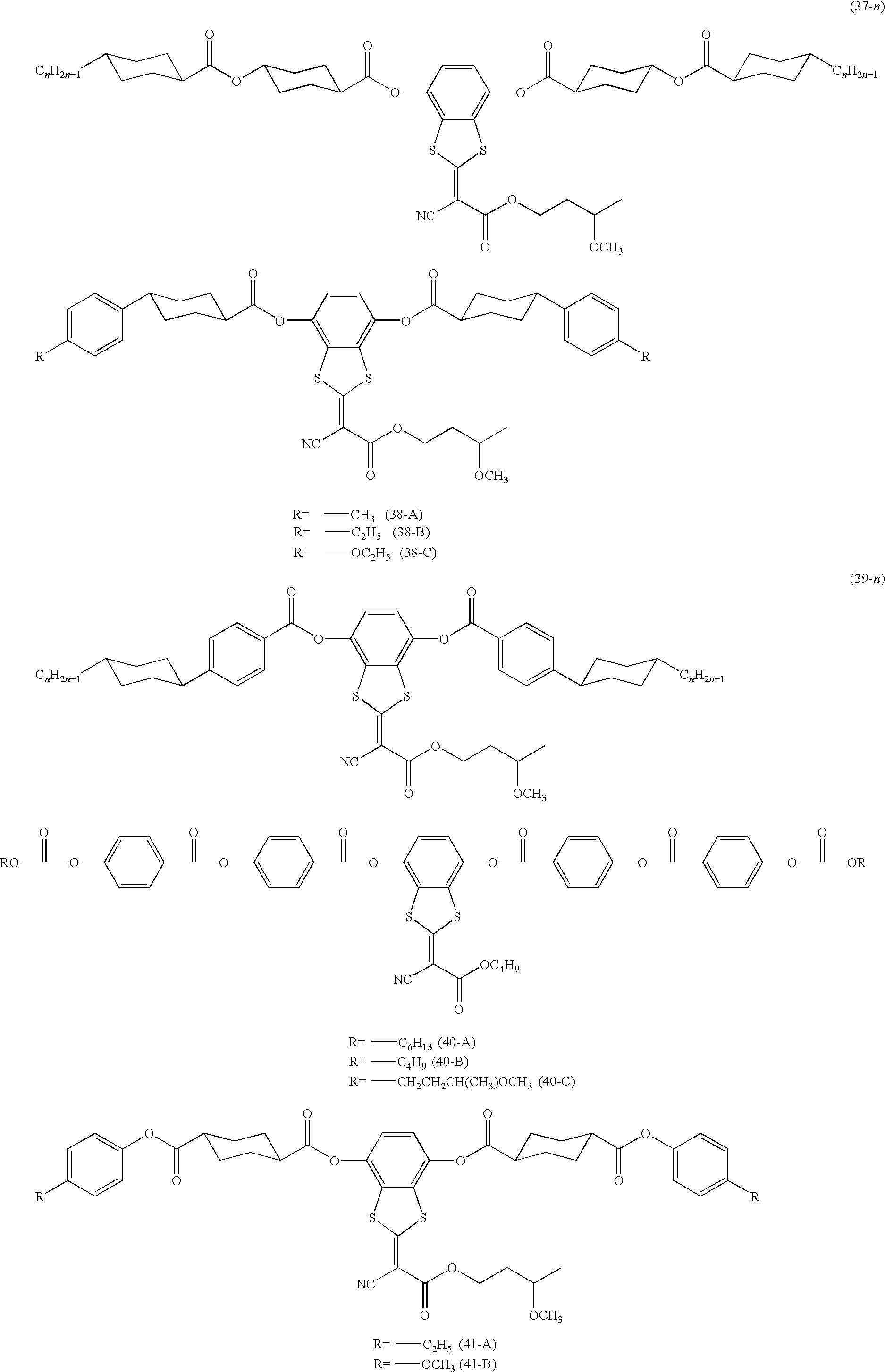

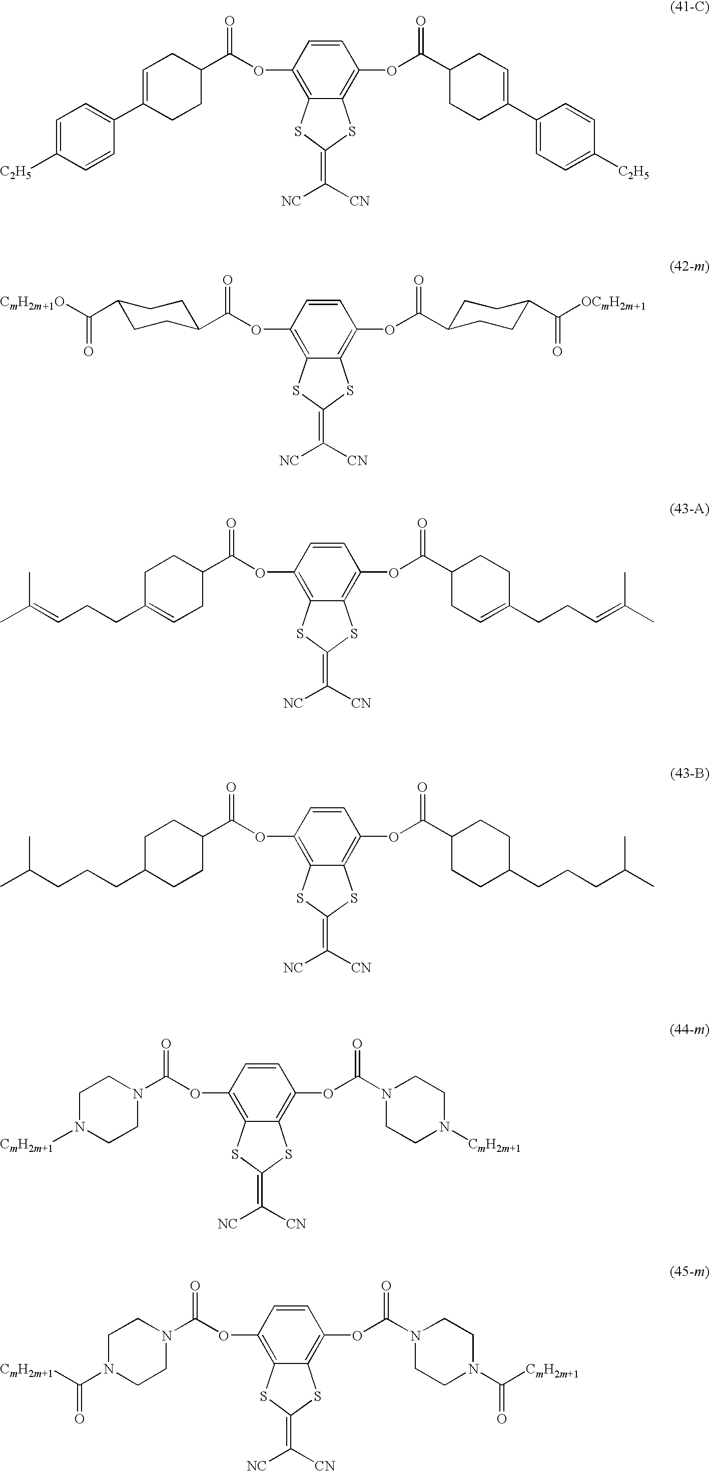

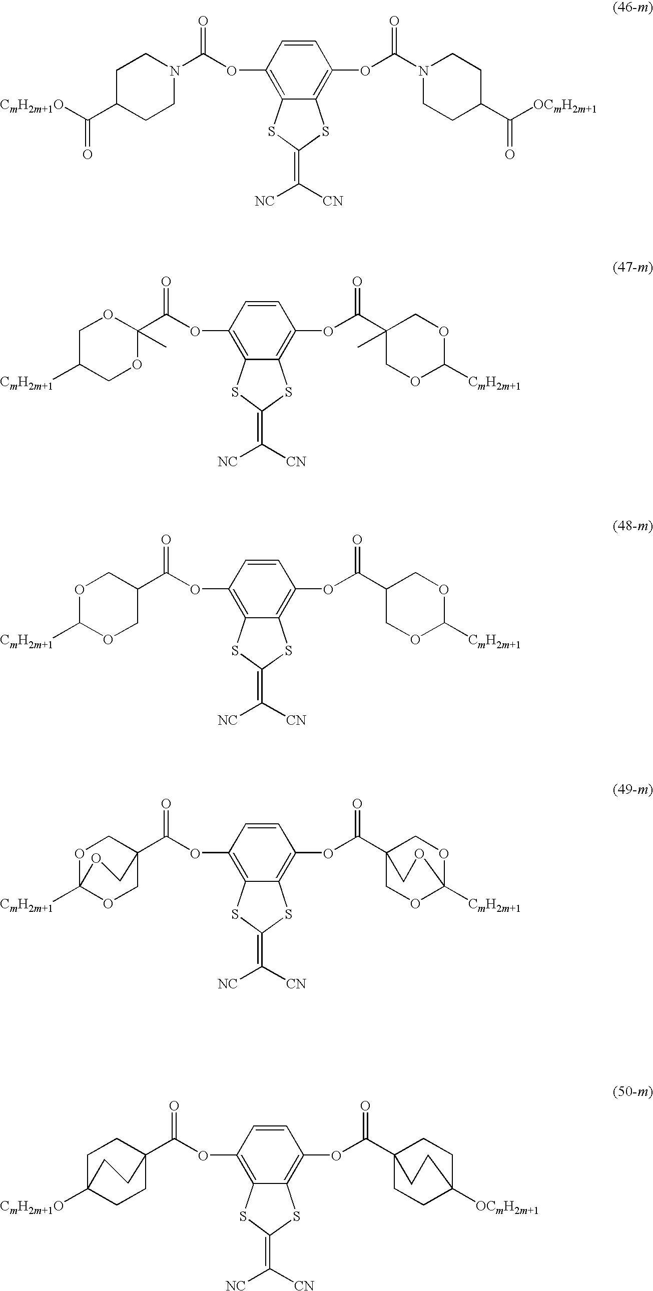

The following specific examples each are an example of a compound, in which R₂₁ and R₂₂ each are a hydrogen atom.

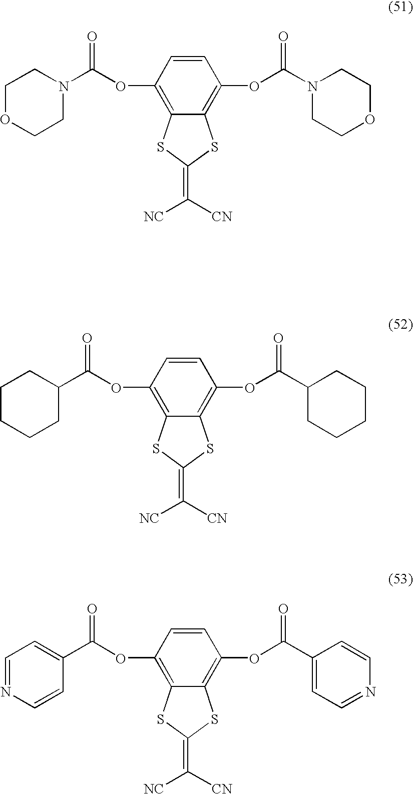

The following specific examples each are an example of a compound, in which m1 and m2 each are 0.

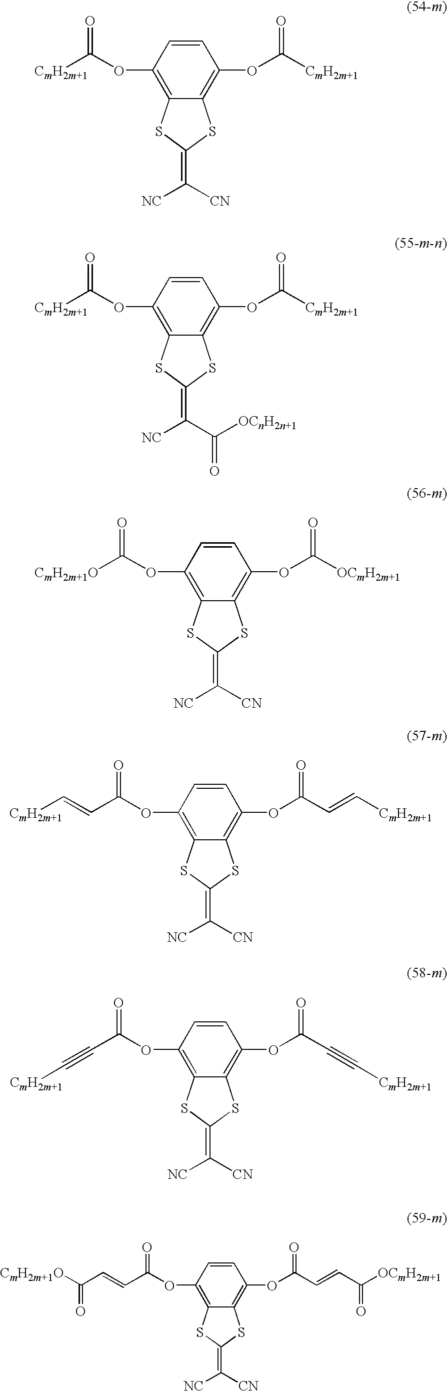

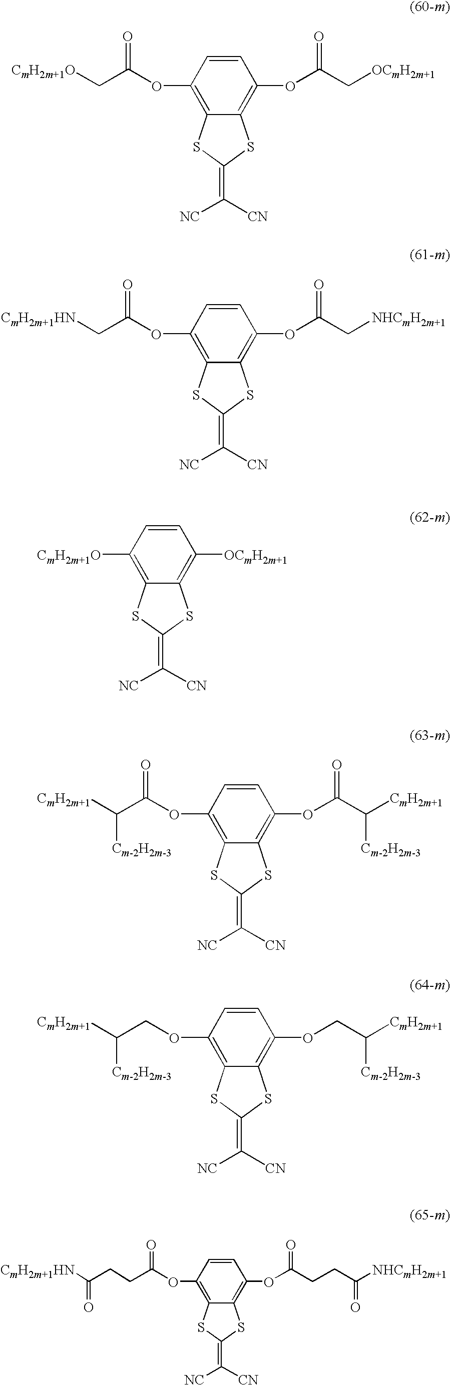

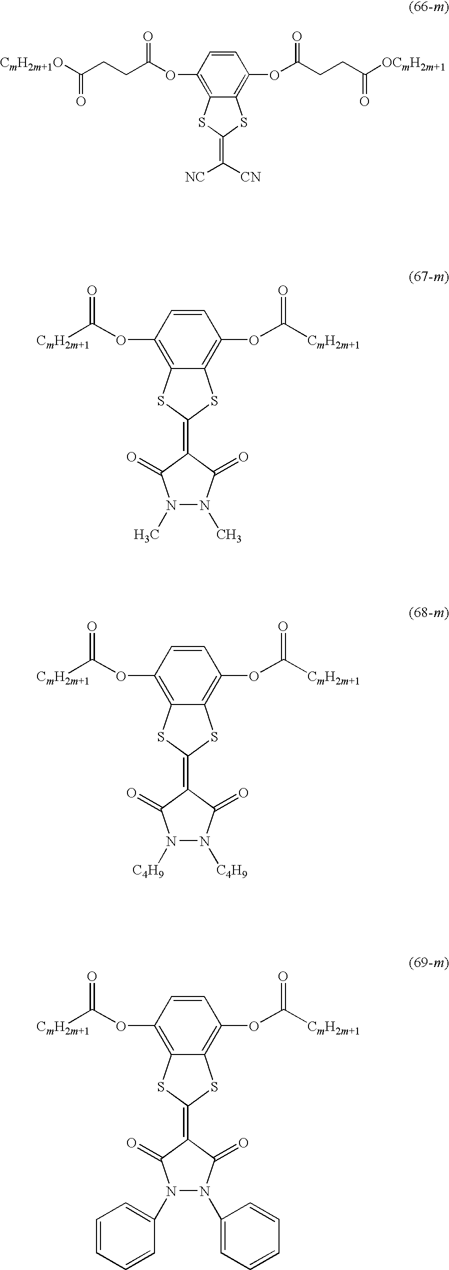

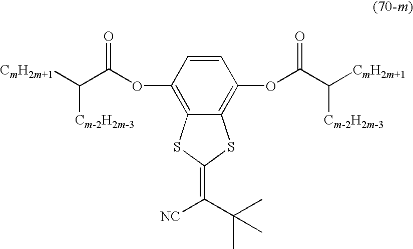

The synthesis of the compound represented by formula (A-1) can be performed by referring to a known method. For example, the compound represented by formula (A-1) can be synthesized referring to the methods described in, for example, paragraph Nos. [0066] to [0067] and [0136] to [0176] in JP-A-2008-107767. Further, intermediates of the compound represented by formula (A-1) can be synthesized referring to the methods described in, for example, J. Org. Chem., 29, p. 660-665 (1964); J. Org. Chem., 69, p. 2164-2177 (2004); Justus Liebigs Annalen der Chemie, 726, p. 103-109 (1969); and Journal of Chemical Crystallography (1997), 27(9), p. 515-526. For example, the following compound can be synthesized according to the following synthesis scheme.

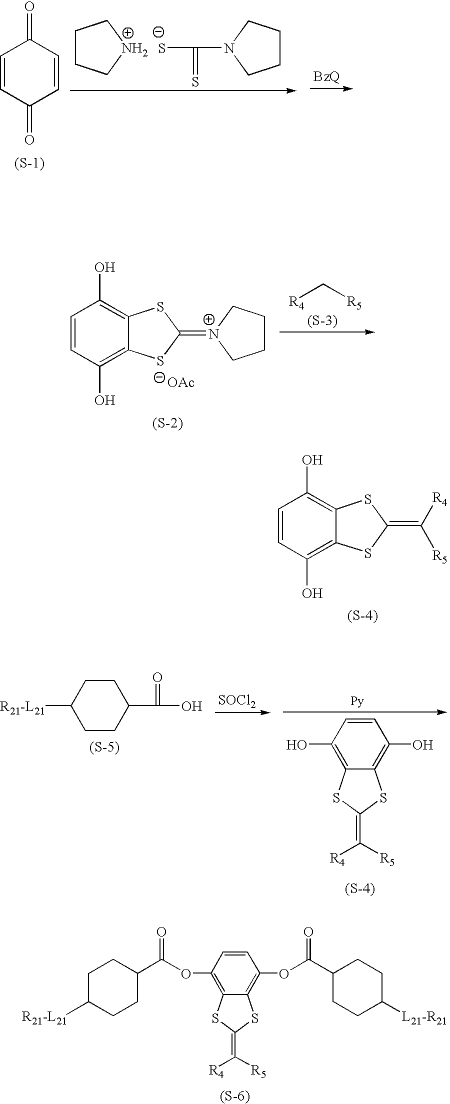

The compounds (S-1) to (S-4) can be synthesized referring to the methods described in, for example, Journal of Chemical Crystallography (1997); 27(9); p. 515-526.

Furthermore, as shown in the scheme, the compound (S-6) included in formula (A-1) can be obtained by adding N,N-dimethylformamide to a toluene solution of the compound (S-5), adding thionyl chloride, heating the mixture under stirring to thereby generate an acid chloride, subsequently adding this acid chloride dropwise to a tetrahydrofuran solution of the compound (S-4), and then adding pyridine under stirring.

Syntheses of other compounds having different substituents or linking groups for formula (A-1) can be carried out based on the method described above, by changing the compound to be used or the reaction to be carried out, but the present invention is not intended to be limited to this synthesis method.

### [Cellulose Composition of the Present Invention]

The cellulose composition of the present invention is a composition containing at least one kind of compound represented by formula (I), at least one kind of low molecular weight compound (A), and a cellulose compound. The composition may even contain two or more kinds each of the compound represented by formula (I) and the low molecular weight compound (A). The cellulose compound will be explained in detail later.

### <Effects of Using Low Molecular Weight Compound (A) and Compound Represented by Formula (I) in Combination>

The low molecular weight compound (A) serves as a retardation-controlling agent for an optical film (particularly, retardation-increasing and wavelength dispersion-controlling agent). In particular, it suitably serves as a retardation-controlling agent for obtaining a film having excellent wavelength dispersion property and Re-expression property with stretching.

The compound represented by formula (I) serves as a retardation-controlling agent for an optical film (particularly, retardation-increasing agent). In particular, it suitably serves as a retardation-controlling agent for obtaining a film having excellent Re-expression property with stretching.

An optical film was produced using the cellulose composition of the present invention, and it was found that when the low molecular weight compound (A) and the compound represented by formula (I) are used in combination, a synergistic effect is obtained in terms of the Re expression properties and wavelength dispersibility, as compared with the case of using the low molecular weight compound (A) alone or the compound represented by formula (I) alone. This is thought to be because, due to the high liquid crystallinity of the low molecular weight compound (A), when the low molecular weight compound (A) and the compound represented by formula (I) are used in combination to produce a cellulose film, these compounds are respectively orientated at a high degree of orientation in the film, and thus high optical expression properties are exhibited.

As a result of such effects, the low molecular weight compounds used in the present invention (the low molecular weight compound (A) and the compound represented by formula (I)) in the cellulose composition can now be used in reduced addition amounts, as compared with the retardation controlling agent that has been conventionally used. Usually, if the addition amounts of low molecular weight compounds are increased in order to give those effects, there are problems of clouding of the dope liquid or whitening of films due to the precipitation of additives (bleed-out). However, if the compounds of the present invention are used in combination, a synergistic effect is obtained with small amounts of the compounds, and therefore the amount to be added of the low molecular weight compounds can be each reduced, while such problems as described above scarcely occur, which is very desirable.

### <Δn of Optical Film>

Hereinafter, Δn of the optical film is described.

Δn is a value obtained by subtracting the refractive index in the direction perpendicular to the orientation direction (hereinafter, referred to as “MD direction”) from the refractive index in the orientation direction (hereinafter, referred to as “TD direction”). Thus, in the present invention, when the wavelength dispersion of the refractive index in the MD direction tends downward compared with one in the TD direction (the slope of Δn when smaller wavelengths are on the left side and larger wavelengths are on the right side), the subtracted value satisfies the following expressions (1) and (2).

1>|Δn(450 nm)/Δn(550 nm)| Expression (1)

1<|Δn(630 nm)/Δn(550 nm)| Expression (2)

The wavelength dispersion of the refractive index is, as represented by the Lorentz-Lorenz expression, closely related to the absorption of a substance. Thus, for allowing the wavelength dispersion in the MD direction to tend downward, when the absorption transition wavelength in the MD direction is shifted to a longer wavelength region than one in the TD direction, a film satisfying the expressions (1) and (2) can be designed. For instance, in a polymer material subjected to a stretching treatment, the MD direction thereof is perpendicular to a molecular chain. Shifting the absorption transition wavelength in the wide direction of the polymer to a longer wavelength region is very difficult for the polymer material.

According to the present invention, by adding the low-molecular weight compound (A) and the compound represented by formula (I) in combination to a polymer material and orientating the polymer material, a film satisfying the expressions (1) and (2) can be designed as far as the absorption transition wavelength of the low-molecular weight compound is in the longer wavelength region in the polymer wide direction (MD direction).

When the refractive index of the low-molecular weight compound in the TD direction is larger than one in the MD direction, there is no problem in that the birefringence Δn (550 nm) of the film to the TD direction is positive. Meanwhile, when the refractive index of the low-molecular weight compound in the MD direction is larger than one in the TD direction, there is no problem as far as the refractive index of the polymer material is large in the TD direction and the birefringence Δn(550 nm) of the film is positive.

That is, it is particularly preferable that the cellulose film containing at least one kind of low molecular weight compound (A) and at least one kind of compound represented by formula (I) of the present invention has a refractive index Δn (550 nm) in the direction of orientation of greater than 0 after being subjected to the orientation treatment, and satisfy expressions (1) and (2).

Birefringence (Δn) is described in detail in, for example, “Ekisho Binran (Handbook of Liquid crystal), p. 201, 2000 (published by MARUZEN Co., Ltd.). Birefringence Δn is generally dependent on temperature. The Δn values defined in the present invention may be measured at any temperature, but the Δn values of the optical film are measured at any temperature of preferably −20 to 120° C.

### [Cellulose Compound]

The film of the cellulose compound can be prepared by using the cellulose composition of the present invention.

In the present invention, the “cellulose compound” is a compound having a basic structure of cellulose, and may be any compound having a cellulose skeleton originated from cellulose and obtained after being biologically or chemically modified with functional group(s). In the present invention, two or more different species of cellulose compounds may be used in a mixed manner.

The cellulose compound is preferably a cellulose ester, more preferably a cellulose acylate (e.g., cellulose triacylate, cellulose acylate propionate). Preferred embodiments, employing a cellulose acylate(s), of the present invention will be described in detail below.

### <Cellulose Acylate Raw Cotton>

As the cellulose usable as a raw material of the cellulose acylate in the present invention, use can be made of cotton linter and wood pulp (e.g., broadleaf pulp, and conifer (needleleaf) pulp). Any cellulose obtained from any raw cellulose may be used, and a plurality of celluloses may be used in combination according to the need. There are detailed descriptions of these raw celluloses in, for example, “Plastic Material Lectures (17) Cellulose Resin” (Marusawa and Uda, The Nikkan Kogyo Shimbun, Ltd., published in 1970), and Japan Institute of Invention and Innovation, “Hatsumei Kyokai Kokai Gihou” (Journal of Technical Disclosure) (Kogi No. 2001-1745, Mar. 15, 2001, Japan Institute of Invention and Innovation), pp. 7 to 8; and the raw celluloses described in these publications may be used in the present invention, but these examples are not intended to be limiting of the cellulose acylate that can be used in the present invention.

The acyl group of the cellulose acylate that can be used in the present invention is not particularly limited, but preferably an acety group, a propionyl group, a butyryl group or a benzoyl group. The total substitution degree of acyl group is preferably in the range of 2.0 to 3.0, and more preferably 2.2 to 2.95. The acyl group is most preferably an acetyl group. When the cellulose acetate, of which acyl group is an acetyl group, is used, it is preferable that the degree of acylation (the total substitution degree of acyl group) is in the range of 2.00 to 2.98, and more preferable 2.7 to 2.97.

Each of the glucose units, which constitute cellulose by bonding through 13-1,4-glycoside bond, has free hydroxyl groups at the 2-, 3-, and 6-positions thereof. A cellulose acylate is a polymer obtained by esterifying a part or the whole of these hydroxyl groups with an acyl group(s). Herein, the “substitution degree” means the ratio of esterification at the 2-, 3-, or 6-positions in the cellulose. Specifically, the 100% esterification of any one of the 2-, 3-, and 6-positions is a substitution degree of 1.

### <Degree of Polymerization of Cellulose Acylate>

The degree of polymerization of cellulose acylate that can be used in the present invention is preferably 180 to 700 in terms of viscosity average degree of polymerization. In the case of cellulose acetate, the degree of polymerization is preferably 180 to 550, more preferably 180 to 400, and particularly preferably 180 to 350, in terms of viscosity average degree of polymerization. By adjusting the degree of polymerization to 700 or less, the viscosity of a dope solution of cellulose acylate becomes an adequate one and the production of a film by flow casting then tends to be facilitated. In addition, adjusting the degree of polymerization to 180 or more is preferable because the strength of a film formed can be further increased. The average polymerization degree can be measured by a limiting viscosity method by Uda et al., (Kazuo Uda and Hideo Saito, “The Journal of the Society of Fiber Science and Technology, Japan”, Vol. 18, No. 1, pp. 105 to 120, 1962). Specifically, it can be determined according to the method described in JP-A-9-95538.

Further, the distribution of molecular weight of a cellulose acylate that can be preferably used in the present invention is evaluated by gel permeation chromatography. It is preferable that the polydisperse index Mw/Mn (Mw, mass average molecular weight; and Mn, number average molecular weight) be small and the distribution of molecular weight be narrow. Specifically, the value of Mw/Mn is preferably from 1.0 to 3.0, more preferably from 1.0 to 2.0, and particularly preferably from 1.0 to 1.6.

About the cellulose acylate that can be used in the present invention, the starting cotton thereof, and the synthesis method thereof are described in detail in, for example, “Kokai Giho” by Japan Institute of Invention & Innovation (Kogi No. 2001-1745, published on Mar. 15, 2001), pp. 7 to 12, and they can be applied to the present invention.

### <Additive to Cellulose Composition>

To the cellulose composition of the present invention (hereinafter, referred to as “cellulose acylate solution” or “dope”), in addition to the low molecular weight compound (A) and the compound represented by formula (I), any of various additives (for example, an optical-characteristic controlling agent such as a ultraviolet absorbent, a plasticizer, a deterioration preventing agent, a peeling accelerator, a dye, matting agent fine particles and an infrared absorbent) may be added. As to the timing at which the low molecular weight compound (A), the compound represented by formula (I) and the other additive(s) is added, they may be added in any of the dope production steps, or may be added in the last step of the dope preparation steps.

The additive(s) may be in a solid or oily state. That is, there is no particular limitation to the melting points or boiling points of the additives. For example, a ultraviolet absorbent having a melting point of less than 20° C. and a ultraviolet absorbent having a melting point of 20° C. or more are used in combination; or, similarly, plasticizers may be used in combination. Specifically, the method described in JP-A-2001-151901 can be applied to the present invention.

### (Ultraviolet Absorbent)

Any kind of ultraviolet absorbent can be selected according to the purpose of use, and examples of the UV absorbent that can be used include those of salicylate-series, benzophenone-series, benzotriazole-series, benzoate-series, cyanoacrylate-series, and nickel complex-series absorbents; and a benzophenone-series, benzotriazole-series, or salicylate-series UV absorbent is preferable.

It is preferable to use two or more kinds of ultraviolet absorbents having different absorption wavelength in combination, because great shielding ability can be obtained in a wide wavelength range. As the ultraviolet absorbent for liquid crystal, preferable one is a ultraviolet absorbent which is excellent in absorption ability for ultraviolet ray of wavelength 370 nm or lower, from the viewpoint of prevention of degradation of the liquid crystal, and which has less absorption of visible light of wavelength 400 nm or higher, from the viewpoint of displaying ability of the liquid crystal. Examples of the particularly preferable ultraviolet absorbent include the aforementioned benzotriazole-series compounds, benzophenone-series compounds, and salicylate-series compounds. Among these, benzotriazole-series compounds are especially preferable, because of little coloration which is unnecessary against cellulose ester.

Further, as the UV absorbent, use can also be made of any of the compounds described in JP-A-60-235852, JP-A-3-199201, JP-A-5-1907073, JP-A-5-194789, JP-A-5-271471, JP-A-6-107854, JP-A-6-118233, JP-A-6-148430, JP-A-7-11056, JP-A-7-11055, JP-A-7-11056, JP-A-8-29619, JP-A-8-239509, and JP-A-2000-204173.

The amount of the ultraviolet absorbent to be added is preferably 0.001 to 5 mass %, more preferably 0.01 to 1 mass %, to the cellulose acylate. When the amount to be added is not less than 0.001 mass %, the addition effect can be sufficiently exhibited, which is preferable, and when the amount to be added is not more than 5 mass %, the ultraviolet absorbent can be prohibited from being bleed out on the film surface, which is preferable.

### (Deterioration Preventing Agent)

The deterioration preventing agent may be added to prevent cellulose triacetate etc. from its degradation and decomposition. As the deterioration preventing agent, butyl amine, hindered amine compounds (JP-A-8-325537), guanidine compounds (JP-A-5-271471), benzotriazole-series UV absorbents (JP-A-6-235819), benzophenone-series UV absorbents (JP-A-6-118233), or the like can be used.

### (Plasticizer)

The plasticizer that can be used in the present invention is preferably a phosphate, a carboxylate, fatty acid esters of polyhydric alcohol, polyesters and/or a monosaccharide or a derivative of carbohydrate having 2 to 10 monosaccharide unit (hereinafter, referred to as “carbohydrate-series plasticizer”). Preferred examples of the phosphate-series plasticizer include triphenyl phosphate (TPP), tricresyl phosphate (TCP), cresyl diphenyl phosphate, octyl diphenyl phosphate, biphenyl diphenyl phosphate (BDP), trioctyl phosphate, and tributyl phosphate. Preferred examples of the carboxylate-series plasticizer include dimethyl phthalate (DMP), diethyl phthalate (DEP), dibutyl phthalate (DBP), dioctyl phthalate (DOP), diphenyl phthalate (DPP), diethyl hexyl phthalate (DEHP), triethyl O-acetylcitrate (OACTE), tributyl O-acetylcitrate (OACTB), triethyl acetyl citrate, tributyl acetyl citrate, butyl oleate, methyl acetyl ricinoleate, dibutyl sebacate, triacetin, tributyrin, butyl-phthalyl-butyl glycolate, ethyl phthalyl ethyl glycolate, methyl phthalyl ethyl glycolate, and butyl-phthalyl-butyl glycolate. Preferred examples of the fatty acid esters of polyhydric alcohol include (di)pentaerythritol esters, glycerol esters, and diglycerol esters. Preferred examples of the carbohydrate-series plasticizer include xylose tetraacetate, glucose pentaacetate, fructose pentaacetate, mannose pentaacetate, galactose pentaacetate, maltose octaacetate, cellobiose octaacetate, sucrose octaacetate, xylitol pentaacetate, sorbitol hexaacetate, xylose tetrapropionate, glucose pentapropionate, fructose pentapropionate, mannose pentapropionate, galactose pentapropionate, maltose octapropionate, cellobiose octapropionate, sucrose octapropionate, xylitol pentapropionate, and sorbitol hexapropionate.

### (Peeling Accelerator)

Examples of the peeling accelerator include ethyl esters of citric acid.

### (Infrared Absorbent)

Preferred examples of the infrared absorbent include those described in, for example, JP-A-2001-194522.

### (Dye)

In the present invention, a dye may be added, to adjust the hue of the resultant film. The amount to be added of the dye is preferably 10 to 1,000 ppm, more preferably 50 to 500 ppm, in terms of ratio by mass to the cellulose acylate. The dyes described in, for example, JP-A-5-34858 may also be used.

### (Matting Agent Fine-Particles)

It is also acceptable to add fine particles as a matting agent to the cellulose acylate solution, and to incorporate them the cellulose acylate film of the present invention. Examples of the fine particles that can be used in the present invention include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate, and calcium phosphate. The fine particles are preferably those containing silicon, from the viewpoint of obtaining low turbidity, and particularly silicon dioxide is preferable. Fine particles of silicon dioxide are preferably those having a primary average particle diameter of 20 nm or less and an apparent specific gravity of 70 g/L or more. Particles having a primary average particle diameter as small as 5 to 16 nm are able to reduce the haze of the film, and are hence more preferable. The apparent specific gravity is preferably 90 to 200 g/L, and more preferably 100 to 200 g/L. A larger apparent specific gravity makes it possible to prepare a high concentration dispersion, to thereby better haze and coagulation, which is preferable.

As the fine particles of silicon dioxide, for example, commercially available products under such trade names as Aerosil R972, R972V, R974, R812, 200, 200V, 300, R202, OX50, TT600 (manufactured by Nippon Aerosil Co., Ltd.) may be used. The fine particles of zirconium oxide are commercially available, for example, under such trade names as Aerosil R976 and R811 (manufactured by Nippon Aerosil Co., Ltd.), which may be used in the present invention.

### (Ratios of Compounds to be Added)

In the film obtained by using the cellulose acylate solution of the present invention, the total amount of compounds having a molecular weight of 3,000 or less is preferably 5 to 45 mass %, more preferably 10 to 40 mass %, and further preferably 15 to 30 mass %, to the mass of the cellulose acylate. These compounds include, as mentioned above, the optical-characteristic controlling agent such as compounds lowering optical anisotropy, agents for controlling wavelength dispersion, ultraviolet absorbents, plasticizers, deterioration preventing agents, peeling accelerators, dyes, matting agent fine particles, and infrared absorbents. Further, it is preferable that the total amount of compounds having molecular weights of 2,000 or less be in the above ranges. By adjusting the total amount of the compounds to 5 mass % or more, it becomes difficult to expose the nature of cellulose acylate as a single substance. For instance, the optical characteristics or physical strength of the film are hardly varied due to the change of temperature and humidity. In addition, it is preferable to adjust the total amount of those compounds to 45 mass % or less, because the amount of the compounds does not exceed the limit in which the compounds are compatible in the cellulose acylate film, and as a result, the film is prevented from being whitened or whitely turbid by precipitation of the compounds on the surface of the film (flow or bleed out from a film).

### <Organic Solvent of Cellulose Acylate Solution>

In the present invention, the cellulose acylate film is preferably prepared according to a solvent cast method. In the solvent cast method, it is preferable that a solution (dope) in which a cellulose acylate is dissolved in an organic solvent is used, to prepare a film. The organic solvent, which is preferably used as a main solvent in the present invention, is preferably one selected from a ketone, an ether and an ester each having 3 to 12 carbon atoms, and a halogenated hydrocarbon having 1 to 7 carbon atoms. The ester, ketone, or ether may have a cyclic structure. A compound having two or more functional groups of ester, ketone or ether (i.e. —O—, —CO—, or —COO—) can also be used as a main solvent. The organic solvent may have another functional group, such as an alcoholic hydroxyl group. When the main solvent is a compound having two or more kinds of functional groups, the number of carbon atoms can be within any of the above ranges defined for the compound having any of the functional groups.

In the present invention, for a cellulose acylate film, a chlorine-containing halogenated hydrocarbon may be used as a main solvent, or a non-chlorine-containing solvent may be used as a main solvent, as described in, for example, “Kokai Giho” by Japan Institute of Invention and Innovation, 2001-1745 (pp. 12 to 16).

A solvent for the cellulose acylate solution and film of the present invention, including a dissolving method, is described, as preferred embodiments, in following patent literatures: JP-A-2000-95876, JP-A-12-95877, JP-A-10-324774, JP-A-8-152514, JP-A-10-330538, JP-A-9-95538, JP-A-9-95557, JP-A-10-235664, JP-A-12-63534, JP-A-11-21379, JP-A-10-182853, JP-A-10-278056, JP-A-10-279702, JP-A-10-323853, JP-A-10-237186, JP-A-11-60807, JP-A-11-152342, JP-A-11-292988, JP-A-11-60752 and JP-A-11-60752.

These patent literatures describe not only a solvent preferable for the cellulose acylate that can be used in the present invention but also properties of the solution and co-existence materials that are made to coexist, and constitute preferable embodiments also in the present invention.

### [Optical Film]

A method of producing a film by using the cellulose acylate solution (hereinafter, also referred to as “cellulose acylate film of the present invention”) will be explained. As the method and equipment for producing the cellulose acylate film of the present invention, the same solution casting film-producing method and solution casting film producing apparatus that are used in the production of an ordinary cellulose triacetate film may be used.

### <Producing Process of Cellulose Acylate Film>

### (Dissolution Step)

With regard to the preparation of the cellulose acylate solution (dope), there is no particular limitation to a method used to dissolve cellulose acylate. The dissolution may be carried out at the room temperature, or alternatively the dissolution may be carried out by a cooling dissolution method, a high-temperature dissolution method, or a combination of these methods. As to the preparation of the cellulose acylate solution, and the concentration and filtration of the solution associated with the dissolution step, the production processes described in detail in “Kokai Giho” by Japan Institute of Invention and Innovation Kogi No. 2001-1745, published on Mar. 15, 2001, pp. 22 to 25 are preferably used.

In the present invention, the dope transparency of the cellulose acylate solution is preferably 85% or more, more preferably 88% or more, and further preferably 90% or more. In the present invention, it can be thereby confirmed that various additives are sufficiently dissolved in the cellulose acylate dope solution. As to a specific method to calculate the dope transparency, the dope solution is injected into a glass cell which is 1 cm by 1 cm square, to measure the absorbance of the solution at a wavelength of 550 nm by using a spectrophotometer (UV-3150, trade name, manufactured by Shimadzu Corporation). The absorbance of the solvent may be measured as a control in advance, to calculate the transparency of the cellulose acylate solution from the ratio of the absorbance of the solution to that of the control.

### (Casting, Drying and Winding Steps)

A dope (a cellulose acylate solution) prepared in a dissolution machine (pot) is once stored in a storage pot, and, after defoaming to remove the foams in the dope, the dope is subjected to the final preparation. The dope is discharged from a dope exhaust and fed into a pressure die via, for example, a pressure constant-rate gear pump whereby the dope can be fed at a constant flow rate at a high accuracy depending on a rotational speed. From a pipe sleeve (slit) of the pressure die, the dope is uniformly cast onto a metallic support continuously running in the casting section. At the peeling point where the metallic support has almost rounded in one cycle, the half-dried dope film (also called a web) is peeled from the metallic support. The obtained web is clipped at both ends and dried by conveying with a tenter while maintaining the width at a constant level. Subsequently, the thus-obtained film is mechanically conveyed with rolls in a dryer, to complete the drying, followed by winding with a winder into a rolled shape in a given length. Combination of the tenter and rolls in the dryer may vary depending on the purpose. In the solvent cast film-forming method utilized to produce a silver halide photographic light-sensitive material or a functional protective film that is an optical part for electronic displays, which are major application usages of cellulose acylate films of the present invention, a coater is additionally employed in many cases, in addition to the solvent cast film-forming apparatus, so as to treat the film surface by providing, for example, an undercoat layer, an antistatic layer, an anti-halation layer or a protective layer. These production steps are described in detail in “Hatsumei Kyokai Kokai Giho” (Journal of Technical Disclosure) (Kogi No. 2001-1745, published Mar. 15, 2001, Japan Institute of Invention and Innovation), pp. 25 to 30, and they are classified into casting (including co-casting), metal supports, drying, releasing (peeling), etc., which can be preferably used in the present invention.

### <Control of Retardation Value>

### (Stretching)

The cellulose acetate film that can be used in the present invention is preferably subjected to stretching, to adjust the retardation. In particular, when the in-plane retardation value of a cellulose acetate film is to be made a high value, use may be made of a method of positively stretching said film in the transverse direction, for example, a method of stretching the produced film, as described, for example, in JP-A-62-115035, JP-A-4-152125, JP-A-4-284211, JP-A-4-298310, and JP-A-11-48271.

Stretching of the film is carried out under the condition of the ordinary temperature or under heating. The stretching is preferably performed at a temperature from (glass transition temperature of film) to (glass transition temperature of film+40° C.). In the case of dry film, the stretching temperature is preferably from 130° C. to 200° C. Also, in the case of performing the stretching in a state of the dope solvent remaining after casting, stretching at a temperature lower than that for the dry film can be performed. In this case, the stretching temperature is preferably from 100° C. to 170° C.

The stretching of the film may be carried out by uniaxial stretching only in the longitudinal or transverse direction, or biaxial stretching in a simultaneous or successive manner. The stretching is preferably in the range of from 1 to 200%, more preferably in the range of from 1 to 100%, and particularly preferably in the range of from 1 to 50%.

The film thickness of the cellulose acylate film, that is preferably used in the present invention, obtained after drying may vary depending on the purpose of use, but it is preferably from 5 to 500 μm, more preferably 20 to 300 μm, and particularly preferably 30 to 150 μm. The film thickness of the cellulose acylate film is preferably 40 to 110 μm, when the film is applied to optical devices, particularly VA liquid crystal displays. In order to control the thickness of the film, it is sufficient to control, for example, the concentration of the solid contained in the dope, the slit gap of a die nozzle, the extrusion pressure from the die, and the speed of the metal support, to attain a target thickness.

### <Optical Performances of Cellulose Acylate Film>

### [Retardation of Film]

### (Measurement of Re and Rth)

In the present specification, Re(λ) and Rth(λ) each indicate retardation in plane and retardation along thickness direction at a wavelength λ. Re(λ) is measured by applying a light having a wavelength of λ nm in the normal line direction of a film, using KOBRA-21ADH or WR (trade name, manufactured by Oji Scientific Instruments). Upon selection of the measurement wavelength λ nm, measurements can be made by exchanging the wavelength selection filter manually, or by converting the measurement values with a computer program or the like.

When the film to be tested is represented by an uniaxial or biaxial refractive index ellipsoid, then its Rth(λ) is calculated according to the method mentioned below.

Rth(λ) is calculated using KOBRA 21ADH or WR on the basis of: the above-described Re(λ); retardation values in total six directions measured by making light of wavelength λ nm incident in the normal direction and directions inclined to 50° at an interval of 10° over the normal direction of the film with the in-plane slow axis (judged by the KOBRA 21ADH or WR) as an inclined axis (a rotation axis) (or with an arbitrary direction in the film plane as a rotation axis when there is no retardation axis); the estimated average refractive index; and, the input value of the film thickness.

In the above-described method, when the film has a retardation value of zero in a direction inclined to a certain degree over the normal direction with the in-plane slow axis as a rotation axis, the retardation value in a direction inclined to a larger degree than the inclination angle is calculated by KOBRA 21ADH or WR, after the sign of the retardation value is converted to negative.

Alternatively, Rth may also be calculated by mathematical formulae (21) and (22), on the basis of: retardation values measured from arbitrary inclined two directions, with the slow axis as an inclined axis (a rotation axis) (or with the in-plane arbitrary direction as a rotation axis when there is no retardation axis); the estimated average refractive index; and the input value of the film thickness.

$$\begin{matrix}Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & Formula ( 21 ) \\ Rth = \{ ( nx + ny ) / 2 - nz \} \times d & Formula ( 22 )\end{matrix}$$

The above Re(θ) represents a retardation value in the direction inclined by an angle θ from the normal direction. In the mathematical formula (2), nx represents a refractive index in the slow axis direction in the plane, ny represents a refractive index in the direction orthogonal to nx in the plane, and nz represents a refractive index in the direction orthogonal to nx and ny. d represents film thickness.

In the case where the film to be measured cannot be expressed by a uniaxial or biaxial index ellipsoid, i.e. a film having no so-called optic axis, the Rth(λ) thereof is calculated as follows.

Rth(λ) is calculated using KOBRA 21ADH or WR, on the basis of: the above-described Re(λ); retardation values measured in eleven directions, by making light of wavelength λ nm incident in the directions inclined to −50° to +50° at an interval of 10° over the normal direction of the film with the in-plane slow axis (judged by the KOBRA 21ADH or WR) as an inclined axis (a rotation axis); the estimated average refractive index; and the input value of the film thickness.

In the above measurement methods, as the estimated (hypothetical) value of the average refractive index, use may be made, for example, of values described in “Polymer Handbook” (JOHN WILEY & SONS, INC.) and values described in catalogues of various optical films. For films whose average refractive indexes are unknown, the values may be measured to determine by an Abbe refractometer. Average refractive indexes of major optical films are exemplified in below: cellulose acetate (1.48), cycloolefin polymer (1.52), polycarbonate (1.59), polymethyl methacrylate (1.49), and polystyrene (1.59). KOBRA 21ADH or WR can calculate nx, ny, and nz, by inputting these estimated values of the average refractive index and the film thickness.

It is preferable that the Re(λ) value and the Rth(λ) value satisfy the following expressions (5) and (6), respectively, to widen the angle of field of view of a liquid crystal display, particularly a VA or OCB mode liquid crystal display. Further, this is particularly preferable when the cellulose acylate film is used for the protective film on the liquid crystal cell side of the polarizing plate.

0 nm≦Re(590)≦200 nm Expression (5)

0 nm≦Rth(590)≦400 nm Expression (6)

In the above expressions, Re(590) and Rth(590) each are a value (unit: nm) measured at wavelength of 590 nm.

It is preferable that the Re(λ) value and the Rth(2) value satisfy the following expressions (5-1) and (6-1), respectively.

30 nm≦Re(590)≦150 nm Expression (5-1)

30 nm≦Rth(590)≦300 nm Expression (6-1)

When the cellulose acylate film of the present invention is used in a VA or OCB mode, there are two types of structures: a structure (two-film type) in which the film is applied to each side of a cell, i.e. the total two films are utilized; and a structure (one-film type) in which the film is applied only one side of a cell.

In the case of the two-film type, the Re(590) is preferably 20 to 100 nm, more preferably 30 to 70 nm; and the Rth(590) is preferably 70 to 300 nm, more preferably 100 to 200 nm.

In the case of the one-film type, the Re(590) is preferably 30 to 150 nm, more preferably 40 to 100 nm; and the Rth(590) is preferably 100 to 300 nm, more preferably 150 to 250 nm.

### <Moisture Permeability of Film>

The moisture permeability of a cellulose acylate film of the present invention to be used for a retardation sheet (optical compensation sheet) is preferably 400 to 2,000 g/m²·24 h, more preferably 500 to 1,800 g/m²·24 h, and particularly preferably 600 to 1,600 g/m²·24 h, based on the case where the film thickness be 80 μm in measurement under the conditions of temperature 60° C. under humidity 95% RH (relative humidity) according to JIS Standard, JIS Z0208.

As a method of measuring the moisture permeability, the method described in “Properties of Polymers II” (Polymer Experiment Lesson 4, Kyoritsu Shuppan), pp. 285 to 294: Measurement of Amount of Vapor Transmission (Mass method, Temperature gauge method, Vapor pressure method, and Adsorption amount method), may be applied. That is, a 70 mmφ cellulose acylate film sample according to the present invention is humidity-controlled at 25° C. under humidity 90% RH and at 60° C. under humidity 95% RH, respectively for 24 hours, to measure the amount of water per unit area (g/m²), by using a moisture permeability tester (trade name: KK-709007, manufactured by Toyo Seiki Seisaku-sho, Ltd.), according to JIS Z-0208, and then the moisture permeability is calculated from the following equation:

(Moisture permeability)=(Mass after moisture control)−(Mass before moisture control).

### <Amount of Residual Solvent in Film>

In the present invention, it is preferable to dry the cellulose acylate film in the condition that the amount of a residual solvent is decreased to an amount range from 0.01 to 1.5% by mass, more preferably 0.01 to 1.0% by mass, to the cellulose acylate film. In the case that the cellulose acylate film of the present invention is used as a support, when the amount of a residual solvent is set to the above-mentioned range, curling can be effectively suppressed or prevented. This is assumed to be based on that the amount of a residual solvent may be reduced upon the film formation by the aforementioned solvent-casting method, leading to a reduced free volume, which would be a main factor of the effect.

### [Coefficient of Hygroscopic Swelling of Film]

The coefficient of hygroscopic swelling (expansion) of the cellulose acylate film of the present invention is preferably 30×10⁻⁵/% RH or less, more preferably 15×10⁻⁵/% RH or less, and further preferably 10×10⁻⁵/% RH or less. Further, the coefficient of hygroscopic swelling is preferably as small as possible, but it is generally a value of 1.0×10⁻⁵/% RH or more. The coefficient of hygroscopic swelling indicates an amount of change in the length of a sample when relative humidity is changed under a fixed temperature condition. By controlling the coefficient of the hygroscopic swelling, the cellulose acylate film of the present invention can be used as an optical compensation film support, while maintaining the optical compensation function of the optical compensation film, and with preventing an architrave-like (or frame-like) rise in transmission, i.e. light leakage due to strain.

### <Surface Treatment>

A cellulose acylate film may be subjected to a surface treatment, if necessary, in order to achieve enhanced adhesion between the cellulose acylate film and each functional layer (e.g., subbing or undercoat layer, and backing layer). For example, a glow discharge treatment, an ultraviolet ray treatment, a corona discharge treatment, a flame treatment, an acid treatment, and an alkali treatment may be applied. The glow discharge treatment referred to herein may be a treatment with low-temperature plasma (thermal plasma) generated in a low-pressure gas having a pressure of 10 to 20 Torr (0.133 Pa to 2.67 kPa), or preferably with plasma under the atmospheric pressure. A plasma excitation gas is a gas which can be excited to plasma under conditions as described above, and examples thereof include argon, helium, neon, krypton, xenon, nitrogen, carbon dioxide, flons such as tetrafluoromethane, and a mixture thereof. Details thereof are described in “Hatsumei Kyokai Kokai Giho” (Kogi No. 2001-1745, published Mar. 15, 2001, Japan Institute of Invention and Innovation), pp. 30 to 32, which detailed techniques can be preferably used in the present invention.

### <Functional Layers>

The cellulose acylate film of the present invention can be applied to optical articles or to photographic photosensitive materials, as the usage applications. Particularly, it is preferred that the optical article is a liquid crystal display. Further, it is more preferable that the liquid crystal display has a configuration wherein a liquid crystal cell carrying a liquid crystal between two sheets of electrode substrates, two sheets of polarizers disposed at both sides of the liquid crystal cell one by one, and at least one optical compensating sheet disposed between the liquid crystal cell and the polarizer. As these liquid crystal displays, TN (Twisted Nematic), IPS (In-Plane Switching), FLC (Ferroelectric Liquid Crystal), AFLC (Anti-ferroelectric Liquid Crystal), OCB (Optically Compensatory Bend), STN (Supper Twisted Nematic), ECB (Electrically Controlled Birefringence), VA (Vertically Aligned), and HAN (Hybrid Aligned Nematic) are preferable.

When the cellulose film of the present invention is used for the aforementioned optical articles, any of various kinds of functional layers may be provided on the film. Examples of the functional layer include an antistatic layer, a hardened resin layer (transparent hard coat layer), an anti-reflection layer, an enhanced-adhesion layer, an anti-glare layer, an optical compensating layer, an orientating layer, and a liquid crystal layer. As the functional layer and material therefor, which may be used in the cellulose film of the present invention, a surface-active agent, a sliding agent, a matting agent, an anti-static layer, and a hard-coat layer are enumerated, details of which are described in “Kokai Giho of Japan Institute of Invention & Innovation” (Kogi No 2001-1745, published on Mar. 15, 2001), pp. 32 to 45, which can be preferably used.

### [Polarizing Plate]

The usage applications of the cellulose film of the present invention are described below.

A polarizing plate is generally composed of a polarizing film and a protective film that protects the surface of the polarizing film. The cellulose film of the present invention is particularly useful as a protective film for polarizing plates. When the film is used for a polarizing plate-protective film, the production method of polarizing plate is not particularly limited, but the polarizing plate may be produced in a usual manner. For example, there is a method of producing a polarizing plate, comprising the steps of: alkali-treating the obtained cellulose film; and sticking, with using an aqueous solution of completely saponificated polyvinyl alcohol, the alkali-treated film one by one onto each side of a polarizing film produced by dipping a polyvinyl alcohol film in an iodine solution, followed by stretching. In place of the alkali treatment, an enhanced adhesion processing, as described in JP-A-6-94915 and JP-A-6-118232, may be adopted to the aforementioned production method.

Examples of the adhesive that can be used in adhering the treated side of the protective film and the polarizing film, include polyvinyl alcohol-series adhesives, such as polyvinyl alcohol and polyvinyl butyral; and vinyl-series latexes, such as butyl acrylate.

As described above, a polarizing plate is generally composed of a polarizing film and protecting films to protect both surfaces of the polarizing film, and the thus-prepared polarizing plate may be further provided with a protect film stuck to one surface of the polarizing plate, and a separation film stuck to the opposite surface of the polarizing plate. The protect film and the separation film are used, in order to protect the polarizing plate when the polarizing plate is shipped and subjected to a product testing or the like. In this case, the protect film is stuck in order to protect the surface of a polarizing plate, and the film is used at the side of the surface opposite to the surface with which the polarizing plate is stuck to a liquid crystal plate. Meanwhile, the separation film is used to cover an adhesive layer to be stuck to the liquid crystal plate, and the film is used at the same side as the surface with which the polarizing plate is stuck to a liquid crystal plate.

In a liquid crystal display, usually, a substrate containing liquid crystals is disposed between two polarizing plates. A polarizing-plate protective film to which the cellulose film of the present invention is applied can exhibit excellent display performances, regardless of the site the film is to be disposed. In particular, because a transparent hard coat layer, an anti-glare layer, an anti-reflection layer, and the like layers are disposed to a polarizing-plate protective film to be disposed at the outermost surface at the displaying side of a liquid crystal display, employment of the aforementioned polarizing-plate protective film at this site is especially preferable.

### [Optical Compensation Film (Phase Difference Plate)]

The cellulose acylate film of the present invention can be utilized in various usage applications. It is especially effective when the cellulose acylate film is used as an optical compensation film for liquid crystal display. Herein, the optical compensation film means an optical material that is generally used in a liquid crystal display to compensate a phase difference, and that has the same meaning, for example, as a phase difference plate and an optical compensation sheet. The optical compensation film has birefringence characteristics, and can be used for the purpose of eliminating coloring on the displaying plane of a liquid crystal display or improving the characteristics of the angle of field of view.

### [Liquid Crystal Display]

### <Constitution of Generally Liquid Crystal Display>

When the cellulose film of the present invention is used for an optical compensation film, the transmission axis of the polarizing film and the slow phase axis of the optical compensation sheet composed of the cellulose film can be arranged at any angle. A liquid crystal display has a constitution of a liquid crystal cell carrying liquid crystal between two pieces of electrode substrates, two polarizing films disposed on both surfaces of the liquid crystal cell, and at least one optical compensation film disposed between the liquid crystal cell and the polarizing film.

The liquid crystal layer of the liquid crystal cell is generally formed by sealing a liquid crystal, in the space made by putting a spacer sandwiched between two pieces of substrates. The transparent electrode layer can be formed, for example, on the substrate as a transparent film containing an electric conductive substance. To the liquid crystal cell, for example, a gas barrier layer, a hard coat layer, or an undercoat (or subbing) layer (used for adhesion of the transparent electrode layer) may be further provided. The aforementioned layers can be provided on the substrate. It is preferable that the thickness of the substrate for the liquid crystal cell is generally from 50 μm to 2 mm.

### <Kinds of Liquid Crystal Displays>

The cellulose film of the present invention can be applied to liquid crystal cells of various display modes. As for the display modes, proposed are various modes, for example, TN, IPS, FLC, AFLC, OCB, STN, VA, ECB, and HAN. In addition, the cellulose film can be also used for display modes that are obtained by orientation dividing of the aforementioned display modes. Further, the cellulose film of the present invention can be preferably used in any of transparent-type, reflection-type, and semitransparent-type liquid crystal displays.

### (VA-Type Liquid Crystal Display)

The cellulose film of the present invention can be particularly advantageously used as a support for an optical compensation sheet that is used in the VA-type liquid crystal displays installing a VA mode liquid crystal cell. It is preferred that the Re value is controlled to the range of from 0 to 150 nm and the Rth retardation value is controlled to the range of from 70 to 400 nm, respectively, for the optical compensation sheet that is used in the VA-type liquid crystal display. In an embodiment where two sheets of optically anisotropic polymer films are used in a VA-type liquid crystal display, it is preferred that the Rth retardation value of the film is in the range of from 70 to 250 nm. In an embodiment where one sheet of an optically anisotropic polymer film is used in a VA-type liquid crystal display, it is preferred that the Rth retardation value of the film is in the range of from 150 to 400 nm. The VA-type liquid crystal display may have an orientation dividing system, as described in, for example, JP-A-10-123576.

### <Hardcoat Film, Antiglare Film, and Antireflection Film>

The cellulose film of the present invention may also be preferably applied to a hardcoat film, an antiglare film, and an antireflection film. Any or all of the hardcoat layer, antiglare layer and antireflection layer may be provided on one or both surfaces of the cellulose film of the present invention, for the purposes of improving the visibility of the flat panel displays of LCDs, PDPs, CRTs, ELs, and the like. Preferable embodiments of the antiglare film or antireflection film are described in detail in Japan Institute of Invention and Innovation, “Kokai Giho” Kogi No. 2001-1745, published on Mar. 15, 2001, pp. 54 to 57. The cellulose film of the present invention can be preferably used in these embodiments.

### <Photographic Film Support>

The cellulose film of the present invention may be applied as a support of a silver halide photographic photosensitive material. Specifically, in accordance with the techniques concerning color negatives described in JP-A-2000-105445, the cellulose film of the present invention can be preferably used in the aforementioned color negatives. Further, the cellulose film is also preferably applied as the support of a color reversal silver halide photographic photosensitive material, and in accordance with various raw materials, formulations, and processing or treating methods, as described in JP-A-11-282119, it can be prepared.

### <Transparent Substrate>

Since the cellulose film of the present invention is close to zero in the optical anisotropy and can have excellent transparency, the cellulose acylate film may be used in place of a liquid crystal cell glass substrate of a liquid crystal display, i.e. it may be used as a transparent substrate that seals a driving liquid crystal.

Because it is necessary that the transparent substrate that seals a liquid crystal be excellent in gas barrier properties, the cellulose film of the present invention may be provided with a gas barrier layer on the surface thereof, if necessary. There is no particular limitation on the shape and material of the gas barrier layer. Specifically, any of the following methods may be given, in which, on at least one of the surfaces of the cellulose film of the present invention, SiO₂ or the like is vapor-deposited, or a coating layer of a polymer, such as a vinylidene chloride-series polymer or vinyl alcohol-series polymer, which is relatively high in gas barrier properties, is formed. Any of these methods may be appropriately used in the present invention.

Further, when the cellulose film is used as a transparent substrate that seals a liquid crystal, it may be provided with a transparent electrode(s) to drive the liquid crystal by applying voltage. There is no particular limitation on the transparent electrode, but a metal film, metal oxide film or the like may be laminated, to thereby form the transparent electrode(s), on at least one of the surfaces of the cellulose film of the present invention. Of those, a film of a metal oxide is preferable, from the viewpoints of transparency, electrical conductivity, and mechanical characteristics. In particular, a thin film of indium oxide containing tin oxide primarily and 2 to 15 mass % of zinc oxide, can be preferably used. The details of these techniques are disclosed in, for example, JP-A-2001-125079 and JP-A-2000-227603.

In order to control the Re value and Rth value of the cellulose film of the present invention to be each within the preferable ranges, it is preferable to properly control the type and amount to be added of the low molecular weight compound (A) and the compound represented by formula (I) (herein, which may also be referred to as a retardation controlling agent), as well as a stretching ratio of the film. In the present invention, particularly, among the low molecular weight compounds (A) and the compounds represented by formula (I), a suitable retardation-controlling agent capable of attaining a desired Rth value is selected, and the amount of the retardation-controlling agent to be added and the stretching ratio of the film each are properly set, to thereby control the Re value in the target range; and thus a cellulose film having a desired Re value and Rth value can be obtained.

According to the present invention, there can be provided, at low cost, an optical film where a black display is not colored even when observed from an oblique direction and a high display quality is possible and also to provide a polarizing plate and a liquid crystal display device using the same.

The low molecular weight compound (A) and the compound represented by formula (I) in the cellulose composition of the present invention can impart inverse wavelength dispersibility to a cellulose film when used in combination and incorporated into a cellulose film. Accordingly, the optical film of the present invention containing these compounds has inverse wavelength dispersibility. The optical film, a polarizing plate using the same, and a liquid crystal display device mounted with the optical film of the present invention can give images of high display definition, in which coloring in a black display is low when viewed from an oblique direction.

According to the present invention, a liquid crystal cell optically compensates with high accuracy, and the color difference which is dependent on high contrast and the viewing angle direction in the occasion of black display, can be prevented. Particularly, a cellulose film for VA, IPS and OCB modes, a method for producing the cellulose film, and a polarizing plate making use of the cellulose film are provided.

### EXAMPLE

The present invention will be described in more detail based on the following examples. Any materials, reagents, amount and ratio of use and operations, as shown in the examples, may appropriately be modified without departing from the spirit and scope of the present invention. It is therefore understood that the present invention is by no means intended to be limited to the specific examples below.

### Synthesis Example 1

### Synthesis of Compound Represented by Formula (A-1)

### Synthesis Example 1-1

### Synthesis of Exemplified Compound (1-4) (Compound, in which n=4 in Formula (1-N))

The compound was synthesized according to the following scheme. Herein, the compounds synthesized below were identified by 400 MHz ¹H-NMR.

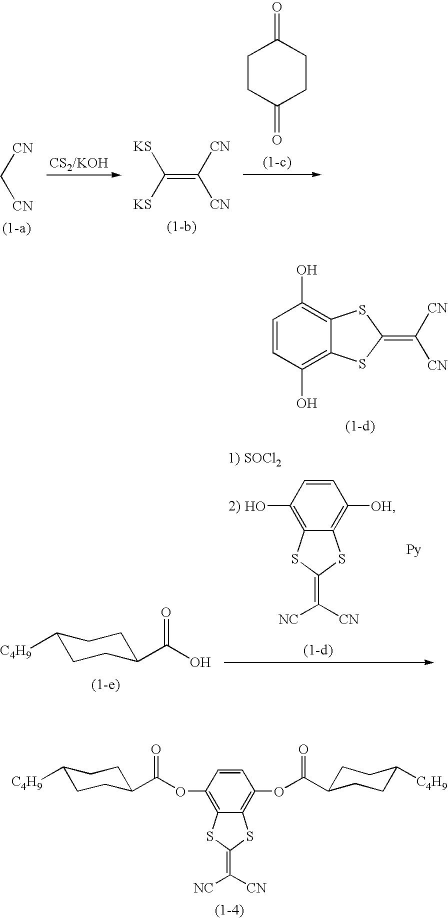

The compounds (1-a) to (1-d) can be synthesized referring to J. Org. Chem., 29, p. 660-665 (1964); and Justus Liebigs Annalen der Chemie, 726, p. 103-109 (1969).

### (Synthesis of Compound (1-d))

Was dissolved 66.01 g (1 mol) of potassium hydroxide (content: 85%) in 200 mL of isopropyl alcohol and 250 mL of water. A solution obtained by dissolving 33.0 g (0.5 mol) of malononitrile in 35 mL of isopropyl alcohol was added thereto while stirring under ice cooling. Then, 3.81 g (0.5 mol) of carbon disulfide was added thereto dropwise. After stirring the reaction solution under ice cooling for one hour, 8.6 mL of acetic acid was added to adjust pH of the reaction solution to 6.0. While stirring the reaction solution under ice cooling, a solution obtained by dissolving 108.1 g (1 mol) of 1,4-benzoquinone in 57.1 mL (1 mol) of acetic acid and 450 mL of acetone was added dropwise over a period of one hour while keeping the inner temperature of 10° C. or less. After stirring the solution at the same temperature for 40 minutes, 1,800 mL of water was added thereto. The precipitated crystals were filtrated, and washed with water. Thus, 117.9 g of the compound (1-d) was obtained (Yield: 95.0%).

¹H NMR (DMSO-d₆) δ (ppm) 6.80 (s, 2H), 10.51 (s, 2H)

### (Synthesis of Exemplified Compound (1-4))

A mixed solution of 10.3 g (0.056 mol) of trans-4-butylcyclohexanecarboxylic acid (1-e), 50 mL of toluene and 0.1 mL of N,N-dimethylformamide was heated up to 60° C. To the mixed solution, 4.72 mL (0.065 mol) of thionyl chloride was added dropwise. The mixture was heated under stirring at 60° C. for one hour, and then the solvent was distilled off under reduced pressure. A solution obtained by dissolving this acid chloride in 25 mL of tetrahydrofuran, was added dropwise to a mixed solution of 6.2 g (0.025 mol) of the compound (1-d) in 50 mL of tetrahydrofuran and 6.37 mL (0.079 mol) of pyridine under ice cooling. This reaction solution was stirred for 2 hours at room temperature, and then 150 mL of methanol was added to the reaction solution. The precipitated crystals were collected by filtration, to obtain 13.4 g of the Exemplified Compound (1-4) as white solid (Yield: 93.0%). Melting point: 152° C.

¹H-NMR (CDCl₃) δ 0.82-0.91 (m, 6H), 0.92-1.10 (m, 4H), 1.17-1.40 (m, 18H), 1.48-1.64 (m, 4H), 1.90 (d, 4H), 2.12 (d, 4H), 2.48-2.60 (m, 2H), 7.25 (s, 2H)

### Synthesis Example 1-2

### Synthesis of Exemplified Compounds (1-2), (1-3) and (1-5)

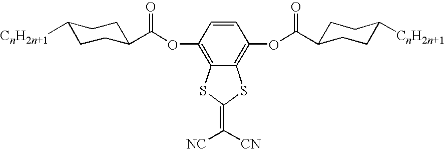

(The Exemplified Compound (1-2) is a compound represented by formula (I-n), in which n=2; the Exemplified Compound (1-3) is a compound represented by formula (1-n), in which n=3; and the Exemplified Compound (1-5) is a compound represented by formula (I-n), in which n=5.)

### (Synthesis of Exemplified Compound (1-5))

A mixed solution of 8.72 g (0.044 mol) of trans-4-pentylcyclohexanecarboxylic acid, 30 mL of toluene and 0.1 mL of N,N-dimethylformamide was heated up to 60° C. To the mixed solution, 3.53 mL (0.0484 mol) of thionyl chloride was added dropwise. The mixture was heated under stirring at 60° C. for one hour and cooled to room temperature. This acid chloride was added dropwise to a mixed solution of 4.97 g (0.020 mol) of the compound (1-d) in 30 mL of tetrahydrofuran and 8.37 mL (0.06 mol) of triethylamine under ice cooling. This reaction solution was stirred for 2 hours at room temperature, and then 20 mL of methanol, 20 mL of water and 50 mL of methanol was added to the reaction solution in this order. The precipitated crystals were collected by filtration and the resultant was flown with methanol, to obtain 11.5 g of the Exemplified Compound (1-5) as white solid (Yield: 94.0%). Melting point: 150° C.

### (Synthesis of Exemplified Compounds (1-2) and (1-3))

The Exemplified Compounds (1-2) and (1-3) were synthesized in the same manner as in the Exemplified Compound (1-5), except that the trans-4-pentylcyclohexanecarboxylic acid was replaced with trans-4-ethylcyclohexanecarboxylic acid and trans-4-propylcyclohexanecarboxylic acid, respectively.

Melting point: Exemplified Compound (1-2) 151° C.
Exemplified Compound (1-3) 174° C.

### Synthesis Example 1-3

### Synthesis of Exemplified Compound (15-4) (Compound, in which n=4 in Formula (15-n))

The Exemplified Compound (15-4) was synthesized in the same manner as in Synthesis Example 1-1, except that the benzoquinone was replaced with methyl benzoquinone. Melting point: 189° C.

### Synthesis Example 1-4

### Synthesis of Exemplified Compound (2-4) (Compound, in which n=4 in Formula (2-N))

The compound was synthesized according to the following scheme.

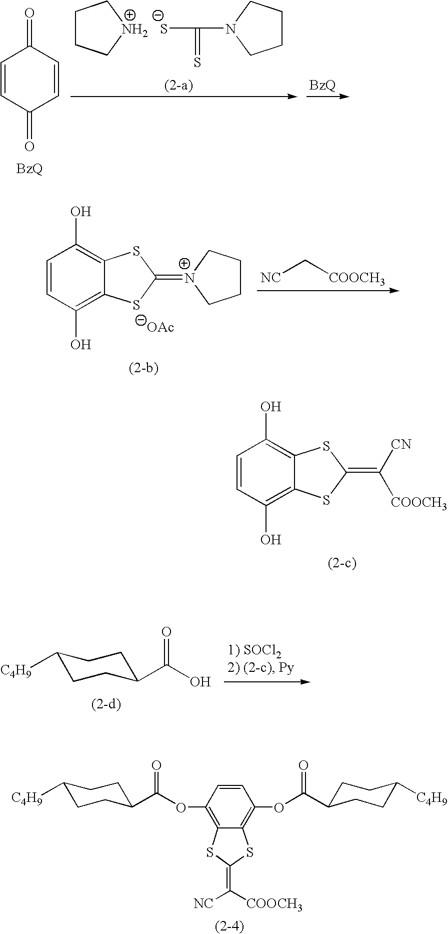

The compounds (2-b) and (2-c) can be synthesized by the method described in Journal of Chemical Crystallography (1997); 27(9); p. 515-526.

Was added 4.72 mL of thionyl chloride to a mixed solution of 10.35 g of trans-4-butylcyclohexanecarboxylic acid (2-d), 50 mL of toluene and 0.1 mL of N,N-dimethylformamide, the mixture was heated under stirring at 60° C. for one hour, and then the solvent was distilled off under reduced pressure. A solution obtained by suspending this acid chloride in 25 mL of tetrahydrofuran, was added dropwise to a solution of 6.2 g of the compound (2-c) in 50 mL of tetrahydrofuran under ice cooling, and 6.37 mL of pyridine was further added dropwise thereto. This reaction solution was stirred for 4 hours at room temperature, and then methanol and water were added to the reaction solution. A product precipitated therefrom was collected by filtration. This crude product was dissolved in methylene chloride, and the solution was treated with activated carbon. Subsequently, purification of the solution was performed by silica gel column chromatography, and recrystallization was carried out from acetonitrile. Thus, 7.2 g of the Exemplified Compound (2-4) was obtained as white solid. Melting point: 143° C.

### Synthesis Example 1-5

### Synthesis of Exemplified Compounds (7-4), (8-4) and (9-4) (The Exemplified Compound (7-4) is a Compound Represented by Formula (7-n), in which n=4; the Exemplified Compound (8-4) is a Compound Represented by Formula (8-n), in which n=4; and the Exemplified Compound (1-5) is a Compound Represented by Formula (9-n), in which n=4.)

The Exemplified Compounds (7-4), (8-4) and (9-4) were synthesized in the same manner as in Synthesis Example 1-4, except that the methyl cyanoacetate used in Synthesis Example 1-4 was replaced with ethyl isobutylylacetate, pivaloylacetonitrile and acetylacetone, respectively.

Melting point: Exemplified Compound (7-4) 126° C.
Exemplified Compound (8-4) 117° C.
Exemplified Compound (9-4) 124° C.

### Synthesis Example 1-6

### Synthesis of Exemplified Compound (22-6) (Compound, in which n=6 in Formula (22-n))

The compound was synthesized according to the following scheme.

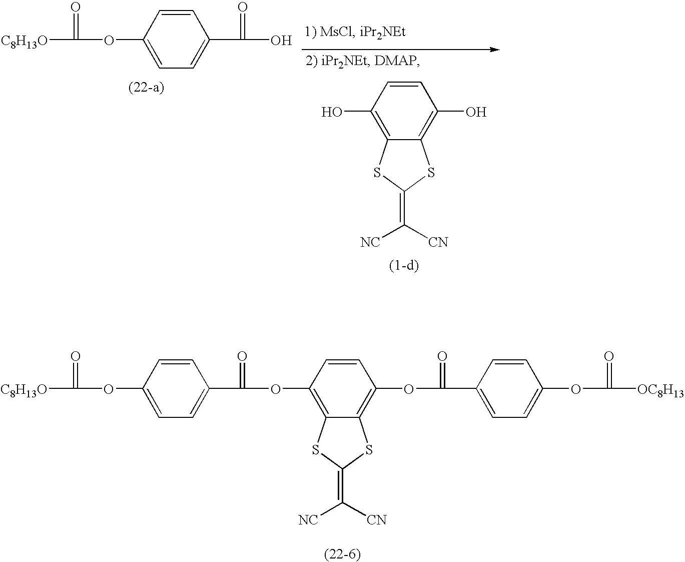

To a solution of 11.7 g (44 mmol) of the compound (22-a) in 100 mL of tetrahydrofuran, 3.4 mL (44 mmol) of methanesulfonic acid chloride was added under ice cooling, and 8.05 mL (46.2 mmol) of N,N-diisopropylethylamine was slowly added dropwise thereto. After the mixture was stirred for one hour, 8.05 mL (46.2 mmol) of N,N-diisopropylethylamine was added to the mixture, and 4.95 g (20 mmol) of the compound (1-d) was added thereto. Subsequently, 0.05 g of N,N-dimethylaminopyridine was added to the mixture. After the mixture was stirred for one hour under ice cooling, the temperature was raised to room temperature, and the mixture was stirred for 6 hours. Methylene chloride and water were added to partition the mixture, and the organic layer was washed with water, 1N aqueous hydrochloric acid and water in this order. The organic layer was dried over magnesium sulfate, and the solvent was distilled off under reduced pressure. Purification of the residue was performed by silica gel column chromatography, using a mixed solvent of methylene chloride/methanol as an eluent, and thus 5.4 g of the Exemplified Compound (22-6) was obtained. Melting point: 165° C.

### Synthesis Example 1-6B

### Synthesis of Exemplified Compound (25-4) (Compound, in which n=4 in Formula (25-n))

The exemplified compound (25-4) was synthesized in the same manner as in Synthesis Example 1-6, except that the substituted benzoate (22-a) used in Synthesis Example 1-6 was replaced with p-butyl benzoate. Melting point: 204° C.

### Synthesis Example 1-7

### Synthesis of Exemplified Compound (24-4) (Compound, in which n=4 in Formula (24-n))

The compound was synthesized according to the following scheme.

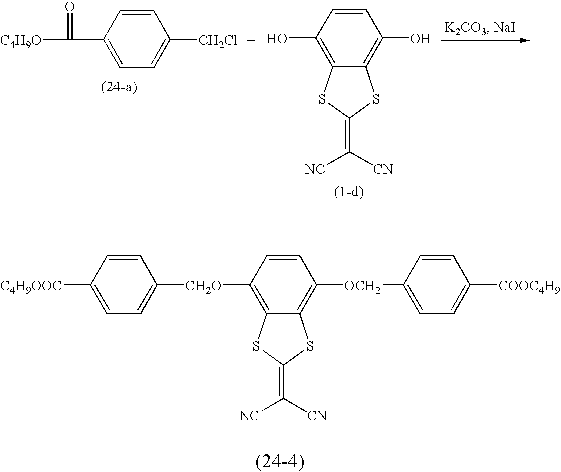

Were heated 14.2 g of the compound (24-a), 6.21 g of the compound (1-d), 11.4 g of potassium carbonate, 0.37 g of sodium iodide, and 70 mL of N-methylpyrrolidinone under stirring for 2 hours at 100° C. The reaction solution was added to water, and crystals were collected by filtration. The product was purified by silica gel column chromatography (methylene chloride/hexane=5/1), treated with activated carbon, and then recrystallized from methylene chloride/acetonitrile. Thus, 5.0 g of the Exemplified Compound (24-4) was obtained as white solid. Melting point: 168° C.

### Synthesis Example 1-8

### Synthesis of Exemplified Compound (29-2) (Compound, in which n=2 in Formula (29-n))

The Exemplified Compound (29-2) was synthesized in accordance with the descriptions in paragraph Nos. [0159] to [0160] of JP-A-2008-107767 by the following scheme.

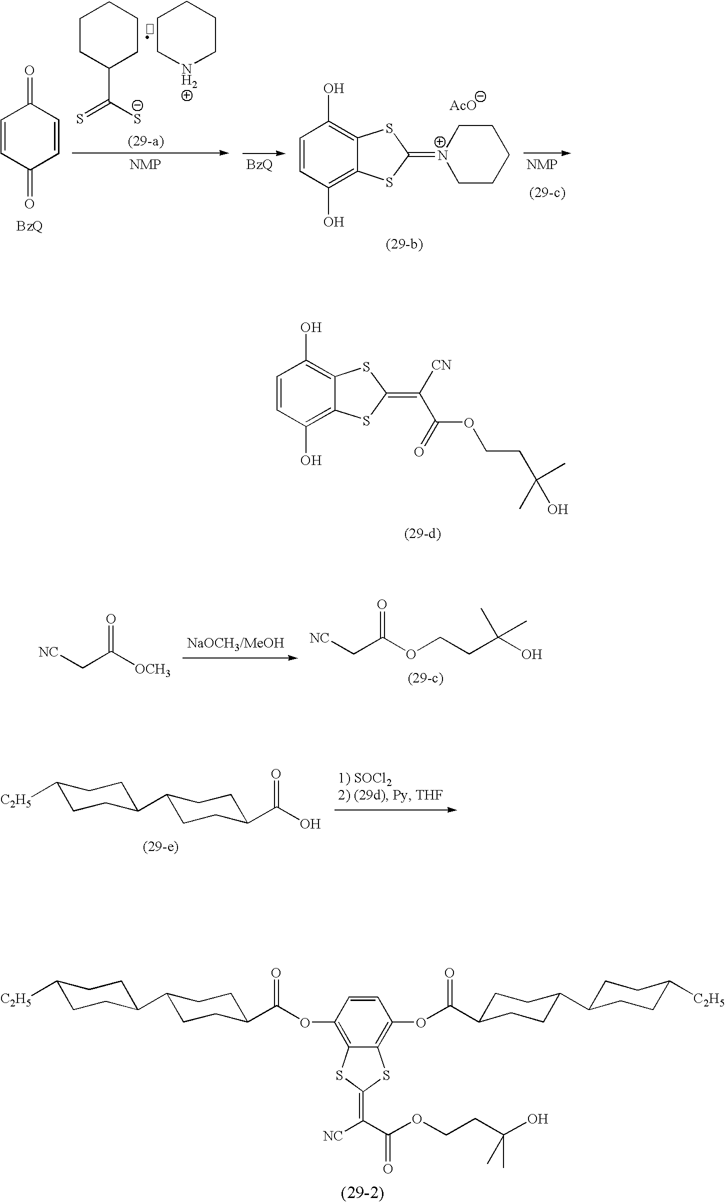

### (Synthesis of Compound (29-c))

The compound (29-c) can be synthesized, referring to J. Org. Chem., 69, p. 2164-2177 (2004).

To a solution of 123 g (0.5 mol) of the compound (29-a) in 250 mL of N-methylpyrrolidinone, a mixed solution of 113 g (1.05 mol) of benzoquinone in acetic acid (250 mL) and N-methylpyrrolidinone (250 mL) was slowly added dropwise under ice cooling so as to keep the inner temperature under 15° C. The reaction solution was stirred at room temperature subsequently at 50° C. by heating for one hour. After cooling to room temperature, 1,200 mL of acetone was added thereto, and crystals were collected by filtration. The crystals were washed with a mixed solution of acetone/acetic acid (1,000 mL). Thus, 143 g of the Exemplified Compound (29-c) was obtained (Yield: 86%).

### (Synthesis of Compound (29-d))

Were mixed 20 g (0.061 mol) of the compound (29-c), 11.5 g (0.067 mol) of the compound (29-b), and 100 mL of isopropyl alcohol. The mixture was heated up to 80° C. under a nitrogen flow and stirred under reflux for three hours. After cooling to room temperature, 200 mL of water was added thereto, and crystals were collected by filtration. The crystals were washed with a mixed solution of water/isopropyl alcohol (100 mL). Thus, 20 g of the exemplified compound (29-d) was obtained (Yield: 92%).

### (Synthesis of Exemplified Compound (29-2))

To a 20-ml toluene solution containing 22.5 g (94.5 mmol) of the compound (29-e) (manufactured by Yantai valiant Fine Chem. Co., Ltd.) and 0.075 mL of N,N-dimethylformamide, was added 10.34 mL (142 mmol) of thionyl chloride, and the mixture was then subjected to reflux under heat. The consumption of the carboxylic acid was confirmed by TLC and the solvents were then distilled off. The product itself was added dropwise into a 75-ml tetrahydrofuran solution containing 15 g (42 mmol) of the compound (29-d) and 11.25 mL (139 mmol) of pyridine under ice-cooling. This reaction solution was return to room temperature, and stirred for 4 hours. After completion of the reaction, 20 mL of methanol and 5 mL of water were added. The solution was stirred for one hour at the stage where the solution became homogeneous. A product precipitated by adding 250 mL of methanol to the solution was collected by filtration, to obtain 29 g of the Exemplified Compound (29-2) (Yield: 86%).

The phase transition temperatures of the synthesized Exemplified Compound (29-2) were measured, which was found to be such that Cr-200° C.→N-250° C.→Iso. Here, “Cr” represents crystal phase, “N” represents a nematic phase, and “Iso” represents an isotropic phase.

### Synthesis Example 1-9

### Synthesis of Exemplified Compound (31-2) (Compound, in which n=2 in Formula (31-n))

The Exemplified Compound (31-2) was synthesized in the same matter as in the Exemplified Compound (7-4), except that 4-(trans-4-ethylcyclohexyl)cyclohexanecarboxylic acid was used.

The phase transition temperatures of the synthesized Exemplified Compound (31-2) were measured, which was found to be such that Cr-195° C.→N-250° C.→Iso.

### Synthesis Example 1-10

### Synthesis of Exemplified Compound (19-8) (Compound, in which n=8 in Formula (19-n))

The Exemplified Compound (19-8) was synthesized in the same manner as the esterification method described in Synthesis Example 1-1.

¹H-NMR (CDCl₃) δ 0.88 (t, 6H), 1.27-1.42, 1.50-1.86 (m, 32H), 2.15 (m, 8H), 2.59 (m, 2H), 3.26 (m, 2H), 3.47 (t, 4H), 7.28 (s, 2H)

The phase transition temperatures of the synthesized Exemplified Compound (19-8) were measured, which was found to be such that Cr-110° C.→S-114° C.→Iso. Here, “Cr” represents crystal phase, “S” represents a smectic phase, and “Iso” represents an isotropic phase.

### Synthesis Example 1-11

### Synthesis of Exemplified Compound (42-m)

The Exemplified Compound (42-6) was synthesized in the same manner as the esterification method described in Synthesis Example 1-1. Melting point: 120° C.

¹H-NMR (CDCl₃) δ 0.90 (t, 6H), 1.31 (m, 12H), 1.54-1.64 (m, 12H), 2.12-2.31 (m, 10H), 2.61 (m, 2H), 4.09 (t, 4H), 7.29 (s, 2H)

The melting point of each of the compounds (42-4), (42-5), (42-7) and (42-8) synthesized in similar manner was shown below.

Melting point: Exemplified Compound (42-4) 160° C.
Exemplified Compound (42-5) 117° C.
Exemplified Compound (42-7) 106° C.
Exemplified Compound (42-8) 99° C.

### Synthesis Example 1-12

### Synthesis of Exemplified Compounds (44-8) and (44-6) (Compound, in which m is 8 or 6 in Formula (44-m))

After synthesizing the carbamoyl chloride, the Exemplified Compound (44-8) was synthesized, according to the esterification procedure described in the Synthesis Example 1-1, by changing the solvent, the base and the reaction temperature from tetrahydrofuran to N,N-dimethylacetamide, from pyridine to triethylamine, and from room temperature to 40° C. (stirring with heating), respectively. Melting point: 116° C.

¹H-NMR (CDCl₃) δ 0.88 (t, 6H), 1.28 (m, 16H), 1.50 (m, 8H), 2.40 (m, 4H), 2.51 (m, 8H), 3.58 (t, 4H), 3.67 (t, 4H), 7.33 (s, 2H)

The melting point of the Exemplified Compound (44-6) synthesized in similar manner was 112° C.

### Synthesis Example 1-13

### Synthesis of Exemplified Compounds (54-11) and (54-13) (Compound, in which m is 11 or 13 in Formula (54-m))

The Exemplified Compound (54-11) was synthesized in the same manner as the esterification method described in Synthesis Example 1-1. Melting point: 88° C.

¹H-NMR (CDCl₃) δ 0.87 (t, 6H), 1.20-1.48 (m, 32H), 1.76 (m, 4H), 2.62 (m, 4H), 7.30 (s, 2H)

The melting point of the Exemplified Compound (54-13) synthesized in similar manner was 95° C.

### Synthesis Example 1-14

### Synthesis of Exemplified Compound (64-4)

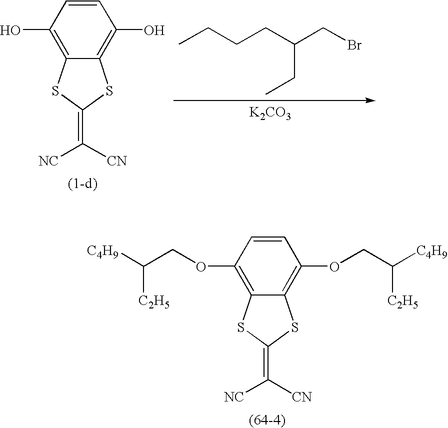

Were added 36 mL of N,N-dimethylacetamide and 7.24 g (0.052 mol) potassium carbonate to 6 g (0.026 mol) of the compound (1-d). The inner temperature was set to 60° C. under a nitrogen atmosphere. Then, 15.17 g (0.079 mol) of 2-ethyhexyl bromide was added. After stirring the reaction solution at the same temperature for four hours, the reaction solution was cooled to room temperature. The reaction solution was added dropwise to 65 mL of ethyl acetate, 65 mL of water and 5.3 g of concentrated hydrochloric acid. After stirring, the water phase was removed and the remains were washed with 50 mL of water. The ethyl acetate solution containing the precipitated crystals was heated to 80° C., and then cooled to 25° C. The precipitated crystals were filtrated, washed with water, and washed with acetonitrile. Thus, 10.75 g of the Exemplified Compound (64-4) was obtained (Yield: 86.8%). Melting point: 184° C.

¹H-NMR (CDCl₃) δ 0.86-0.99 (m, 12H), 1.26-1.37 (m, 8H), 1.38-1.52 (m, 8H), 1.68-1.80 (m, 2H), 3.89-4.02 (m, 4H), 6.80 (s, 2H)

### Synthesis Example 1-15

Other exemplified compounds can be synthesized according to the synthesis methods described before now. Melting points will be shown by excerption below.

Melting point: Exemplified Compound (41-C) 233° C.
Exemplified Compound (41-A) 104° C.
Exemplified Compound (41-B) 147° C.
Exemplified Compound (51) 225° C.
Exemplified Compound (52) 183° C.
Exemplified Compound (66-8) 66° C.

For the exemplified compounds obtained in Synthesis Examples 1-1 to 1-15, their absorption wavelengths derived from the electric dipole transition moments Mx and My, and the magnitudes |Mx| and |My| were respectively measured by time-dependent density functional calculation. In all of the exemplified compounds, the molecular absorption wavelength derived from My was longer than the molecular absorption wavelength derived from Mx, and |My| was larger than |Mx|. Here, Gaussian03 Rev. D.02 (trade name, manufactured by Gaussian, Inc.) was used as the program used in the time-dependent density functional calculation, and B3LYP/6-31+G(d) was used as a basis function. Furthermore, solvent effects were also introduced by a PCM method.

### Synthesis Example 2

### Synthesis of Compound Represented by Formula (1)

### Synthesis Example 2-1

### Synthesis of Exemplified Compound (101-3) (Compound, in which n=3 in Formula (101-n)

The compound (101-3) was synthesized according to the following scheme.

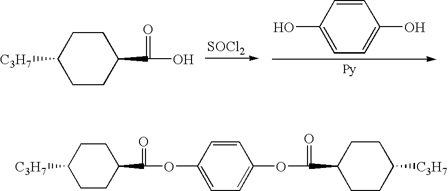

Was added 16.9 mL of thionyl chloride to a mixed solution of 37.5 g of trans-4-propylcyclohexanecarboxylic acid, 100 mL of toluene and 0.1 mL of N,N-dimethylformamide. The mixture was heated under stirring at 60° C. for one hour, and then the solvent was distilled off under reduced pressure. A solution obtained by suspending this acid chloride in 25 mL of tetrahydrofuran, was added dropwise to a solution of 11.0 g of hydroquinone and 17.8 mL of pyridine in 100 mL of tetrahydrofuran under ice cooling. This reaction solution was stirred for 4 hours at room temperature, and then methanol and water were added to the reaction solution. The obtained oily product was taken out through decantation and then recrystallized with acetonitrile three times. Thus, 34 g of the Exemplified Compound (101-3) was obtained as white solid. Yield: 82%

¹H-NMR (CDCl₃) δ 0.90 (t, 3H), 0.98 (m, 2H), 1.10-1.32 (m, 5H), 1.55 (m, 2H), 1.85 (d, 2H), 2.11 (d, 2H), 2.45 (m, 1H), 7.04 (s, 4H)

The phase transition temperatures of the synthesized exemplified compound (101-3) were measured, which was found to be such that Cr-126° C.→N-218° C.→Iso. Here, “Cr” represents crystal phase, “N” represents a nematic phase, and “Iso” represents an isotropic phase.

### Synthesis Example 2-2

### Synthesis of Exemplified Compounds (101-2), (101-4), (101-5) and (101-6)

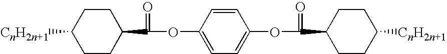

(The Exemplified Compound (101-2) is a compound represented by formula (101-n), in which n=2; the Exemplified Compound (101-4) is a compound represented by formula (101-n), in which n=4; and the Exemplified Compound (101-5) is a compound represented by formula (101-n), in which n=5; and the Exemplified Compound (101-6) is a compound represented by formula (101-n), in which n=6.)

The Exemplified Compounds (101-2), (101-4), (101-5) and (101-6) were synthesized in the same manner as in Synthesis Example 2-1, except that the trans-4-propylcyclohexanecarboxylic acid was replaced with trans-4-ethylcyclohexanecarboxylic acid, trans-4-butylcyclohexanecarboxylic acid, trans-4-pentylcyclohexanecarboxylic acid and trans-4-hexylcyclohexanecarboxylic acid, respectively.

The phase transition temperatures of each of the synthesized exemplified compound were measured, which was found to show the following temperatures.

### Exemplified Compound (101-2): Cr-127° C.→N-188° C.→Iso

### Exemplified Compound (101-4): Cr-128° C.→N-210° C.→Iso

### Exemplified Compound (101-5): Cr-122° C.→SmB-139° C.→N-214° C.→Iso

### Exemplified Compound (101-6): Cr-130° C.→SmB-157° C.→N-198° C.→Iso

Here, “Cr” represents crystal phase, “SmB” represents a smectic B phase, “N” represents a nematic phase, and “Iso” represents an isotropic phase.

### Synthesis Example 2-3

### Synthesis of Exemplified Compound (103-3) (Compound, in which n=3 in Formula (103-n))

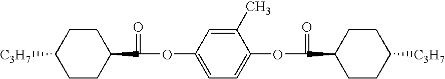

The Exemplified Compound (103-3) was synthesized in the same manner as in Synthesis Example 2-1, except that the hydroquinone was replaced with methylhydroquinone.

¹H-NMR (CDCl₃) δ 0.86 (t, 3H), 0.98 (m, 2H), 1.20-1.30 (m, 5H), 1.53 (m, 2H), 1.86 (d, 2H), 2.12 (s, 3H), 2.11 (d, 2H), 2.47 (m, 1H), 6.92 (m, 3H)

The phase transition temperatures of the synthesized Exemplified Compound (103-3) were measured, which was found to be such that Cr-102° C.→N-190° C.→Iso.

### Synthesis Example 2-3A

### Synthesis of Exemplified Compound (106-3) (Compound, in which n=3 in Formula (106-n))

The Exemplified Compound (106-3) was synthesized in the same manner as in Synthesis Example 2-1, except that the hydroquinone was replaced with chlorohydroquinone.

The phase transition temperatures of the synthesized Exemplified Compound (106-3) were measured, which was found to be such that Cr-91° C.→N-194° C.→Iso.

### Synthesis Example 2-3B

The Exemplified Compounds (105-n), (113), (114-n) and (115) were synthesized in the same manner as in Synthesis Example 2-1, except that the trans-4-propylcyclohexanecarboxylic acid was replaced with any of various cyclohexanecarboxylic acids substituted at the 4-position.

The phase transition temperatures of the synthesized exemplified compounds were measured, and are shown by excerption below.

### Exemplified Compound (105-6): Cr-124° C.→Iso

### Exemplified Compound (105-8): Cr-121° C.→Iso

### Exemplified Compound (115): Cr-84° C.→SmB-152° C.→Iso

### Synthesis Example 2-4

### Synthesis of Exemplified Compound (116-3) (Compound, in which n=3 in Formula (116-n))

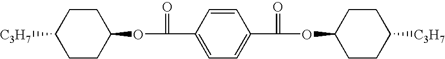

To a 100-ml tetrahydrofuran solution containing 15 g of 4-propylcyclohexanol and 12.8 mL of pyridine, a tetrahydrofuran solution containing 10 g of terephthaloyl chloride was added dropwise under ice cooling. This reaction solution was stirred for 4 hours at room temperature, and then methanol and water were added to the reaction solution. Further, methylene chloride was added, to extract a product.

The organic layer was washed with hydrochloric acid solution, water and saturated sodium chloride solution, and dried over magnesium sulfate, and the solvent was distilled off under reduced pressure. Recrystallization was conducted three times, to obtain 8.3 g of the Exemplified Compound (116-3) as white solid. (Yield: 41%)

### Synthesis Example 2-5

### Synthesis of Exemplified Compound (116-2) (Compound, in which n=2 in Formula (116-n))

The Exemplified Compound (116-2) was synthesized in the same manner as in Synthesis Example 2-4, except that the 4-propylcyclohexanol was replaced with 4-ethylcyclohexanol.

¹H-NMR (CDCl₃) δ 0.90 (t, 6H), 1.0-1.32 (m, 10H), 1.50 (m, 4H), 1.85 (d, 4H), 2.10 (d, 4H), 4.92 (m, 2H), 8.07 (s, 4H)

Melting point: 150° C.

### Synthesis Example 2-6

### Synthesis of Exemplified Compound (130-3) (Compound, in which n=3 in Formula (130-n))

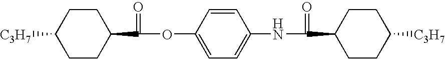

The Exemplified Compound (130-3) was synthesized in the same manner as in Synthesis Example 2-1, except that the hydroquinone was replaced with aminophenol.

### Synthesis Example 2-7

### Synthesis of Exemplified Compound (139-4)

The Exemplified Compound (139-4) was synthesized in the same manner as in Synthesis Example 2-1, except that the hydroquinone was replaced with 4,4′-biphenol, and the trans-4-propylcyclohexanecarboxylic acid was replaced with trans-4-butylcyclohexanecarboxylic acid.

### Example 1

### Preparation of Cellulose Acetate Film 101

### (Preparation of Dope)

The components for the following cellulose acetate solution were charged into a mixing tank, followed by stirring while heating, to dissolve the components, to thereby prepare a cellulose acetate solution

### (Cellulose Acetate Solution)

| | |
|---|---|
| Cellulose acetate having acetyl | 100 parts by mass |
| substitution degree of 60.2% | |
| Sugar derivatives 1 (plasticizer) | 3.6 parts by mass |
| Methylene chloride (first solvent) | 336 parts by mass |
| Methanol (second solvent) | 29 parts by mass |

Sugar derivatives 1: β-D-Glucose pentaacetate

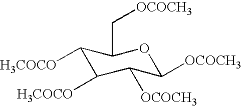

Respective compositions provided below were charged into another mixing tank and stirred and dissolved while being heated, to thus prepare the retardation increasing agent solution.

### (Retardation Increasing Agent Solution)

| | |
|---|---|
| Exemplified Compound (1-2) | 14.0 parts by mass |
| (Low molecular weight compound (A)) | |
| Exemplified Compound (101-3) | 11.7 parts by mass |
| (Compound represented by formula (I)) | |
| Methylene chloride | 87 parts by mass |
| Methanol | 13 parts by mass |

The cellulose acylate solution of 100 mass parts and the retardation increasing agent solution were mixed so that the amount of each of the Exemplified Compound (1-2) and the Exemplified Compound (101-3) was to be 2.5 mass parts and 3.0 mass parts, respectively, to 100 mass parts of the cellulose acylate, to obtain a dope for forming a film.

### (Flow Casting) (Film 101)

The thus-prepared dope was subject to flow casting using a glass plate casting device. It was subject to dry using warm air at 70° C. for 6 minutes, then the film was separated from the glass plate and fixed to a support and dried using warm air at 100° C. for 10 minutes, and then warm air at 140° C. for 20 min, to obtain a cellulose acylate film having a thickness of 55 μm.

Subsequently, the obtained film was horizontally stretched under the conditions of 175° C., up to a stretching ratio of 20%, at a stretching rate of 30%/min. The film thickness of the completed cellulose acylate film was 52 μM. This film was designated as film 101.

### Production of Films 102 to 106 and 100

### Comparative Example

Films 102 to 106 and 100 were produced by adjusting the type and amount to be added of the compounds so that the retardation increasing agent solution for the film 101 had the composition shown in Table 1, and performing film formation and stretching in the same manner as in the case of the film 101.

### (Measurement of Re or Rth of Film)

Re value of each of thus-produced cellulose acetate films was measured at 450 nm, 550 nm and 630 nm using a birefringence analyzer, KOBRA 21ADH (trade name, from Oji Scientific Instruments), by allowing incidence of light of each wavelength in the direction of the normal line. Results are shown in Table 1. Sample No. 100 in Table 1 corresponds to a cellulose acetate film similarly produced, except that the retardation controlling agent was not added at all. In Table 1, Re and Rth are a value measured at 55 nm. Further, the amount to be added in the following table (mass part) is a value to 100 mass parts of cellulose acetate.

### (Evaluation of Re-Expression Property and Re-Inverse Dispersibility)

Based on the measured Re values at wavelengths of 450 nm, 550 nm and 630 nm, each of Re-expression property and Re-inverse dispersibility was evaluated according to the following criteria.

### Re-Expression Property:

A: Re(550) was 80 or more.

B: Re(550) was more than 40, and less than 80.

C: Re(550) was 40 or less.

### Re-Inverse Dispersibility:

A: Re(630)−Re(450) was 16 or more.

B: Re(630)−Re(450) was more than 9, and less than 16.

C: Re(630)−Re(450) was 9 or less.

Results are shown in Table 1.

TABLE 1

| | | Low molecular weight | | | | | | | | | | |
|---|---|---|---|---|---|---|---|---|---|---|---|---|
| | | compound (A) | | Compound of formula (I) | | Evaluation | | Optical properties | | | | |
| | | | Addition | | Addition | Re- | | | | | | |
| | | | amount | | amount | ex- | Re-inverse | | | Re(630)- | | |
| | Film | | (mass | | (mass | pression | disper- | Re | Rth | Re(450) | Re(450)/ | Re(630)/ |
| | No. | Additive | part) | Additive | part) | property | sibility | (nm) | (nm) | (nm) | Re(550) | Re(550) |
| This | 101 | (1-2) | 2.5 | (101-3) | 3.0 | A | B | 91 | 118 | 14 | 0.87 | 1.02 |
| invention | | | | | | | | | | | | |
| Comparative | 102 | (1-2) | 2.5 | Comparative | 3.0 | C | C | 39 | 102 | 7 | 0.84 | 1.04 |
| Example | | | | rod-shaped | | | | | | | | |
| | | | | compound 1 | | | | | | | | |
| Comparative | 103 | (1-2) | 2.5 | Comparative | 3.0 | C | C | 22 | 75 | 5 | 0.89 | 1.02 |
| Example | | | | rod-shaped | | | | | | | | |
| | | | | compound 2 | | | | | | | | |
| Comparative | 104 | (1-2) | 2.5 | None | — | C | C | 15 | 74 | 7 | 0.62 | 1.13 |
| Example | | | | | | | | | | | | |
| Comparative | 105 | None | — | (101-3) | 3.0 | — | — | 54 | 99 | 2 | 0.97 | 1.01 |
| Example | | | | | | | | | | | | |
| Comparative | 106 | None | — | Comparative | 3.0 | — | — | 24 | 85 | 4 | 0.89 | 1.04 |
| Example | | | | rod-shaped | | | | | | | | |
| | | | | compound 1 | | | | | | | | |
| Comparative | 100 | None | — | None | — | — | — | 8 | 68 | 5 | 0.54 | 1.19 |
| Example | | | | | | | | | | | | |
| Calculation A | 104 | — | — | — | — | — | — | 60 | 105 | 4 | — | — |
| | + | | | | | | | | | | | |
| | 105 | | | | | | | | | | | |
| Calculation B | 104 | — | — | — | — | — | — | 30 | 91 | 6 | — | — |
| | + | | | | | | | | | | | |
| | 106 | | | | | | | | | | | |

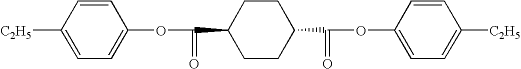

Comparative rod-shaped compound 1 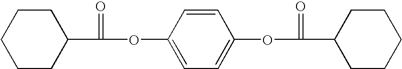
Comparative rod-shaped compound 2
Note:
Comparative rod-shaped compound 1: Compound described in JP-A-2007-256494
Comparative rod-shaped compound 2: Compound described in JP-A-2007-249224

As shown in the results of Table 1, it can be seen that when two kinds of the additives defined by the present invention (the low molecular weight compound (A) and the compound represented by formula (I)) were used in combination, a balance can be achieved between high Re expression properties and the wavelength dispersibility of Re.

When a comparison between the film samples No. 101 and No. 102 is made, it can be seen that the Re expression properties and the inverse dispersibility are obviously enhanced by using the Exemplified Compound (101-3) as the compound represented by formula (I).

The synergistic effect obtained by using two kinds of the additives defined by the present invention in combination, will be explained. In the combination with the comparative rod-shaped compound (1), the value of Re obtained with No. 102, which made use of two compounds in combination, turns out to be approximately a sum of the values of Re obtained with Comparative Examples No. 104 and No. 106, which respectively made use of each of the additives alone (in the table, Calculation B). On the other hand, in the combination with the Exemplified Compound (101-3) of the present invention, it can be seen that the value of Re obtained with No. 101, which made use of two compounds in combination, turns out to be greater than a sum of the values of Re obtained with Comparative Examples No. 104 and No. 105 (in the table, Calculation A). Furthermore, since the Re-inverse dispersibility of No. 101 is enhanced with an increase of Re, it is thought that in the combination of the compounds of the present invention, the degree of orientation of the two kinds of additives is enhanced as compared with the cases of using each of the additives alone. Thus, this was an unexpected effect.

Furthermore, it is understood from No. 103 that the comparative rod-shaped compound 2 described in JP-A-2007-249224 functions very poorly as a retardation increasing agent, and the same effects as those of the present invention cannot be obtained.

With respect to values of Δn(440)/Δn(550), Δn(630)/Δn(550), values of Re(440)/Re(550), Re(630)/Re(550) are shown in Table 1. From the following two relationships, they are exactly the same as the dispersibility of birefringence.

Re(440)/Re(550)=(Δn(440)×d)/(Δn(550)×d)=Δn(440)/Δn(550)

Re(630)/Re(550)=(Δn(630)×d)/(Δn(550)×d)=Δn(630)/Δn(550)

Here, d represents thickness of the film.

### Example 2

### Production of Films 121 to 130

Films 121 to 130 were produced in the same way as in the Example 1, by performing film formation and stretching in the same manner as in the case of the film 101, except that the compound represented by formula (I) and the low molecular weight compound (A) shown in Table 2 were used.

### (Measurement of Re or Rth of Film)

The results obtained in the same manner as in Example 1 are shown in Table 2.

TABLE 2

| | | Low molecular weight | | Compound of formula | | | |
|---|---|---|---|---|---|---|---|
| | | compound (A) | | (I) | | | |
| | | | Addition | | Addition | Evaluation | |
| | Film | | amount | | amount | Re-expression | Re-inverse |
| | No. | Additive | (mass parts) | Additive | (mass parts) | property | dispersibility |
| This | 121 | (29-2) | 2.5 | (101-3) | 3.0 | A | B |
| invention | | | | | | | |
| This | 122 | (29-2) | 2 | (102) | 2.0 | B | B |
| invention | | | | | | | |
| Comparative | 123 | (29-2) | 2.5 | Comparative | 3.0 | B | B |
| Example | | | | rod-shaped | | | |
| | | | | compound 1 | | | |
| This | 124 | (1-4) | 2.5 | (101-3) | 3.0 | A | A |
| invention | | | | | | | |
| This | 125 | (1-4) | 1.25 | (101-3) | 2.0 | B | B |
| invention | | | | | | | |
| Comparative | 126 | (1-4) | 2.5 | Comparative | 2.0 | B | B |
| Example | | | | rod-shaped | | | |
| | | | | compound 1 | | | |
| This | 127 | (1-4) | 1.25 | (101-4) | 2.0 | B | B |
| invention | | | | | | | |
| This | 128 | (1-4) | 1.25 | (102) | 2.0 | B | B |
| invention | | | | | | | |
| This | 129 | (1-4) | 1.25 | (103-3) | 2.0 | B | B |
| invention | | | | | | | |
| This | 130 | (1-4) | 1.25 | (116-2) | 2.0 | B | B |
| invention | | | | | | | |

| | Optical properties | | | | | |
|---|---|---|---|---|---|---|
| | | | Re(630)- | | | |
| | Re | Rth | Re(450) | Re(450)/ | Re(630)/ | |
| | (nm) | (nm) | (nm) | Re(550) | Re(550) | Remarks |
| This | 108 | 119 | 12 | 0.90 | 1.02 | |
| invention | | | | | | |
| This | 63 | 112 | 11 | 0.91 | 1.02 | Reduced |
| invention | | | | | | addition |
| | | | | | | amount |
| Comparative | 65 | 108 | 13 | 0.83 | 1.03 | |
| Example | | | | | | |
| This | 109 | 149 | 22 | 0.83 | 1.03 | |
| invention | | | | | | |
| This | 51 | 97 | 10 | 0.83 | 1.04 | Reduced |
| invention | | | | | | addition |
| | | | | | | amount |
| Comparative | 56 | 109 | 15 | 0.77 | 1.04 | |
| Example | | | | | | |
| This | 64 | 106 | 12 | 0.83 | 1.02 | Reduced |
| invention | | | | | | addition |
| | | | | | | amount |
| This | 58 | 104 | 13 | 0.83 | 1.02 | Reduced |
| invention | | | | | | addition |
| | | | | | | amount |
| This | 52 | 102 | 12 | 0.83 | 1.02 | Reduced |
| invention | | | | | | addition |
| | | | | | | amount |
| This | 49 | 111 | 10 | 0.85 | 1.02 | Reduced |
| invention | | | | | | addition |
| | | | | | | amount |

Similarly to the results shown in Table 1, it can be seen from a comparison of the film samples No. 121 and No. 123, and a comparison of the samples No. 124 and No. 126, that when the compound (101-3) represented by formula (I) was used, the Re expression properties were obviously enhanced to a large extent without any change in the wavelength dispersibility of Re.

It can also be seen from this effect that in the Samples No. 122 and No. 125, Re and Re wavelength dispersibility can be realized to the same extent as that for the Comparative Example (Sample No. 123 or No. 126), by reducing the addition amount of additives using the compounds defined by the present invention. The same applies to Samples No. 127 to 130 as well.

### Example 3

### Production of Films 131 to 136

Films 131 to 136 were produced in the same way as in the Example 1, by performing film formation and stretching in the same manner as in the case of the film 101, except that the compound represented by formula (I) and the low molecular weight compound (A) shown in Table 3 were used.

### (Measurement of Re or Rth of Film)

The results obtained in the same manner as in Example 1 are shown in Table 3.

TABLE 3

| | | Low molecular weight | | Compound of formula | | | |
|---|---|---|---|---|---|---|---|
| | | compound (A) | | (I) | | | |
| | | | Addition | | Addition | Evaluation | |
| | Film | | amount | | amount | Re-expression | Re-inverse |
| | No. | Additive | (mass parts) | Additive | (mass parts) | property | dispersibility |
| This | 131 | (7-4) | 1.25 | (101-3) | 1.5 | B | B |
| invention | | | | | | | |
| Comparative | 132 | (7-4) | 2.5 | Comparative | 3.0 | B | C |
| Example | | | | rod-shaped | | | |
| | | | | compound 1 | | | |
| This | 133 | (31-2) | 1.25 | (101-3) | 1.5 | B | A |
| invention | | | | | | | |
| Comparative | 134 | (31-2) | 2.5 | Comparative | 3.0 | B | A |
| Example | | | | rod-shaped | | | |
| | | | | compound 1 | | | |
| This | 135 | (9-4) | 2.5 | (101-5) | 3.0 | A | A |
| invention | | | | | | | |
| This | 136 | (1-5) | 2.5 | (101-3) | 3.0 | A | A |
| invention | | | | | | | |

| | Optical properties | | | | | |
|---|---|---|---|---|---|---|
| | | | Re(630)- | | | |
| | Re | Rth | Re(450) | Re(450)/ | Re(630)/ | |
| | (nm) | (nm) | (nm) | Re(550) | Re(550) | Remarks |
| This | 53 | 97 | 15 | 0.75 | 1.05 | Reduced |
| invention | | | | | | addition |
| | | | | | | amount |
| Comparative | 46 | 100 | 10 | 0.82 | 1.03 | Partially |
| Example | | | | | | whitening |
| | | | | | | of film |
| This | 51 | 92 | 24 | 0.62 | 1.07 | Reduced |
| invention | | | | | | addition |
| | | | | | | amount |
| Comparative | 54 | 113 | 25 | 0.56 | 1.08 | Partially |
| Example | | | | | | whitening |
| | | | | | | of film |
| This | 98 | 108 | 35 | 0.42 | 1.13 | |
| invention | | | | | | |
| This | 101 | 133 | 24 | 0.80 | 1.04 | |
| invention | | | | | | |

Similar to the results in Examples 1 and 2, it can be seen that when two kinds of low molecular weight compounds defined by the present invention were used in combination, a balance can be achieved between high Re expression properties and the wavelength dispersibility of Re. In the Comparative Examples (No. 132 and No. 134), whitening of films was observed because the addition amount of the additives was large. However, it was found that when the compound represented by formula (I) and the low molecular weight compound (A) were used (No. 131 and No. 133), such problems did not occur because the addition amount was small.

### Example 4

### Production of Films 141 to 150

Films 141 to 150 were produced in the same way as in the Example 1, by performing film formation and stretching in the same manner as in the case of the film 101, except that the compound represented by formula (I) and the low molecular weight compound (A) shown in Table 4 were used.

### (Evaluation of Re-Expression Property and Re-Inverse Dispersibility

Re values at wavelengths of 450 nm, 550 nm and 630 nm, respectively were measured in the same way as in Example 1, and each of Re-expression property and Re-inverse dispersibility was evaluated according to the following criteria. The results are shown in Table 4.

### Re-Expression Property:

A: Re(550) was 30 or more.

B: Re(550) was more than 20, and less than 30.

C: Re(550) was 20 or less.

### Re-Inverse Dispersibility:

A: Re(630)−Re(450) was 12 or more.

B: Re(630)−Re(450) was more than 7, and less than 12.

C: Re(630)−Re(450) was 7 or less.

TABLE 4

| | | Low molecular weight | | Compound of formula | | | |
|---|---|---|---|---|---|---|---|
| | | compound (A) | | (I) | | | |
| | | | Addition | | Addition | Evaluation | |
| | Film | | amount | | amount | Re-expression | Re-inverse |
| | No. | Additive | (mass parts) | Additive | (mass parts) | property | dispersibility |
| This | 141 | (1-5) | 1.25 | (101-4) | 1.5 | A | A |
| invention | | | | | | | |
| This | 142 | (1-2) | 1.25 | (101-5) | 1.5 | A | A |
| invention | | | | | | | |
| This | 143 | (19-8) | 1.25 | (101-4) | 1.5 | B | B |
| invention | | | | | | | |
| This | 144 | (42-8) | 1.25 | (101-4) | 1.5 | B | B |
| invention | | | | | | | |
| This | 145 | (54-11) | 1.25 | (101-4) | 1.5 | B | A |
| invention | | | | | | | |
| This | 146 | (54-9) | 1.25 | (101-4) | 1.5 | B | B |
| invention | | | | | | | |
| This | 147 | (56-10) | 1.25 | (101-4) | 1.5 | B | B |
| invention | | | | | | | |
| This | 148 | (1-5) | 1.25 | (111-5) | 1.5 | B | B |
| invention | | | | | | | |
| This | 149 | (1-5) | 1.25 | (124-5) | 1.5 | A | A |
| invention | | | | | | | |
| This | 150 | (1-5) | 1.25 | (139-4) | 1.5 | A | A |
| invention | | | | | | | |

### Example 5

Cellulose acetate films were produced in the same manner as in Examples 1 to 4, for the combinations with the Exemplified Compound (2-4), (15-4), (22-6), (24-4), (30-4), (41-C), (48-8) or (59-10) and the Exemplified Compound (101-3), (101-4) or (101-5), and the Re values were measured. It was confirmed that in all cases, the Re value was large, and the wavelength dispersibility of Re was excellent (the value of Re(630)−Re(450) being larger), as compared with those samples which did not make use of these rod-shaped compounds.

### Example 6

### Production of Films 201 to 204

Films 201 to 204 were produced in the same way as in the Example 1, by performing film formation and stretching in the same manner as in the case of the film 101, except that the compound represented by formula (I) and the low molecular weight compound (A) shown in Table 5 were used.

### (Measurement of Re or Rth of Film

The results obtained in the same manner as in Example 1 are shown in Table 5.

TABLE 5

| | | Low molecular weight | | Compound of formula | | | |
|---|---|---|---|---|---|---|---|
| | | compound (A) | | (I) | | | |
| | | | Addition | | Addition | Evaluation | |
| | Film | | amount | | amount | Re-expression | Re-inverse |
| | No. | Additive | (mass parts) | Additive | (mass parts) | property | dispersibility |
| This | 201 | (1-3) | 1.5 | (101-3) | 3.0 | A | B |
| invention | | | | | | | |
| This | 202 | (1-3) | 1.2 | (101-3) | 1.8 | B | C |
| invention | | | | | | | |
| Comparative | 203 | (1-3) | 1.5 | Comparative | 3.0 | B | C |
| Example | | | | rod-shaped | | | |
| | | | | compound 1 | | | |
| Comparative | 204 | (1-3) | 1.5 | None | — | C | B |
| Example | | | | | | | |

| | Optical properties | | | | | |
|---|---|---|---|---|---|---|
| | | | Re(630)- | | | |
| | Re | Rth | Re(450) | Re(450)/ | Re(630)/ | |
| | (nm) | (nm) | (nm) | Re(550) | Re(550) | Remarks |
| This | 108 | 149 | 10 | 0.93 | 1.02 | |
| invention | | | | | | |
| This | 58 | 113 | 2 | 0.98 | 1.02 | Reduced |
| invention | | | | | | addition |
| | | | | | | amount |
| Comparative | 55 | 109 | 3 | 0.97 | 1.02 | |
| Example | | | | | | |
| Comparative | 15 | 77 | 12 | 0.41 | 1.18 | |
| Example | | | | | | |

### (Production of Polarizing Plate)

A polarizing film was produced by allowing a stretched polyvinyl alcohol film to adsorb iodine.

The above-produced cellulose acylate film sample Nos. 202 and 203 each were bonded to one side of the polarizing film, using a polyvinyl alcohol-base adhesive. The film herein was saponified under the conditions below.

A 1.5 mol/l aqueous sodium hydroxide solution was prepared, and kept at 55° C. A 0.01 mol/l dilute aqueous sulfuric acid solution was prepared, and kept at 35° C. The cellulose acylate film was immersed in the aqueous sodium hydroxide solution for 2 minutes, and then immersed in water to thoroughly wash off the aqueous sodium hydroxide solution. Next, the film was immersed in the dilute aqueous sulfuric acid solution for 1 minute, and then immersed in water to thoroughly wash off the dilute sulfuric acid solution. Finally, the sample was thoroughly dried at 120° C.

A commercially available cellulose triacylate film (FUJITAC TD80UF, trade name, from FUJIFILM Corporation) was saponified, then bonded to the opposite side of the polarizing film using a polyvinyl alcohol-base adhesive, and the product was dried at 70° C. for 10 minutes or longer.

The cellulose acetate film was bonded to the polarizing film so that the slow axis thereof was parallel to the transmission axis of the polarizing film. The commercially available cellulose triacylate film was bonded to the polarizing film so that the slow axis thereof was perpendicular to the transmission axis of the polarizing film.

### (Production of Liquid Crystal Cell)

A liquid crystal cell was produced by forming a liquid crystal layer between substrates held while keeping a 3.6-μm gap of the substrates, into which a liquid crystal material having a negative dielectric anisotropy (trade name: MLC6608, manufactured by MERCK) was dropped and sealed. Retardation of the liquid crystal layer (product Δnd of thickness d (μm) of the liquid crystal layer and anisotropy of refractive index Δn) was adjusted to 300 nm. The liquid crystal material was vertically aligned.

### (Mounting to VA-Mode Panel)

On an upper polarizing plate (on the observer's side) of a liquid crystal display device employing the above-described VA-mode liquid crystal cell and a lower polarizing plate (on the backlight side), the polarizing plate provided with the film No. 202 or 203 produced in Example 6 in the above was disposed, so that the cellulose acylate film was disposed at the liquid crystal cell. The upper polarizing plate and the lower polarizing plate were bonded to the liquid crystal cell using an adhesive. The upper polarizing plate and the lower polarizing plate were provided in the crossed-nicols arrangement, in which the transmission axis of the former was along the vertical direction of the displaying plane; and the transmission axis of the latter was along the horizontal direction of the displaying plane.

The liquid crystal cell was then applied with a 55-Hz rectangular pulse voltage so as to be operated in the normally-black mode, showing the white state at 5V, and the black state at 0V. The black state was observed in the viewing-angle direction with an azimuth angle of 45° and a polar angle of 60°; and color sift was evaluated between the viewing-angle directions with an azimuth angle of 45° and a polar angle of 60° and with an azimuth angle of 180° and a polar angle of 60°.

An observation was made on two liquid crystal display devices produced using the film No. 202 or 203, and as a result, it was confirmed that a neutral black display was realized in both the front direction and the viewing-angle direction. From this result, it was confirmed that a satisfactory display performance is obtained even from the film No. 202 of the present invention, in which the addition amount of the low molecular weight compounds in the film was reduced to a large extent.

Having described our invention as related to the present embodiments, it is our intention that the invention not be limited by any of the details of the description, unless otherwise specified, but rather be construed broadly within its spirit and scope as set out in the accompanying claims.

What is claimed is:

1. A cellulose composition, comprising:
at least one kind of cellulose compound;
at least one kind of compound represented by formula (I); and
at least one kind of low molecular weight compound (A);
wherein molecular absorption wavelength of the low molecular weight compound (A) derived from an electric dipole transition moment My in a direction approximately orthogonal to a molecular long axis direction, is longer than that derived from an electric dipole transition moment Mx in a direction approximately parallel to the molecular long axis direction; and
wherein magnitude of the electric dipole transition moment |My| of the low molecular weight compound (A) in the direction approximately orthogonal to the molecular long axis is larger than that of the electric dipole transition moment |Mx| in the direction approximately parallel to the molecular long axis direction: 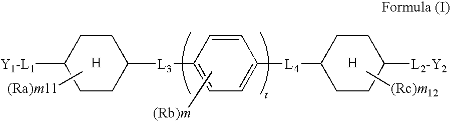
wherein L₁, L₂, L₃, and L₄ each independently represent a single bond, or a divalent linking group selected from the group consisting of —O—, —CO—, —NR^{A}— (R^{A} represents an alkyl group having 1 to 7 carbon atoms or a hydrogen atom), —CH₂— and a combination of these; Y₁ and Y₂ each independently represent an alkyl group; Ra, Rb and Rc each independently represent a substituent; m represents an integer of 0 to 4; t represents an integer of 1 or 2; and m11 and m12 each independently represent an integer of 0 to 10.

2. The cellulose composition according to claim 1, wherein the low molecular weight compound (A) is a compound having a structure represented by formula (a) in its skeleton.

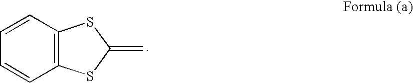

3. The cellulose composition according to claim 2, wherein the low molecular weight compound (A) having a structure represented by formula (a) is a compound represented by formula (A-1): 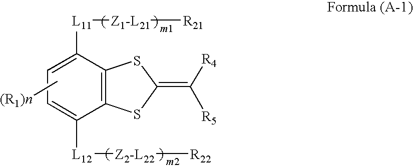
wherein R₁, R₄ and R₅ each independently represent a substituent; n represents an integer of 0 to 2; L₁₁, L₁₂, L₂₁ and L₂₂ each independently represent a single bond, or a divalent linking group selected from the group consisting of —O—, —S—, —S(═O)₂—, —CO—, —NR^{A}— (R^{A} represents an alkyl group having 1 to 7 carbon atoms or a hydrogen atom), —CH₂— and a combination of these; Z₁ and Z₂ each independently represent a divalent 5- or 6-membered cyclic linking group; R₂₁ and R₂₂ each independently represent a hydrogen atom or an alkyl group; and m1 and m2 each independently represent an integer of 0 to 2.

4. The cellulose composition according to claim 3, wherein R₄ and R₅ in formula (A-1) is an electron-withdrawing substituent having a Hammett substituent constant σₚ value of 0 or more.

5. The cellulose composition according to claim 3, wherein Z₁ and Z₂ in formula (A-1) each independently represent a 1,4-cyclohexylene group or a 1,4-phenylene group.

6. The cellulose composition according to claim 3, wherein m1 and m2 in formula (A-1) each are 0 or 1.

7. The cellulose composition according to claim 1, wherein L₃ and L₄ in formula (I) each independently represent —OC(═O)— or —C(═O)O—.

8. The cellulose composition according to claim 1,
wherein L₁ and L₂ in formula (I) each independently represent a single bond; and
wherein Y₁ and Y₂ in formula (I) each independently represent an unsubstituted alkyl group.

9. The cellulose composition according to claim 1, wherein at least one of the compound represented by formula (I) and the low molecular weight compound (A) is in a liquid crystal phase at any temperature of from 100° C. to 300° C.

10. The cellulose composition according to claim 1, wherein the cellulose compound is a cellulose ester.

11. The cellulose composition according to claim 10,
wherein the cellulose ester is a cellulose acylate;
wherein the acyl substituent of the cellulose acylate is substantially an acetyl group; and
wherein a total substitution degree of the cellulose acylate is from 2.00 to 3.00.

12. A cellulose film, comprising the composition according to claim 1.

13. The cellulose film according to claim 12, wherein the low molecular weight compound (A) is contained in an amount of 0.1 to 50 mass parts, with respect to 100 mass parts of the cellulose compound.

14. The cellulose film according to claim 12, wherein the compound (1) is contained in an amount of 0.1 to 50 mass parts, with respect to 100 mass parts of the cellulose compound.

15. An optical film, comprising the cellulose film according to claim 12.

16. The optical film according to claim 15,
wherein the birefringence Δn (550 nm) in the orientation direction is larger than 0; and
wherein the optical film satisfies expressions (1) and (2).
1>|Δn(450 nm)/Δn(550 nm)| Expression (1)
1<|Δn(630 nm)/Δn(550 nm)| Expression (2)

17. A method of producing the cellulose film according to claim 12, comprising the steps of:
stretching a film; and
contracting the film.

18. A method of producing the optical film according to claim 15, comprising the steps of:
stretching a film; and
contracting the film.

19. A retardation sheet, comprising the cellulose film according to claim 12.

20. A retardation sheet, comprising the optical film according to claim 15.

21. A polarizing plate, comprising the retardation sheet according to claim 19.

22. A polarizing plate, comprising the retardation sheet according to claim 20.

23. A liquid crystal display device, comprising the retardation sheet according to claim 19.

24. A liquid crystal display device, comprising the retardation sheet according to claim 20.

25. A liquid crystal display device, comprising the polarizing plate according to claim 21.

26. A liquid crystal display device, comprising the polarizing plate according to claim 22.

27. The liquid crystal display device according to claim 23, which is a VA mode.

28. The liquid crystal display device according to claim 24, which is a VA mode.

29. The liquid crystal display device according to claim 25, which is a VA mode.

30. The liquid crystal display device according to claim 26, which is a VA mode.
